(19) United States
(12) Patent Application Publication
(10) Pub. No.: US 2026/0181574 A1
(43) Pub. Date: Jun. 25, 2026

(54) METHOD AND USER EQUIPMENT FOR SELECTING NETWORK

(71) Applicant: Samsung Electronics Co., Ltd., Suwon-si (KR)

(72) Inventors: Aman AGARWAL, Bangalore (IN); Sidhant JAIN, Bangalore (IN); Kailash Kumar JHA, Bangalore (IN); Lalith KUMAR, Bangalore (IN); Avneesh TIWARI, Bangalore (IN); Mahmoud WATFA, Bangalore (IN)

(21) Appl. No.: 19/538,413

(22) Filed: Feb. 12, 2026

Related U.S. Application Data
(63) Continuation of application No. PCT/KR2024/011823, filed on Aug. 8, 2024.

(30) Foreign Application Priority Data
Aug. 13, 2023 (IN) 202341054360
Jul. 29, 2024 (IN) 2023 41054360

(51) Int. Cl. H04W 60/06; H04B 7/185; H04W 36/08; H04W 84/06

(52) U.S. Cl. CPC H04W 60/06; H04B 7/18519; H04W 36/083; H04W 84/06

(57) ABSTRACT

A method performed by a user equipment (UE) is provided. The method includes registering to a non-terrestrial network (NTN), storing information that a registered public land mobile network (RPLMN) corresponds to the NTN, triggering a network search procedure, and in response to the triggering of the network search procedure, in case that the stored information indicates that the RPLMN corresponds to the NTN, searching for a terrestrial network (TN) instead of searching for the NTN for the network search procedure.

### CROSS-REFERENCE TO RELATED APPLICATION(S)

This application is a continuation application, claiming priority under 35 U.S.C. § 365(c), of an International application No. PCT/KR2024/011823, filed on Aug. 8,2024, which is based on and claims the benefit of an Indian Provisional patent application number 202341054360, filed on Aug. 13, 2023, in the Indian Intellectual Property Office, and of an Indian Complete patent application number 202341054360 filed on Jul. 29, 2024, in the Indian Intellectual Property Office, the disclosure of each of which is incorporated by reference herein in its entirety.

### BACKGROUND

### 1. Field

The disclosure relates to wireless communication networks. More particularly, the disclosure relates to a method for power saving and quicker Terrestrial Network (TN) service for User Equipment's (UEs) supporting Non-Terrestrial Network (NTN).

### 2. Description of Related Art

For a fifth-generation (5G) system with satellite access, the following requirements apply: The 5G system shall support service continuity between NR terrestrial access network and new radio (NR) satellite access networks owned by a same operator or owned by 2 different operators having an agreement.

FIG. 1A depicts the SystemInformationBlockType19 (SIB19), according to the related art.

System Information Block 19 (SIB19): As per 3^{rd} Generation Partnership Project (3GPP) TS 38.331 v17.3.0, Section 6.3.1, SystemInformationBlockType19 (SIB19) contains satellite assistance information for NTN access (as depicted in FIG. 1A).

### SIB19 Field Descriptions

a) distanceThresh: Distance from the serving cell reference location and is used in location-based measurement initiation in RRC_IDLE and RRC_INACTIVE mode. Each step represents 50 m.
b) ntn-Config: Provides parameters needed for the UE to access NR via NTN access such as Ephemeris data, common timing advance (TA) parameters, k_offset, validity duration for UL sync information and epoch.
c) ntn-NeighCellConfigList, ntn-NeighCellConfigListExt: Provides a list of NTN neighbour cells including their ntn-Config, carrier frequency and PhysCellId. This set includes all elements of ntn-NeighCellConfigList and all elements of ntn-NeighCellConfigListExt. If ntn-Config is absent for an entry in ntn-NeighCellConfigListExt, the ntn-Config provided in the entry at the same position in ntn-NeighCellConfigList applies.
d) referenceLocation: Reference location of the serving cell provided via NTN quasi-Earth fixed system and is used in location-based measurement initiation in RRC_IDLE and RRC_INACTIVE mode.
e) t-Service: Indicates the time information on when a cell provided via NTN quasi-Earth fixed system is going to stop serving the area it is currently covering. The field indicates a time in multiples of 10 ms after 00:00:00 on Gregorian calendar date 1 Jan. 1900 (midnight between Sunday, Dec. 31, 1899, and Monday, Jan. 1, 1900). The exact stop time is between the time indicated by the value of this field minus 1 and the time indicated by the value of this field.

FIG. 1B depicts the information element (IE) NTN-Config, according to the related art.

The IE NTN-Config provides parameters needed for the UE to access NR via NTN access (as depicted in FIG. 1B).

FIG. 1C depicts the IE EphemerisInfo, according to the related art.

The IE EphemerisInfo provides satellite ephemeris. Ephemeris may be expressed either in format of position and velocity state vector in ECEF or in format of orbital parameters in ECI (as depicted in FIG. 1C).

FIG. 1D depicts the IE SystemInformationBlockType32, according to the related art.

The IE SystemInformationBlockType32 contains satellite assistance information for prediction of discontinuous coverage. SystemInformationBlockType32 is only signalled in an NTN cell (as depicted in FIG. 1D).

t-ServiceStart: Time information on when the incoming satellite is going to start serving the area for quasi-earth fixed cell.

### From 3GPP TS 23.501 (Rel-18)

### 5.4.1.4 Support of Unavailability Period

Before the start of an event that makes the UE unavailable, the UE includes an indication and type of unavailability, the Start of the Unavailability Period if known and the Unavailability Period Duration if known and triggers either Mobility Registration Update or UE initiated Deregistration procedure.

### 5.4.13.1 Mobility Management and Power Saving Optimization

For NR satellite access that provides discontinuous network coverage, and in case both UE and network indicate support for “Unavailability Period Support”, the following applies:

If the UE determines it will lose coverage and decides to remain in no service during coverage lose period, then:
a UE out-of-coverage period may be determined, which expressed by a Start of Unavailability Period and/or Unavailability Period Duration indicating the timing information for when a UE is expected to be out of coverage, and when the UE is expected to re-gain coverage again. The UE out-of-coverage period may consider current and expected future locations of the UE.

### From 3GPP TS 23.502

### 4.2.2.2.2 General Registration

The UE provides its determined value of start of unavailability period and Unavailability Period Duration to the Access and Mobility Management Function (AMF) in Registration Request:

UE to (R)AN: Access Network (AN) message (AN parameters, Registration Request (Registration type, Subscription Concealed Identifier (SUCI) or 5G-Globally Unique Temporary Identifier (GUTI) or Permanent Equipment Identifier (PEI), [last visited Tracking Area Identity (TAI) (if available)], Security parameters, [Requested Network Slice Selection Assistance Information (NSSAI)], [Mapping Of Requested NSSAI], [Default Configured NSSAI Indication], [UE Radio Capability Update], [UE MM Core Network Capability], [Packet Data Unit (PDU) Session status], [List Of PDU Sessions To Be Activated], [Follow-on request], [Mobile Initiated Communication Only (MICO) Indication], [Requested Active Time], [Requested Discontinuous Reception (DRX) parameters for Evolved Universal Terrestrial Radio Access (E-UTRA) and NR], [Requested DRX parameters for Narrow Band Internet of Things (NB-IoT)], [extended idle mode DRX parameters], [Local Area Data Network (LADN) Deep Neural Networks (DNN(s)) or Indicator Of Requesting LADN Information], [Non-Access Stratum (NAS) message container], [Support for restriction of use of Enhanced Coverage], [Preferred Network Behaviour], [UE paging probability information], [Paging Subgrouping Support Indication], [UE Policy Container (the list of PDU Session Identity (PSIs), indication of UE support for Access Network Discovery & Selection Policy (ANDSP), the operating system identifier, Indication of UE Route Selection Policy (URSP) Provisioning Support in Evolved Packet System (EPS), UE capability of reporting URSP rule enforcement to network, UE capability of supporting Visited Public Land Mobile Network (VPLMN)-specific URSP rules)] and [UE Radio Capability ID], [Release Request indication], [Paging Restriction Information], PEI, [PLMN with Disaster Condition], [Requested Periodic Update time], [Unavailability Period Duration], [Start of Unavailability Period], [Unavailability Type])).

The AMF provides start of unavailability period and Unavailability Period Duration to the UE in Registration Accept:

New AMF to UE: Registration Accept (5G-GUTI, Registration Area, [Mobility restrictions], [PDU Session status], [Allowed NSSAI], [Mapping Of Allowed NSSAI], [Partially Allowed NSSAI], [Mapping Of Partially Allowed NSSAI], [TAI List for Single-NSSAIs (S-NSSAIs) in Partially Allowed NSSAI], [Configured NSSAI for the Serving PLMN], [Mapping Of Configured NSSAI], [Network Slice Simultaneous Registration Group (NSSRG) Information], [Network Slice Access Group (NSAG) Information], [rejected S-NSSAIs], [TAI List for any rejected S-NSSAI Partially in the Random Access (RA)], [Pending NSSAI], [Mapping Of Pending NSSAI], [Periodic Registration Update timer], [Active Time], [Strictly Periodic Registration Timer Indication], [LADN Information], [MICO Indication], [Internet Protocol (IP) Multimedia Subsystem (IMS) Voice over Packet-Switched (PS) session supported Indication], [Emergency Service Support indicator], [Accepted DRX parameters for E-UTRA and NR], [Accepted DRX parameters for NB-IoT], [extended idle mode DRX parameters], [Paging Time Window], [Network support of Interworking without N26], [Access Stratum Connection Establishment NSSAI Inclusion Mode], [Network Slicing Subscription Change Indication], [Operator-defined access category definitions], [List of equivalent PLMNs], [Enhanced Coverage Restricted information], [Supported Network Behaviour], [Service Gap Time], [PLMN-assigned UE Radio Capability ID], [PLMN-assigned UE Radio Capability ID deletion], [Wake-Up Signal (WUS) Assistance Information], [AMF PEIPS Assistance Information], [Truncated 5G S-Temporary Mobile Subscription Identifier (5G-S-TMSI) Configuration], [Connection Release Supported], [Paging Cause Indication for Voice Service Supported], [Paging Restriction Supported], [Reject Paging Request Supported], [Paging Restriction Information acceptance/rejection], [“List of PLMN(s) to be used in Disaster Condition”], [Disaster Roaming wait range information], [Disaster Return wait range information], [Forbidden TAI(s)], [List of equivalent Standalone Non-Public Networks (SNPNs)], [Registered Network Identifier (NID)], [Unavailability Period Support], [Mobile Base Station Relay (MBSR) authorization information], [Return To Coverage Notification Not Required], [Unavailability Period Duration], [Start of Unavailability Period], [S-NSSAI location availability information], [Mapping Of Alternative NSSAI], [Slice Usage Policy], [Maximum Time Offset]).

In discontinuous coverage of satellite scenario, UEs are bound to have coverage at only specific times due to the continuous movement of the satellites or satellite constellations. In case of Out of Service (OOS) recovery/recovery from lack of coverage or power-on/switch-on or during periodic higher priority PLMN search, even if UE determines that UE is in Discontinuous Coverage (DC) of Non Terrestrial Network (NTN), UE may still try to search for NTN Radio Access Technologies (RATs), which is redundant/not necessary/not needed as there is no NTN service available during Discontinuous Coverage (DC). This redundant/un-necessary search will result in service acquisition delay and may lead to higher amount of power consumption at the UE side. Hence solutions are needed to overcome this issue.

FIG. 2 depicts an example scenario (S200) occurring during PLMN or network selection during DC according to the related art. When UE determines that UE is in NR/Evolved Universal Terrestrial Radio Access Network (E-UTRAN) Satellite Access Discontinuous Coverage (DC) or Discontinuous coverage or Unavailability Period of any NTN or Network of selected/any PLMN or Network/PLMN/RAT/Access/Access Technology or any combination of these at the time of Switch-ON or recovery from lack of coverage or any other trigger conditions as stated in this embodiment. At Switch-ON or recovery from lack of coverage or any trigger condition, if the UE is in automatic mode (automatic network selection mode), UE will try/select/search/scan for Last registered PLMN(RPLMN) or Last Registered Network first on the preferred or last registered or available Access Technology/RAT/Access, which may be Satellite Access Network (i.e., NR or E-UTRAN Satellite Access Network) or UE may select/search for any supported access/RAT/Network/Access Technology or any access technologies, including Satellite Access network. However, if the last registered access/Access Technology/RAT for the UE was a NR/E-UTRAN Satellite Access Network and the UE is currently in the NR/E-UTRAN Satellite Access Discontinuous Coverage (DC), optionally for the last registered PLMN or any selected PLMN or Network (RAT/Access/Access Technology/PLMN or any combination of these), UE may still select/search/scan for the NR/E-UTRAN Satellite Access Network, optionally for the last registered PLMN or any selected PLMN or Network (RAT/Access/PLMN/Access Technology or any combination of these), which may lead to un-necessary delay in service acquisition and may also lead to more power consumption as UE is in NR/E-UTRAN Satellite Access Discontinuous Coverage, optionally for the last registered PLMN or any selected PLMN or Network (RAT/Access/PLMN/Access Technology or any combination of these) and UE will not get Satellite Access Network or NTN for the registered PLMN (RPLMN) or selected PLMN/Network, optionally when discontinuous coverage is ongoing. In an embodiment, at the time of Switch-ON or recovery from lack of coverage or any trigger conditions, the UE and/or the Network/any Network Entity may not be able to indicate or negotiate the Start of the unavailability period and/or the unavailability period duration to each other. optionally due to NR/E-UTRAN Satellite Access Discontinuous Coverage (DC), and since the Unavailability Period or the discontinuous period may have started when the UE was in Switched OFF state or the UE was not in coverage and thus, the UE may not go into discontinuous coverage, optionally for the selected PLMN/Network/RAT and may keep searching or scanning for the Satellite Access Network or NTN or any access technology on which NTN may be deployed, optionally for the selected PLMN/Network/RAT. For example, when the UE was previously in coverage or switched on, the UE was in Satellite Access Coverage and registered to the Network. The UE then loses coverage or is switched off. Later, when the UE recovers back to coverage or is switched ON again, the UE is already in Satellite Access discontinuous coverage, optionally for the selected or last registered PLMN/Network/RAT, as determined by the UE, but the UE or the Network couldn't indicate the start/duration of the Unavailability Period or Discontinuous coverage as the discontinuous coverage has already started. The UE may unnecessarily search and scan for Satellite Access Network, optionally for the selected or last registered PLMN/Network/RAT. In yet another scenario, at Switch-ON or recovery from lack of coverage, if the UE is in automatic mode (automatic network selection mode), if there is no last registered PLMN, then UE will search for Home PLMN (HPLMN)/Equivalent HPLMN(s) (EHPLMN(s)) or any other PLMN in priority order as per 3GPP TS 23.122 for all the RATs/preferred RAT or Access/Network (including Satellite Access Network). However, the UE might be in the discontinuous coverage of the NR/E-UTRAN Satellite Access Network, optionally for the selected PLMN or Network, which may lead to un-necessary delay in service acquisition, more power consumption and unnecessary scanning for NR/E-UTRAN Satellite Access Network, optionally for the selected PLMN or Network, for which UE might be in NR/E-UTRAN Satellite Access Discontinuous coverage or the selected Satellite Access may not be available currently. This will lead to un-necessary power consumption and also delay in service acquisition of the UE. A method needs to be defined to solve this problem.

Referring to FIG. 2, at operation S202, switch on the UE or recovery from lack of coverage of the UE or any trigger conditions, the UE is in an automatic mode. At operation S204, the UE determines that the UE is in the discontinuous coverage or unavailability period of the NR/E-UTRAN satellite access network or the NTN, (optionally for the selected PLMN/Network).

At operation S206, the UE will search for HPLMN/EHPLMN(s) or any other PLMN in priority order as per 3GPP TS 23.122 for all the RATs/preferred RAT or Access/Network (including Satellite Access Network). However, the UE might be in the discontinuous coverage of the NR/E-UTRAN satellite access network, optionally for the selected PLMN or the network, which may lead to un-necessary delay in service acquisition.

At operation S208, if the last registered access/access technology/RAT for the UE was the NR/E-UTRAN satellite access network and the UE is currently in the NR/E-UTRAN Satellite Access Discontinuous Coverage (DC), optionally for the selected PLMN (i.e., RPLMN), the UE may still select/search for the NR/E-UTRAN Satellite Access Network, optionally for the selected PLMN (i.e., RPLMN) or any selected PLMN or Network and UE will not get satellite access network for the registered PLMN (RPLMN) or selected PLMN/Network when discontinuous coverage is ongoing.

At operation S210, this will lead to un-necessary power consumption and also delay in service acquisition of the UE as the UE is in the discontinuous coverage or unavailability period of NR/E-UTRAN satellite access network or an NTN.

FIG. 3 depict an example scenario (S300) occurring during PLMN or network selection during DC according to the related art. At S304, when UE determines that UE is in NR/E-UTRAN Satellite Access Discontinuous Coverage (DC) of selected/any PLMN or NTN Network/PLMN/RAT/Access/Access Technology combination and UE is in manual mode (manual network selection mode). At Switch-ON or during recovery from lack of coverage or during any PLMN/Network Search/Selection/Scanning, if the UE is in Manual mode (i.e., Manual network selection mode), UE will search for all the available PLMN(s) or Network (i.e., PLMN/RAT/Access or combination of these) using all the supported access technologies (including the NR/E-UTRAN Satellite Access Network) and indicate/populate the list of the available PLMN(s), optionally including/indicating/displaying the list of RAT/Access Technologies associated/available along with the available PLMN(s) to the upper layers/User Interface (UI)/User. At S306, if the RAT/Access Technologies is not indicated/displayed by the UE to the upper layers/UI/User or if the upper layers/UI/User doesn't select/indicate any Access Technology for the selected PLMN, then the UE shall select the highest priority available access technology for the selected PLMN, if available or stored in the UE, or the UE may select any supported access technology for the selected PLMN for registration. At S308, however, if the selected access technology (i.e., based on user selection or based on highest priority access technology or based on supported access technology or any other basis), for the selected particular PLMN, is a NR/E-UTRAN Satellite Access Network which is in NR/E-UTRAN Satellite Access discontinuous coverage, the UE shall not be able to get Satellite Access Network for the selected PLMN, when discontinuous coverage is ongoing and this may lead to un-necessary delay in service acquisition and lead to more power consumption. In an embodiment, at the time of Switch-ON or recovery from lack of coverage, the UE is in manual mode (manual network selection mode) and the UE and/or the Network/any Network Entity may not be able to indicate or negotiate the Start of the unavailability period and/or the unavailability period duration to each other, optionally due to NR/E-UTRAN Satellite Access Discontinuous Coverage (DC), optionally since the Unavailability Period or the discontinuous period may have started when the UE was in Switched OFF state or the UE was not in coverage and thus, the UE may not go into discontinuous coverage, optionally for the selected PLMN/Network/RAT and may keep searching or scanning for the Satellite Access Network, optionally for the selected PLMN/Network/RAT. For example, when the UE was previously in coverage or switched on, UE was in Satellite Access Coverage and registered to the Network. The UE then loses coverage or is switched off. Later, when the UE recovers back to coverage or is switched ON again, the UE is already in Satellite Access discontinuous coverage, optionally for the selected or last registered PLMN/Network/RAT, as determined by the UE, but the UE or the Network couldn't indicate the start/duration of the Unavailability Period or Discontinuous coverage as the discontinuous coverage has already started. UE may unnecessarily search and scan for Satellite Access Network, optionally for the selected or last registered PLMN/Network/RAT. A method needs to be defined to solve this problem.

FIG. 4 depict an example scenario (S400) occurring during PLMN or network selection during DC according to the related art. When the UE determines that the UE is in NR/E-UTRAN Satellite Access Discontinuous Coverage (DC) of selected/any PLMN or Network/PLMN/RAT/Access/Access Technology or any combination of these and periodic higher priority PLMN search timer expires. If the UE is in a Visited PLMN (VPLMN), UE shall periodically attempt to obtain service on its HPLMN (if the EHPLMN list is not present or is empty) or one of its EHPLMNs (if the EHPLMN list is present) or a higher priority PLMN/access technology combinations listed in “user controlled PLMN selector” or “operator controlled PLMN selector” by scanning in accordance with the requirements that are applicable to i), ii) and iii) as defined in the Automatic Network Selection Mode in clause 4.4.3.1.1 of 3GPP TS 23.122. During the periodic higher priority PLMN search, UE shall search for at least one/all of the higher priority PLMN(s) over all the supported/preferred access technologies (including the NR/E-UTRAN Satellite Access Technologies). However, for the selected/any PLMN, if the UE searches for NR/E-UTRAN Satellite Access Network when the UE is in NR/E-UTRAN Satellite Access discontinuous coverage, optionally for the selected PLMN, the UE shall not be able to find/get NR/E-UTRAN Satellite Access Network for the selected PLMN, when discontinuous coverage is ongoing and this may lead to un-necessary delay in searching for higher priority PLMN(s) service acquisition and lead to more power consumption. The UE will unnecessarily search for PLMNs over NR/E-UTRAN Satellite Access Network/Access Technology during higher priority PLMN Search even though NR/E-UTRAN Satellite Access Network/Technology services for certain PLMN/Network may not be available due to discontinuous coverage and will lead to failure/delay in service acquisition and more power consumption as Discontinuous coverage is ongoing. In an embodiment, the UE and/or the Network/any Network Entity may not be able to indicate or negotiate the Start of the unavailability period and/or the unavailability period duration to each other, optionally due to NR/E-UTRAN Satellite Access Discontinuous Coverage (DC), optionally since the Unavailability Period or the discontinuous period may have started when the UE was registered on the Visited PLMN (VPLMN) and the UE may keep searching or scanning for the Satellite Access Network, optionally for the selected PLMN/Network/RAT, optionally as part of Higher Priority PLMN search. This will lead to un-necessary power consumption and also delay in service acquisition of the UE. A method needs to be defined to solve this problem.

Referring to FIG. 4, at operation 402, the UE determines that the higher priority PLMN search timer expires. At operation 404, the UE determines that the UE is in the discontinuous coverage of NR/E-UTRAN satellite access network, (optionally for the selected PLMN/Network). At operation 406, during the periodic higher priority PLMN search, the UE shall search for all the higher priority PLMN(s) over all the supported/preferred access technologies (including the NR/E-UTRAN satellite access technologies). However, for the selected/any PLMN, if the UE searches for NR/E-UTRAN satellite access network when the UE is in the NR/E-UTRAN satellite access discontinuous coverage, optionally for the selected PLMN, the UE shall not be able to find/get NR/E-UTRAN satellite access network for the selected PLMN, when discontinuous coverage is ongoing. At operation 408, this will lead to un-necessary power consumption and also delay in service acquisition of the UE as the UE is in the discontinuous coverage of NR/E-UTRAN satellite access network.

FIGS. 5, 6, 7, 8, and 9 depict various example scenarios (S500-S900) occurring during PLMN or network selection, optionally during DC or unavailability period of the NTN, according to the related arts.

Referring to FIG. 5, the UE searches for RPLMN (NTN PLMN) and may face a delay (for e.g. 5-15 secs) and consumes more power due to RPLMN search or Registered Network Search.

In another scenario, the UE searches for RPLMN (i.e., NTN PLMN) or the last registered network and gets service quickly. But it is not full-set of services. The UE searches for higher priority PLMN after certain time interval (for e.g. 2 minute timer expiry) or on expiry of an operator specific Better System Reselection (BSR) timer. The UE is stuck in NTN PLMN or NTN with limited set of services for the timer duration.

If the UE was last registered to NTN or NTN PLMN (i.e., RPLMN is NTN PLMN), at Switch-ON or recovery from lack of coverage or due to any trigger conditions, the UE will search for the RPLMN (i.e., Satellite PLMN) or the last registered network on all RATs and Access Network (including Satellite Access Network or any band/frequency on which last registered Network/PLMN was found). When the UE is in discontinuous coverage of the RPLMN or the NTN is not available, optionally due to unavailability period or discontinuous coverage, since the PLMN or the Network may be specific to satellite deployment, UE may not be able to get services on any other access network except for Satellite Access Network (for e.g. Network operator may not have deployed the last registered PLMN/Network on any other access technology other than the access technology or RAT or Band or PLMN on which UE was last registered). The UE being in discontinuous coverage or unavailability period of NTN or RPLMN (Satellite PLMN or NTN PLMN), the UE's search for RPLMN or last registered Network will result in failure as the UE will not find any service from the satellite PLMN or the RPLMN or the last registered Network during the discontinuous coverage. This will lead to un-necessary delay in the service acquisition, more power consumption as the UE will scan NTN PLMN on Satellite Access or any Bands/Frequency on which NTN is deployed during discontinuous coverage.

Further, when the UE is not in discontinuous coverage of the RPLMN or does not have discontinuous coverage information, the UE searches for RPLMN and either finds NTN PLMN (for e.g. the same or a different NTN PLMN or any NTN) upon search or does not find the NTN PLMN. If the UE does not find NTN PLMN, the UE will trigger search for TN PLMN after NTN PLMN search (for e.g. after PLMN Search/Scanning on RPLMN fails) fails. This will lead to un-necessary delay in service acquisition, more power consumption. If the UE finds the NTN PLMN quickly upon search (for e.g. the same RPLMN over NTN or a different NTN PLMN or any NTN), it will not be a preferred PLMN for the UE as the NTN network cannot provide full set of services to the UE (only limited set of services such as Short Message Service (SMS) services would be provided). Moreover, the TN (Normal) services may be available in the UE's location, but since UE triggered search for the RPLMN (NTN PLMN), the UE will not be able to get normal services from the TN PLMN. The UE or the Network will have to perform higher priority PLMN search procedure or any other procedure to select or redirect the UE to a higher priority PLMN/Network, after the expiry of higher priority PLMN search timer (2 min minimum) or for operator specific Better System Reselection timer or any timer or procedure for selection of a higher priority Network or for a better system, this will further delay the UE acquiring full services and UE will remain stuck with limited set of services of a satellite/NTN for a long time.

When the UE is not in discontinuous coverage of RPLMN or NTN or does not have discontinuous coverage information of the NTN, upon searching for RPLMN or last registered Network, the UE may find service on any of the TN RATs or NTN RAT or access technology, If the UE finds service on NR/E-UTRAN Satellite access or over any access/band/frequency used to provide NTN from RPLMN, it will not be a preferred Access for the UE as the NTN Access can only provide limited set of services and cannot provide full set of services to the UE. The UE will have to perform higher priority PLMN (+Access Technology) search procedure to select a higher priority PLMN (+Access Technology), after the expiry of higher priority PLMN search timer (2 min minimum) or the UE searches for better system upon Expiry of operator specific Better System Reselection timer or any timer or procedure for selection of a higher priority Network or for a better system. This will further delay the UE acquiring full services and UE will remain stuck is limited services of satellite for a long time.

Referring to FIG. 6, at operation 602, the operator has deployed the NTN and TN networks on different PLMN ID. At operation 604, the UE is registered to the NTN PLMN, RPLMN: NTN PLMN, RPLMN RAT: Satellite Access. At operation 606, the UE is powered on or is performing recovery from lack of coverage. At operation 608, the UE determines whether the UE has discontinuous coverage information and the UE is in the discontinuous coverage of RPLMN? If the UE has the discontinuous coverage information and the UE is in the discontinuous coverage of RPLMN, at operation 610, the UE searches for the RPLMN in all RATs including satellite access/RAT even when RPLMN is in the discontinuous coverage and the PLMN is not deployed as TN network. The UE does not find RPLMN and the PLMN search fails.

If the UE does not have discontinuous coverage information or the UE is not in the discontinuous coverage of RPLMN, at operation 612, the UE searches for the RPLMN and may find service on RPLMN (NTN PLMN) but cannot get full services. The TN PLMN may be available at UEs location, which can provide full services to UE, but UE attaches/registers to the satellite PLMN. At operation 614, the UE has to wait for higher priority PLMN search timer expiry (2 mins) before moving to another TN PLMN. At operation 616, the UE searches for other PLMN as per priority defined in 23.122 and finds full service on other TN PLMN.

Referring to FIG. 7, at operation 702, the operator may have deployed NTN and TN networks on Same PLMN ID. At operation 704, the UE is registered to the satellite access RPLMN (for e.g. RAT: Satellite Access or over any access/band/frequency used to provide NTN). At operation 706, the UE is powered on or is performing recovery from Lack of Coverage or any trigger conditions.

At operation 708, the UE checks if it has discontinuous coverage information and if the UE is in the discontinuous coverage of RPLMN or if the discontinuous coverage or unavailability period is applicable for the UE or the Network?

If the UE has discontinuous coverage information and the UE is in discontinuous coverage of RPLMN or the last registered network then, at operation 710, the UE searches for RPLMN or the last registered network in all RATs or using all/any access technologies including satellite access/RAT even when RPLMN or last registered network is in satellite access discontinuous coverage or not available due to any reason. The UE wastes time and power in searching satellite access during discontinuous coverage.

If the UE does not have the discontinuous coverage information or if the UE is not in the discontinuous coverage of RPLMN then, at operation 712, the UE searches for the RPLMN and may find service on the RPLMN on the satellite access or over any access/band/frequency used to provide NTN but cannot get full services. TN PLMN/Cell may be available at UEs location, which can provide full services to UE, but UE attaches/registers to the Satellite Access or to the NTN.

At operation 714, the UE has to wait for higher priority PLMN (+Access Technology) Search timer expiry (2 mins) or Better System Reselection timer expiry or any timer or procedure for selection of a higher priority Network or for a better system before moving to TN PLMN/TN Cell. After timer expiry, the UE searches for other PLMN as per priority defined in 23.122 and finds service on other TN PLMN.

Referring to FIG. 8, the UE finds HPLMN NTN cell or any Higher Priority Network (which may include any NTN) during Higher Priority PLMN search procedure and performs/tach/registration/Tracking Area Update Procedure to attach to HPLMN NTN cell or the found NTN Cell. The HPLMN (NTN) or the found NTN is not able to provide full set of services to the UE as the NTN cell can only provide limited set of services to the UE. The UE moves from full services availability to limited set of services (for e.g. SMS services only). Hence, the user experience is deteriorated sharply.

When the UE is attached/registered to any PLMN other than the HPLMN/EHPLMN of the Subscriber Identity Module (SIM) (i.e. UE is attached/registered to a Visited PLMN or VPLMN), the UE runs a Higher Priority PLMN Search Timer or any timer or procedure for selection of a higher priority Network or for a better system. The current VPLMN may be a TN PLMN and is able to provide full set of services to the UE such as SMS, MMS, HD Voice and Video Call, High speed Data etc. Since the UE is not in highest priority PLMN or Network, upon expiry of Higher priority PLMN search timer or any timer or procedure for selection of a higher priority Network or for a better system, the UE searches for PLMNs higher in priority order (HPLMN/EHPLMN or OPLMN or UPLMN) for the UE as defined in 3GPP 23.122. The UE belonging to the operator is currently attached/registered to a VPLMN TN network. The UE runs a higher priority PLMN search timer or any timer or procedure for selection of a higher priority Network or for a better system and triggers search for HPLMN/EHPLMN or other PLMNs higher in priority order as per 23.122 upon expiry of the Higher Priority PLMN Search timer. During Higher Priority PLMN Search, if the UE finds HPLMN NTN cell, which is higher in Priority Order then the UE selects the found PLMN and performs Attach Procedure/Registration Procedure/Tracking Area Update Procedure to attach to home PLMN over NTN Network or any Higher Priority Network (which may include any NTN). The new priority PLMN, i.e. the HPLMN of the UE or the NTN is not able to provide full set of services to the UE as the NTN cell can only provide limited set of services to the UE. The UE moves from full services availability (via VPLMN TN cell) to limited set of services (via HPLMN NTN cell), and User Experience is deteriorated sharply.

During Higher Priority PLMN Search or any timer or procedure for selection of a higher priority Network or for a better system, even if the UE doesn't find HPLMN or higher priority PLMN cell, still the UE spends a significant time in PLMN search procedure on NTN RAT even though NTN RAT could not provide better services to the UE. The UE later finds services a PLMN from OPLMN list which is higher in priority to current VPLMN and attaches/registers to it. The UE wastes a significant amount of time scanning NTN RAT which not only delays service acquisition but also drains battery of the UE.

Referring to FIG. 9, at operation S902, the UE is attached/registered to any PLMN other than HPLMN/EHPLMN (i.e., VPLMN). The UE runs higher priority PLMN search timer or any timer or procedure for selection of a higher priority Network or for a better system. At operation S904, upon higher priority PLMN search timer expiry, the UE triggers search for HPLMN/EHPLMN or any PLMN higher in priority order. At operation S906, the UE searches for higher priority PLMN on all RATs including NTN RAT/Band in RAT priority order. At operation S908, the UE determines whether the higher priority PLMN cell is found? If the higher priority PLMN cell is found, at operation S910, the UE determines whether the found cell is NTN?

If the found cell is NTN? At operation S912, the UE moves to higher priority PLMN as NTN Cell. The NTN Cell is not able to provide full set of services to the UE as the NTN cell can only provide limited set of services to the UE. The UE moves from full services availability to limited set of services, and the user experience is deteriorated sharply. If the found cell is not NTN? At operation S914, the UE moves to the higher priority PLMN TN Cell. The higher priority PLMN cell is not Found, at operation S916, the UE stays on the current VPLMN cell.

The above information is presented as background information only to assist with an understand the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide methods and systems for saving power and getting quicker TN services using optimized network scanning for UE supporting NTNs during switch on or recovery from lack of coverage or during any modem reset or any other trigger conditions, wherein the UE shall disable/ignore/postpone/de-prioritize the last registered network or the RPLMN, optionally over NR/E-UTRAN Satellite access/RAT or over any access/band/frequency used to provide NTN or by lowering the priority of satellite access/NTN RATs, optionally during Discontinuous Coverage (DC).

Another aspect of the disclosure is to ignore a last registered network, if the last registered network is the NTN and perform a network search procedure for a terrestrial network (TN).

Another aspect of the disclosure is to perform a network search procedure, ignore an NTN, and select a TN.

Another aspect of the disclosure is to provide a quicker and better technique for getting Terrestrial Network services during any PLMN Selection/Search Procedure (for ex-At Switch-ON, or recovery from lack of coverage or during Higher Priority PLMN search or during any trigger conditions).

Another aspect of the disclosure is to ignore/de-prioritize/disable/not select the Last Registered PLMN (RPLMN) (or RPLMN+last registered RAT combination) or last registered network for the PLMN Selection during Switch-On/recovery from lack of coverage/during higher Priority PLMN Search if the RPLMN was an NTN PLMN.

Another aspect of the disclosure is to ignore/de-prioritize/disable/not select the Last Registered PLMN (RPLMN) over the Satellite Access or any Freq/Band over which NTN is deployed for the PLMN Selection during Switch-On/recovery from lack of coverage/during higher Priority PLMN Search/during any trigger conditions if the RPLMN was an NTN PLMN or if the last registered RAT is NTN/Satellite Access.

Another aspect of the disclosure is to ignore/de-prioritize/disable/not select the Last Registered PLMN (RPLMN) (or RPLMN+last registered RAT combination) or last registered network, optionally over the Satellite Access or any Freq/Band over which NTN is deployed for the PLMN Selection during Switch-On/recovery from lack of coverage/during higher Priority PLMN Search/during any trigger conditions if the RPLMN was a NTN PLMN or if the last registered RAT is NTN/Satellite Access or a access/band/frequency used to provide NTN and optionally if the UE is in the discontinuous coverage duration of the RPLMN (for ex-based on unavailability period start time and unavailability period duration).

Additional aspects will be set forth in part in the description which follows and, in part, will be apparent from the description, or may be learned by practice of the presented embodiments.

In accordance with an aspect of the disclosure, a method performed by a user equipment (UE) is provided. The method includes registering to a non-terrestrial network (NTN), storing information that a registered-public land mobile network (RPLMN) corresponds to the NTN, triggering a network search procedure, and in response to the triggering of the network search procedure, in case the stored information indicates that the RPLMN corresponds to the NTN, searching for a terrestrial network (TN) instead of searching for the NTN for the network search procedure.

In an embodiment, the network is at least one of a Public Land Mobile Network (PLMN), a Radio Access Technology (RAT), an access, a Radio Access Network (RAN), the network operated in a band, the network operated in a frequency, and the network operated in a cell, a Core Network (CN) entity, a Network Function, a Network entity, a component of the network, a TN, an NTN, or a combination of these.

In an embodiment, the last registered network is a network on which the UE was successfully registered or attached before selecting a network or before triggering a network selection or before triggering the network search procedure.

In an embodiment, the UE determines the last registered network by using at least one of one or more of a value or a file or a configuration or an information configured or stored in the UE (for e.g. a last registered network value derived or stored in the UE or a last registered PLMN value (for e.g. RPLMN) stored or derived in the UE), one or more of a value or a file or a configuration or an information configured or stored in the SIM, one or more of a value or a file or a configuration or an information configured by the network, one or more of a value or a file or a configuration or an information configured by the server, one or more of a value or a file or a configuration or an information configured by an application function, a value configured in the SIM, a value stored in or derived from one or more of a EF_EPSLOCI file or a EF_LOCI file or a EF_PSLOCI file or a EF5GS3GPPLOCI file (or any other file or value stored or derived from) in the SIM (for e.g. the value stored in the above file may refer to some other value from which UE can derive the value of the RPLMN or the last registered network), a value stored in the non-volatile memory of the device and a file stored in the SIM.

In an embodiment, the UE determines that the last registered network is the NTN by using at least one of a broadcast parameter (for e.g. a broadcast parameter which indicates the Network is a NTN), a System Information Block (SIB) parameter, a Non-access stratum (NAS) signalling parameter, an access stratum (AS) signalling parameter, a band used by an operator for deploying a satellite service (for e.g. network operator or the satellite vendor may use some specific bands for deploying NTN or satellite service) or an NTN service, a PLMN used by an operator for deploying the satellite service (for e.g. network operator or the satellite vendor may use some specific PLMN(s) for deploying NTN or satellite service) or the NTN service, a frequency used by the operator for deploying the satellite service or the NTN service, a RAT used by the operator for deploying the satellite service or the NTN service(for e.g. network operator or the satellite vendor may use some specific RAT (for e.g. Long Term Evolution (LTE) or NB-NTN or NB-IOT NTN for deploying NTN or satellite service), a network deployed using any of an NTN Technology, a network used by a satellite vendor for deploying a satellite service or an NTN service, an information regarding configuration for an NTN deployment as configured in the UE, an information regarding configuration for the NTN deployment as indicated by the network, an information regarding configuration for the NTN deployment as configured in a Subscriber Identity Module (SIM), an information regarding configuration for the NTN deployment as indicated by a server (for e.g. a server or a Network deployed method can be used to inform the UE regarding the NTN deployment details), an information regarding configuration for the NTN deployment as indicated by an application function, a database indicating details of a satellite or NTN cell, its location, its availability/unavailability time and its deployment details, a machine learning or an artificial intelligence based technique to predict or determine a network type, and a data driven technique to predict or determine a network type.

In an embodiment, ignoring the last registered network includes at least one of ignoring the last registered network if the last registered network is the NTN, ignoring the last registered network if the last registered network is the NTN and the UE is in discontinuous coverage of the last registered network, de-prioritizing the last registered network if the last registered network is the NTN, selecting the last registered network with a lowest priority if the last registered network is the NTN, de-prioritizing the last registered network, if the last registered network is the NTN and the UE is in the discontinuous coverage of the last registered network, selecting the last registered network with the lowest priority if the last registered network is the NTN and the UE is in the discontinuous coverage of the last registered network, disabling the last registered network if the last registered network is the NTN, disabling the last registered network if the last registered network is the NTN and the UE is in discontinuous coverage of the last registered network; disabling the last registered network over the NTN if the last registered network is the NTN, disabling the last registered network over the NTN if the last registered network is the NTN and the UE is in the discontinuous coverage of the last registered network, ignoring the last registered network over the NTN if the last registered network is the NTN, ignoring the last registered network over the NTN if the last registered network is the NTN and the UE is in the discontinuous coverage of the last registered network, de-prioritizing the last registered network over the NTN if the last registered network is the NTN, selecting the last registered network over the NTN the with lowest priority if the last registered network is the NTN, de-prioritizing the last registered network over the NTN, if the last registered network is the NTN and the UE is in the discontinuous coverage of the last registered network, selecting the last registered network over the NTN with lowest priority if the last registered network is the NTN and the UE is in the discontinuous coverage of the last registered network, disabling the last registered network over a satellite access or the NTN access or over the NTN deployed band or frequency or RAT if the last registered network is the NTN, disabling the last registered network when the last registered RAT is a satellite access or a satellite RAT or an NTN access or an NTN RAT, ignoring the last RPLMN if the last registered network is the NTN; disabling the PLMN search on the last RPLMN and searching for a TN PLMN as per priority order, disabling the PLMN search on the last RPLMN and searching for a TN PLMN as per a priority order when the UE is in the discontinuous coverage of the RPLMN, de-prioritizing the RPLMN and searching for the TN PLMN as per priority order, searching for the NTN PLMN when the TN PLMN is not found, and the UE is not in the discontinuous coverage of RPLMN, selecting any Network other than NTN, selecting any PLMN other than RPLMN, selecting any Network other than Last Registered Network, selecting any TN PLMN, and not selecting any NTN PLMN. In an embodiment, ignoring the last registered network may include at least one of (in any order or combination) selecting any Network other than NTN, selecting any PLMN other than RPLMN, selecting any Network other than Last Registered Network, selecting any TN PLMN; and not selecting any NTN PLMN.

In an embodiment, ignoring the last registered network may occur during a network search procedure, in an embodiment, the UE may ignore the last registered network during a network search procedure. In an embodiment, the UE may ignore the last registered network before or during or after a network search procedure. In an embodiment, the UE ignores the last registered network or the UE ignores the NTN or the UE ignores the last registered PLMN during a network search procedure. In an embodiment, the UE ignores the last registered network or the UE ignores the NTN or the UE ignores the last registered PLMN if the selected network is same as the last registered network/PLMN and the last registered network/PLMN is an NTN. In an embodiment, the UE ignores the NTN if the selected network is an NTN during network search procedure.

In an embodiment, the last registered network is at least one of a last RPLMN, a last registered RAT (LRRAT), a last registered access, a last registered system, a last registered RAN, a last registered network operated in band, a last registered network operated in frequency, a last registered network operated in cell, a last registered CN entity, a last registered Network entity, a last registered network function (NF), a last registered component of network, a last registered TN, and a last registered NTN.

In an embodiment, the NTN is at least one of a non-terrestrial PLMN, a non-terrestrial RAT, a non-terrestrial access, a non-terrestrial system, a non-terrestrial RAN, a non-terrestrial band, a non-terrestrial frequency, a non-terrestrial cell, a non-terrestrial CN entity, a non-terrestrial network function, a non-terrestrial CN entity, a component of a non-terrestrial network a network other than TN, and a network on satellite access network.

In an embodiment, the UE determines the last registered network using least one of a value configured in the UE, a value configured in the SIM, a value stored in the non-volatile memory of the device, and a file stored in the SIM.

In an embodiment, the UE determines that the UE is in the discontinuous coverage of the network by using at least one of a broadcast parameter, a SIB parameter, a NAS signalling parameter, an AS signalling parameter, an information regarding configuration for NTN deployment as configured in the UE, an information regarding configuration for the NTN deployment as indicated by the network, an unavailability period duration and a start of unavailability period, an unavailability type, an indication for store and forward mode, a satellite coverage availability information (SCAI), a satellite ephemeris information, an information regarding configuration for the NTN deployment as configured in a SIM, an information regarding configuration for the NTN deployment as indicated by a server, an information regarding configuration for the NTN deployment as indicated by an application function, a database indicating details of a satellite or NTN cell, its location, its availability/unavailability time and its deployment details, a machine learning or an artificial intelligence based technique to predict or determine a network availability and unavailability status, and a data driven technique to predict or determine a Network availability and unavailability status.

In an embodiment, the UE triggers a network search procedure to select the network, when the UE detects an event.

In an embodiment, the event includes at least one of a switch off the UE, a switch on the UE, a recovery of the UE from lack of a coverage area, a recovery of the UE from an OOS area, a SIM insertion in the UE, a SIM re-insertion post removal in the UE, a SIM removal in the UE, a disabling of the SIM in the UE, an enabling of the SIM in the UE, a modem reset, a power cycle, a modem power up, a modem power cycle, an airplane mode on in the UE, an airplane mode off in the UE, a UE exiting airplane mode, a UE entering airplane mode, a modem exiting airplane mode, an activation of the UE, a reject cause from the network, a detach triggered by the network, a deregistration triggered by the network, on entering store and forward mode in the UE, on exiting store and forward mode in the UE, on entering store and forward mode from the network, on exiting store and forward mode from the network, a detach triggered by the UE, a deregistration triggered by the UE, a network mode change in the UE, a network selection mode change in the UE, an operating mode change in the UE, on entering satellite mode in the UE, on exiting satellite mode in the UE, a turning on of a modem, and a SIM refresh procedure. These events may also be referred to as “trigger conditions” in this embodiment.

In an embodiment, the network search procedure includes selecting a network, and searching the selected network.

In an embodiment, the UE performs the network search procedure for the TN on at least one of a terrestrial PLMN, a terrestrial RAT, a terrestrial access, a terrestrial system, a terrestrial RAN, a terrestrial band, a terrestrial frequency, a terrestrial cell, a terrestrial CN entity, a terrestrial network entity, a component of terrestrial network, a terrestrial network function, a network other than NTN, and a network other than satellite access network.

In an embodiment, the UE is at least one of an NTN-capable UE, a UE capable of availing an NTN service, a UE supporting NTN technology, a UE capable of getting NTN services using technologies other than NTN technology, a UE capable of availing the NTN service which is deployed using a 3^{rd} Generation Partnership Project (3GPP) Satellite or NTN system, a UE capable of availing a service which is deployed using a 3GPP system, a UE capable of availing the NTN service which is deployed using an NTN network deployed using any 3GPP technology, and a UE capable of availing the NTN service which is deployed using any proprietary NTN implementation outside the scope of 3GPP NTN system.

In an embodiment, the NTN includes one of Low Earth Orbits (LEO), Medium Earth Orbits (MEO), Geostationary Orbits (GEO), High Altitude Platform Systems (HAPS), Unmanned Aerial Vehicles (UAV), an Unmanned Aircraft System (UAS), a network supported by an airborne vehicle, a Network deployed using a 3^{rd} Generation Partnership Project (3GPP) Satellite or NTN system, an NTN Network deployed using any 3GPP technology, deployed using any 3GPP technology and an NTN Network deployed using any proprietary NTN implementation outside the scope of a 3GPP NTN system (for e.g. a NTN deployed using an operator server or application etc.). (for e.g. in some cases, the network operators or the satellite vendors are deploying NTN services using existing 3GPP Technologies (for e.g. using 3GPP RAT(s) such as LTE, i.e. deploying LTE-based Satellite system) to ease the deployment).

In accordance with another aspect of the disclosure, a method for selecting a network by a UE registered to the network is provided. The method includes performing, a network search procedure. Further, the method includes ignoring an NTN and selecting a TN.

In an embodiment, the UE registered to the network is at least one of the UE is registered to the TN, the UE is registered to the NTN, a UE is registered to a 3GPP network, and a UE is registered to a Non-3GPP (N3GPP) network.

In an embodiment, the UE performs the network search procedure and selects the TN on at least one of a terrestrial PLMN, a terrestrial RAT, a terrestrial access, a terrestrial system, a terrestrial RAN, a terrestrial band, a terrestrial frequency, a terrestrial cell, a terrestrial CN entity, a terrestrial network entity, a component of a terrestrial network, a terrestrial network function, a network other than NTN, and a network other than satellite access network.

In an embodiment, the UE performs the network search procedure, when the UE detects an event.

In an embodiment, the event includes at least one of an expiry of a timer for higher priority PLMN search procedure, a handover procedure, a redirection procedure, a reselection procedure, an expiry of a timer for Better System Reselection (BSR), an expiry of an operator defined timer, a background network search procedure, an idle mode procedure, a connected mode procedure and a network release procedure.

In an embodiment, ignoring the NTN includes at least one of selecting a TN, not selecting an NTN, selecting any Network other than NTN, selecting any PLMN other than NTN PLMN, ignoring the NTN, ignoring the NTN if the UE is in a discontinuous coverage of the NTN, de-prioritizing the NTN, selecting the NTN with a lowest priority, de-prioritizing the NTN if the UE is in the discontinuous coverage of the NTN, selecting the NTN with the lowest priority if the UE is in the discontinuous coverage of the NTN, disabling the NTN, disabling the NTN if the UE is in the discontinuous coverage of the NTN, ignoring the found Network over NTN, de-prioritizing the found Network over NTN, selecting the found Network over NTN with lowest priority, de-prioritizing the found Network over NTN, if the UE is in the discontinuous coverage of the found Network, selecting the found Network over NTN with lowest priority if the UE is in the discontinuous coverage of the found Network, disabling the found Network over a satellite access or an NTN access or over the NTN deployed band or frequency or RAT, disabling the found Network when the found RAT is a satellite access or a Satellite RAT or an NTN access or an NTN RAT, ignoring the found Network if the found Network is an NTN, disabling the PLMN search on the found Network and searching for a TN PLMN as per a priority order, searching for higher priority TN PLMNs on all RATs except NTN RAT or NTN Band and disabling searching on NTN bands or RATs and Operator deployed NTN Bands, disabling the PLMN search on the found Network and searching for a TN PLMN as per a priority order when the UE is in a discontinuous coverage of the found Network, and de-prioritizing the found Network and searching for a TN PLMN as per a priority order, and searching for a NTN PLMN when TN PLMN is not found, and the UE is not in the discontinuous coverage of found Network.

In an embodiment, the UE ignores the last registered network or the UE ignores the NTN or the UE ignores the last registered PLMN during the network search procedure. In an embodiment, the UE ignores the last registered network or the UE ignores the NTN or the UE ignores the last registered PLMN if the selected network is same as the last registered network/PLMN and the last registered network/PLMN is an NTN. In an embodiment, the UE ignores the NTN if the selected network is an NTN during network search procedure.

In an embodiment, the UE ignores the NTN on at least one of a non-terrestrial PLMN, a non-terrestrial RAT, a non-terrestrial access, a non-terrestrial system, a non-terrestrial RAN, a non-terrestrial band, a non-terrestrial frequency, a non-terrestrial cell, a non-terrestrial CN entity, a non-terrestrial network function, a non-terrestrial CN entity, a component of a non-terrestrial network a network other than TN, and a network on satellite access network.

In accordance with another aspect of the disclosure, a user equipment (UE) is provided. The UE includes communication circuitry, memory, including one or more storage media, storing instructions, led and at least one processor communicatively coupled to the communication circuitry and the memory, wherein the instructions, when executed by the at least one processor individually or collectively, cause the UE to trigger a network search procedure, determine if a last registered network corresponds to a non-terrestrial network (NTN), in accordance with a determination that the last registered Network corresponds to the NTN, disable the last registered network for the network search procedure, and perform the network search procedure for a terrestrial network (TN).

In accordance with another aspect of the disclosure, a UE including a PLMN search controller coupled with a processor and memory is provided. The PLMN search controller is configured to perform a network search procedure. Further, the PLMN search controller is configured to ignore an NTN. Further, the PLMN search controller is configured to select a TN.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include triggering a network search procedure, determining if a last registered network corresponds to a non-terrestrial network (NTN), in accordance with a determination that the last registered network corresponds to the NTN, disable the last registered network for the network search procedure, and performing the network search procedure for a terrestrial network (TN).

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A depicts the SystemInformationBlockType19 (SIB19), according to the related art;

FIG. 1B depicts the IE NTN-Config, according to the related art;

FIG. 1C depicts the IE EphemerisInfo, according to the related art;

FIG. 1D depicts the IE SystemInformationBlockType32, according to the related art;

FIGS. 2, 3, 4, 5, 6, 7, 8, and 9 depict various example scenarios occurring during PLMN or network selection during DC, according to the related arts;

FIG. 10 shows various hardware components of the UE, according to an embodiment of the disclosure;

FIG. 11 depicts an example scenario, wherein the UE shall disable/ignore/postpone/de-prioritize the last registered PLMN (RPLMN) or the last registered Network (for e.g. NTN), optionally over NR/E-UTRAN satellite access/RAT or over any access/band/frequency used to provide NTN or by lowering the priority of satellite access/NTN RATs, optionally during Discontinuous Coverage or unavailability period or during a duration when NTN or the last registered network is not available, according to an embodiment of the disclosure;

FIGS. 12 and 13 are the flowcharts illustrating a method for selecting a network by the UE, according to various embodiments of the disclosure;

FIG. 14 depicts a scenario, wherein the UE shall disable/ignore/postpone/de-prioritize the last registered PLMN (RPLMN) or the last registered Network (for e.g. NTN or the like), optionally over NR/E-UTRAN Satellite access/RAT or over any access/band/frequency used to provide NTN or by lowering the priority of satellite access/NTN RATs, optionally during Discontinuous Coverage or unavailability period or during a duration when the NTN or the last registered network is not available, according to an embodiment of the disclosure;

FIG. 15 depicts a scenario, wherein the UE shall disable/ignore/postpone/de-prioritize the last registered PLMN (RPLMN) or the last registered Network (for e.g. NTN), optionally over NR/E-UTRAN Satellite access/RAT last registered PLMN (RPLMN) or the last registered Network (for e.g. NTN), optionally over or by lowering the priority of satellite access/NTN RATs, optionally during Discontinuous Coverage or unavailability period or during a duration when NTN or the last registered network is not available, according to an embodiment of the disclosure;

FIG. 16 depicts a scenario, wherein the UE shall disable/ignore/postpone/de-prioritize the last registered PLMN (RPLMN) or the last registered Network (for e.g. NTN), optionally over NR/E-UTRAN Satellite access/RAT last registered PLMN (RPLMN) or the last registered Network (for e.g. NTN), optionally over or by lowering the priority of satellite access/NTN RATs, optionally during Discontinuous Coverage or unavailability period or during a duration when NTN or the last registered network is not available, according to an embodiment of the disclosure;

FIG. 17 depicts an example scenario, wherein the UE shall disable/ignore/postpone/de-prioritize the last registered PLMN (RPLMN) or the last registered Network (for e.g. NTN or the like), optionally over NR/E-UTRAN Satellite access/RAT last registered PLMN (RPLMN) or the last registered Network (for e.g. NTN), optionally over or by lowering the priority of satellite access/NTN RATs, optionally during Discontinuous Coverage or unavailability period or during a duration when NTN or the last registered network is not available, according an embodiment of the disclosure;

FIG. 18 depicts an example scenario, wherein the UE shall disable/ignore/postpone/de-prioritize the last registered PLMN (RPLMN) or the last registered Network (for e.g. NTN), optionally over NR/E-UTRAN Satellite access/RAT last registered PLMN (RPLMN) or the last registered Network (for e.g. NTN), optionally over or by lowering the priority of satellite access/NTN RATs, optionally during Discontinuous Coverage or unavailability period or during a duration when NTN or the last registered network is not available, according to an embodiment of the disclosure;

FIGS. 19 and 20 depicts an example scenario, wherein the UE shall disable/ignore/postpone/de-prioritize the last registered PLMN (RPLMN) or the last registered Network (for e.g. NTN), optionally over NR/E-UTRAN Satellite access/RAT last registered PLMN (RPLMN) or the last registered Network (for e.g. NTN), optionally over or by lowering the priority of satellite access/NTN RATs, optionally during Discontinuous Coverage or unavailability period or during a duration when NTN or the last registered network is not available, according to various embodiments of the disclosure; and

FIG. 21 depicts an example scenario, wherein the UE shall disable/ignore/postpone/de-prioritize the last registered PLMN (RPLMN) or the last registered Network (for e.g. NTN), optionally over NR/E-UTRAN Satellite access/RAT last registered PLMN (RPLMN) or the last registered Network (for e.g. NTN), optionally over or by lowering the priority of satellite access/NTN RATs, optionally during Discontinuous Coverage or unavailability period or during a duration when NTN or the last registered network is not available, according to an embodiment of the disclosure.

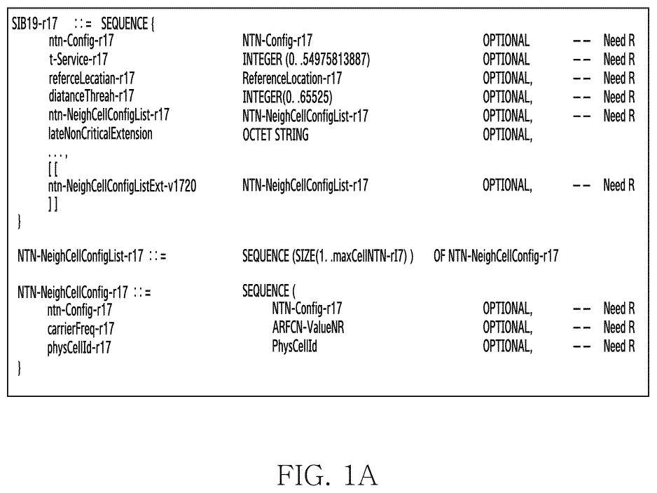

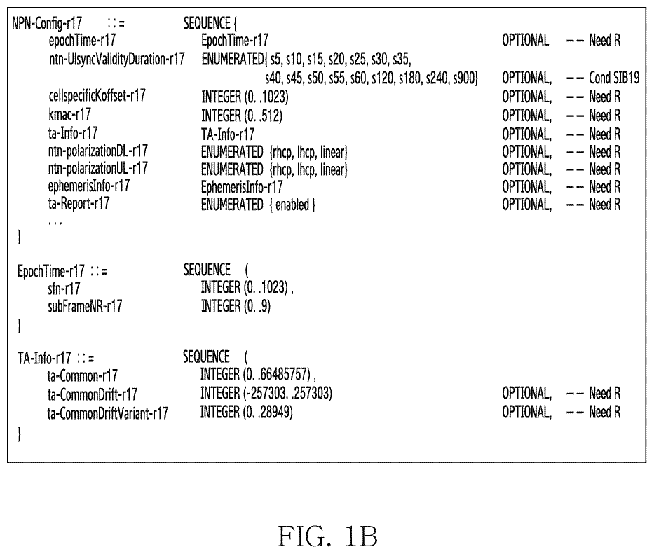

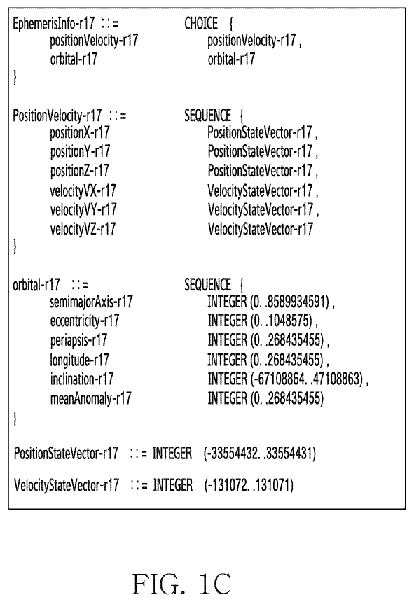

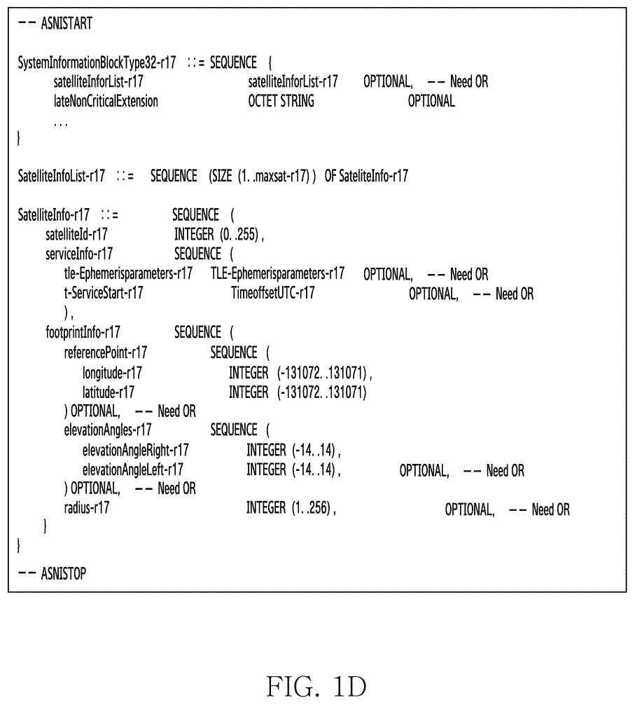

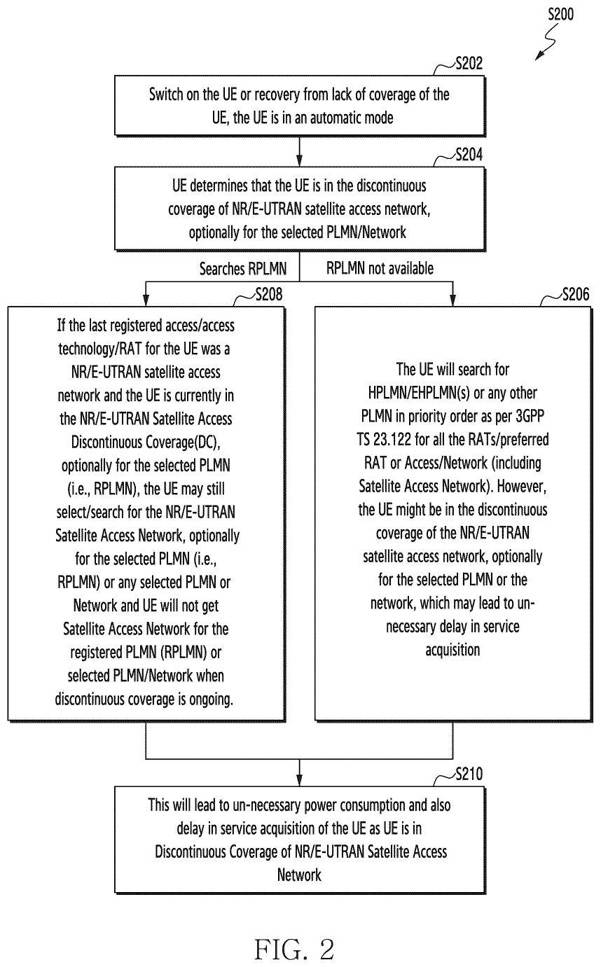

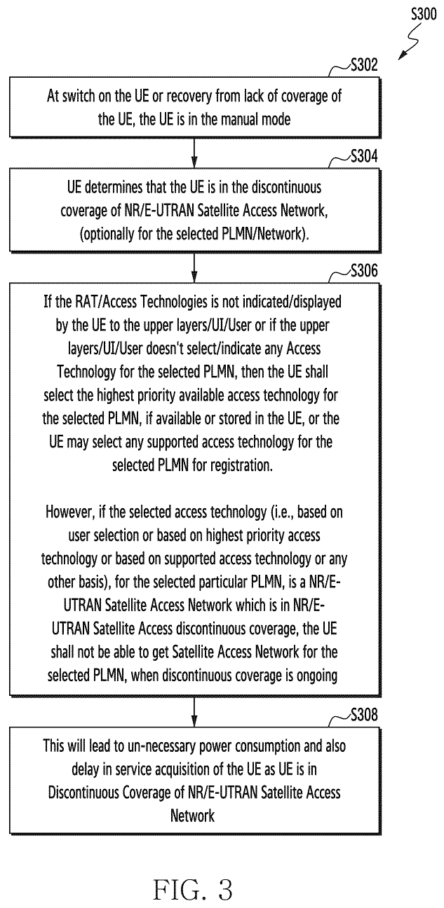

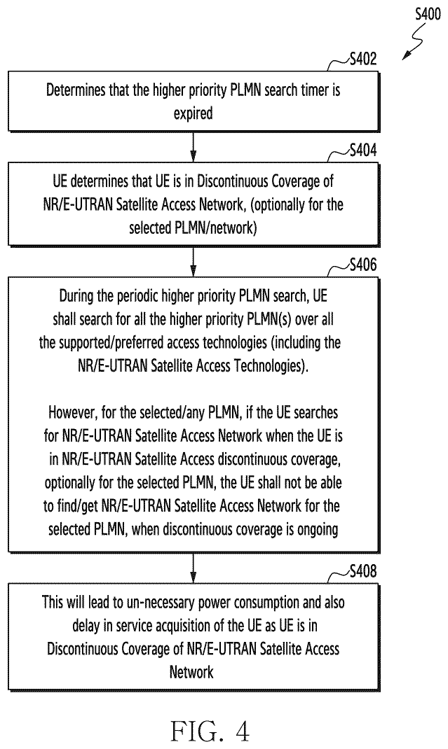

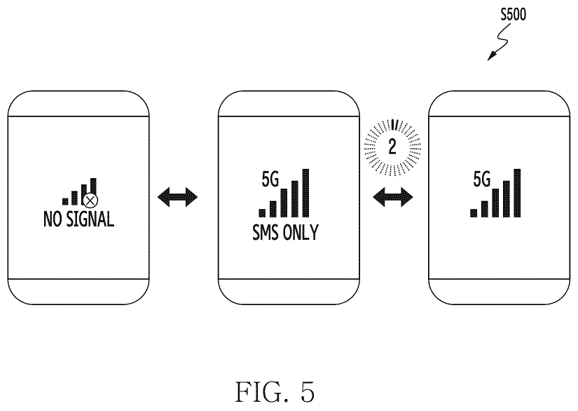

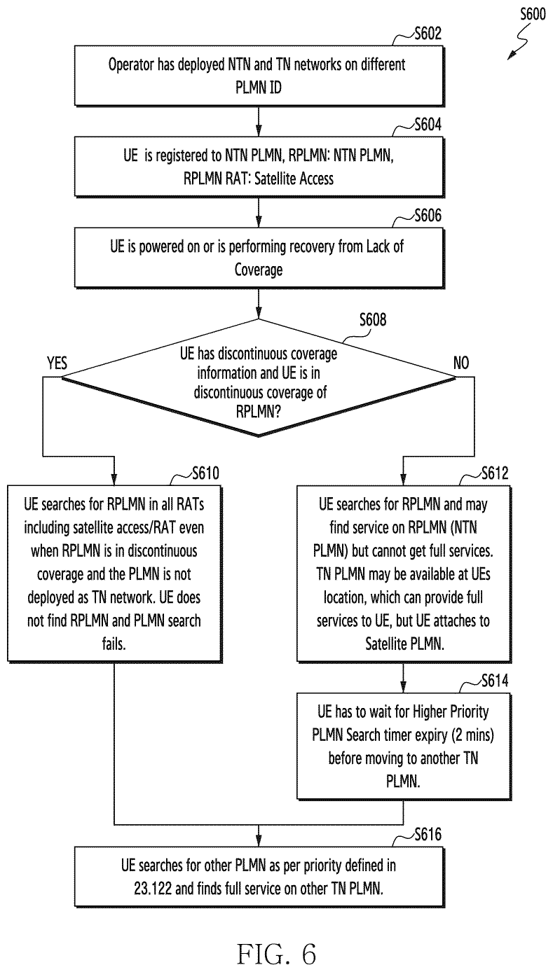

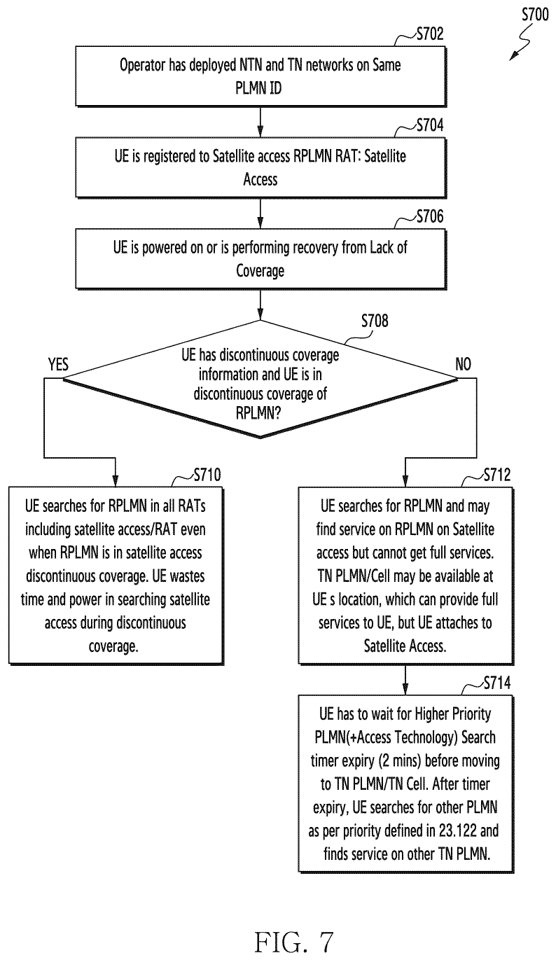

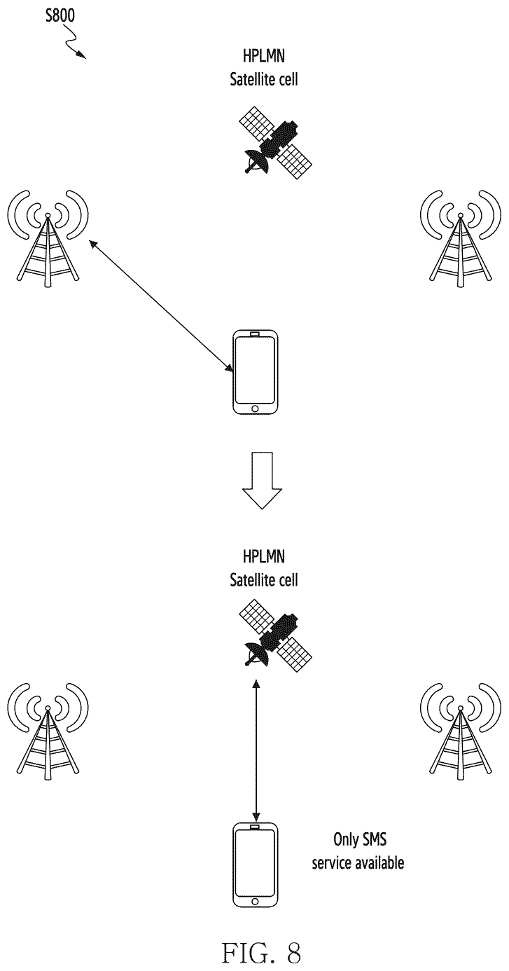

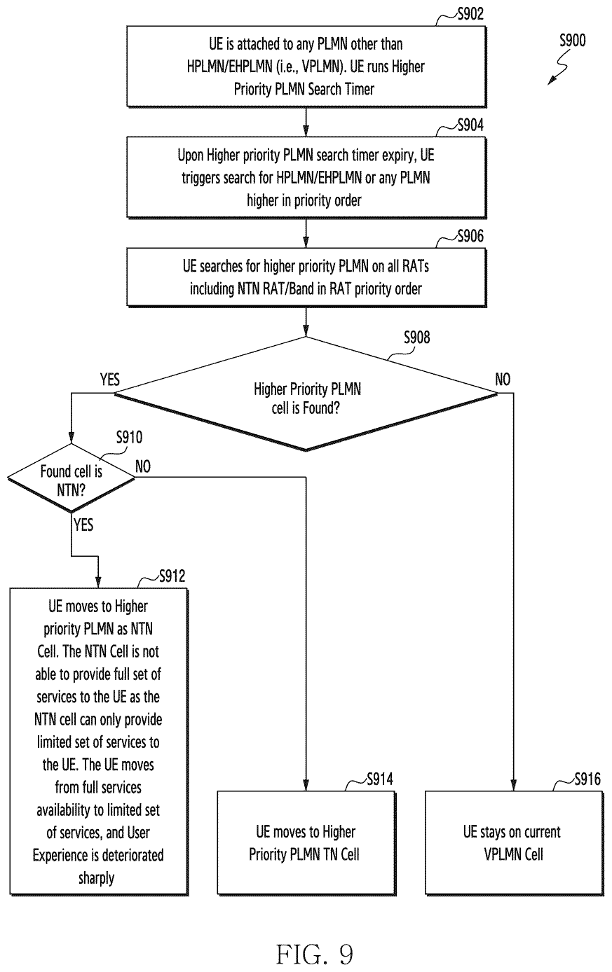

Throughout the drawings, like reference numerals will be understood to refer to like parts, components, and structures.

### DETAILED DESCRIPTION

The following description with reference to-the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the document, the word “exemplary” is used herein to mean “serving as an example, instance, or illustration.” Any embodiment or implementation of the subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however, that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or operations does not include only those components or operations but may include other components or operations not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the disclosure. The following description is, therefore, not to be taken in a limiting sense.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/operations is for the purposes of this description and should not be construed as sequential ordering/placement/occurrence unless specified otherwise.

The embodiments herein achieve methods for selecting a network by the UE. The method includes triggering a network search procedure. Further, the method includes determining if a last registered network is an NTN. Further, the method includes ignoring the last registered network, if the last registered Network is the NTN. Further, the method includes performing the network search procedure for the terrestrial network (TN). The proposed method ensures that the UE (for e.g. NTN capable UE or the like) does not perform RPLMN search first (for e.g. ignore the RPLMN or the last registered Network) upon Switch On or Recovery from Lack of coverage or upon modem power up or power cycle or upon exiting airplane mode or upon modem reset or upon SIM REFRESH or upon any trigger conditions if the RPLMN or the last registered system/network is an NTN PLMN or NTN, and directly select or scan or search for TN PLMN or Terrestrial Network or Terrestrial Cellular Networks resulting in quick and better services for the user.

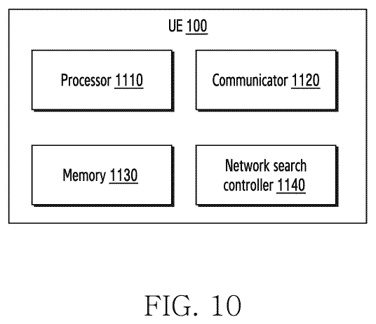

Referring now to the drawings, and more particularly to FIGS. 10 through 20, where similar reference characters denote corresponding features consistently throughout the figures, there are shown at least one embodiment.

The following abbreviations and definitions have been referred to herein:
a. 3GPP: Third Generation Partnership Project
b. 5GC: 5G Core
c. 5GCN: 5G Core Network
d. 5G-GUTI: 5G-Globally Unique Temporary Identifier
e. 5GMM: 5G Mobility Management
f. 5GS: 5G System
g. 5GSM: 5GS Session Management
h. 5G-S-TMSI: 5G S-Temporary Mobile Subscription Identifier
i. 5G-TMSI: 5G Temporary Mobile Subscription Identifier
j. AI: Artificial Intelligence
k. AMF: Access and Mobility Management Function
l. AS: Access Stratum
m. BSR: Better System Reselection
n. CAG: Closed access group
o. CAG ID: Closed Access Group Identifier
p. CN: Core Network
q. CU: Centralized Unit
r. DB: Database
s. DC: Discontinuous Coverage
t. DisCo: Discontinuous Coverage
u. DL: Downlink
v. DRX: Discontinuous Reception
w. DU: Distributed Unit
x. eDRX: Extended Discontinuous Reception
y. EHPLMN: Equivalent Home Public Land Mobile Network
z. EMM: EUTRA Mobility Management
aa. eNB: Evolved Node-B
bb. eNPN: Enhanced Non-Public Networks
cc. EPC: Evolved Packet Core
dd. EPLMN: Equivalent Public Land Mobile Network
ee. EPS: Evolved Packet System
ff. eSIM: embedded Subscriber Identity Module
gg. E-UTRA: Evolved Universal Mobile Telecommunication Access
hh. EUTRAN: Evolved Universal Mobile Telecommunication Access Network
ii. FPLMN: Forbidden Public Land Mobile Network
jj. FR: Frequency Range
kk. GEO: Geostationary Orbit
ll. GERAN: GSM Edge Radio Access Network
mm. GERAN EC-GSM-IoT: GSM Edge Radio Access Network Extended Coverage-GSM-Internet of Things
nn. gNB: Next generation Node-B
oo. gNB—CU: Next generation Node-B Control Unit
pp. gNB—DU: Next generation Node-B Distributive Unit
qq. GPRS: General Packet Radio Service
rr. GSM: Global System for Mobile Communication
ss. HPPLMN: Higher Priority Public Land Mobile Network
tt. HPLMN: Home Public Land Mobile Network
uu. IAB: Integrated access and backhaul
vv. IAB-UE: The part of the IAB node that supports the Uu interface towards the IAB-donor or another parent IAB-node (and thus manages the backhaul connectivity with either PLMN or SNPN it is registered with) is referred to as an IAB-UE.
ww. LADN: Local Area Data Network
xx. LEO: Low Earth Orbit
yy. LRPLMN: Last Registered Public Land Mobile Network
zz. LRPLMNSI: Last Registered PLMN Selection Indication
aaa. LRRAT: Last Registered Radio Access Technology
bbb. MCC: Mobile Country Code
ccc. ME: Mobile Equipment
ddd. MEC: Multi-Access Edge Computing
eee. MEO: Medium Earth Orbit
fff. MICO: Mobile Initiated Communication Only
ggg. ML: Machine Learning
hhh. MME: Mobility Management Entity
iii. MNC: Mobile Network Code
jjj. MPS: Multimedia Priority Service
kkk. MS: Mobile Station. The present document makes no distinction between MS and UE.
lll. NAS: Non-Access Stratum
mmm. NB-S1 Mode: Narrow Band with S1 Interface
nnn. NF: Network Function
ooo. NGAP: Next Generation Application Protocol
ppp. NG-RAN: Next Generation Radio Access Network
qqq. Non-3GPP: Non-3^{rd} Generation Participation Project
rrr. NPN: Non-Public Networks
sss. NR: New Radio
ttt. NTN: Non Terrestrial Networks
uuu. NW: Network
vvv. OOS: Out of Service
www. OS Upgrade: Operating System Upgrade
xxx. PDN: Packet Data Network
yyy. PDU: Packet Data Unit
zzz. PLMN ID: Public Land Mobile Network Identity
aaaa. PSM: Power Saving Mode
bbbb. QoS: Quality Of Service
cccc. RAT: Radio Access Technology
dddd. RPLMN: Registered Public Land Mobile Network
eeee. RRC: Radio Resource Control
ffff. RU: Registration Update
gggg. SAT: Satellite
hhhh. Satellite: an artificial body placed in orbit round the earth or moon or another planet in order to collect information or for communication.
iiii. Satellite Constellation: Group of satellites, placed in orbit round the earth or moon or another planet in order to collect information or for communication.
jjjj. SCAF: Satellite Coverage Availability Function
kkkk. SCAI: Satellite Coverage Availability Information
llll. Service User: An individual who has received a priority level assignment from a regional/national authority (i.e., an agency authorised to issue priority assignments) and has a subscription to a mobile network operator
mmmm. SIM: Subscriber Identity Module
nnnn. SMS: Short Messaging Service
oooo. SNPN: Standalone Non-Public Networks
pppp. SUCI: Subscription Concealed Identifier
qqqq. SW: Software
rrrr. TAC: Tracking Area Code
ssss. TAI: Tracking Area Identity
tttt. TAU: Tracking Area Update
uuuu. TER: Terrestrial
vvvv. TMO: T-Mobile
wwww. TN: Terrestrial Networks
xxxx. UCU: UE Configuration Update
yyyy. UDM: Unified Data Management Function
zzzz. UE: User Equipment
aaaaa. UL: Uplink
bbbbb. ULI: User Location Information
ccccc. UPU: UE Parameters Update
ddddd. USIM: Universal Subscriber Identification Module
eeeee. Uu: The radio interface between the UE and the Node B
fffff. VMR: Vehicle Mounted Relay
ggggg. VPLMN: Visited Public Land Mobile Network
hhhhh. VZW: Verizon Wireless
iiiii. WB-S1 Mode: Wide Band with S1 Interface
jjjjj. Visited PLMN (VPLMN): This is a PLMN different from the HPLMN (if the EHPLMN list is not present or is empty) or different from an EHPLMN (if the EHPLMN list is present).
kkkkk. Allowable PLMN: In the case of an MS operating in MS operation mode A or B, this is a PLMN which is not in the list of “forbidden PLMNs” in the MS. In the case of an MS operating in MS operation mode C or an MS not supporting A/Gb mode and not supporting Iu mode, this is a PLMN which is not in the list of “forbidden PLMNs” and not in the list of “forbidden PLMNs for GPRS service” in the MS.
lllll. Available PLMN: PLMN(s) in the given area which is/are broadcasting capability to provide wireless communication services to the UE.
mmmmm. Camped on a cell: The MS (ME if there is no SIM) has completed the cell selection/reselection process and has chosen a cell from which it plans to receive all available services. Note that the services may be limited, and that the PLMN or the SNPN may not be aware of the existence of the MS (ME) within the chosen cell.
nnnnn. EHPLMN: Any of the PLMN entries contained in the Equivalent HPLMN list.
ooooo. Equivalent HPLMN list: To allow provision for multiple HPLMN codes, PLMN codes that are present within this list shall replace the HPLMN code derived from the IMSI for PLMN selection purposes. This list is stored on the USIM and is known as the EHPLMN list. The EHPLMN list may also contain the HPLMN code derived from the IMSI. If the HPLMN code derived from the IMSI is not present in the EHPLMN list then it shall be treated as a Visited PLMN for PLMN selection purposes.
ppppp. Home PLMN: This is a PLMN where the MCC and MNC of the PLMN identity match the MCC and MNC of the IMSI.
qqqqq. Registered PLMN (RPLMN): This is the PLMN on which certain LR (location registration which is also called as registration procedure) outcomes have occurred. In a shared network the RPLMN is the PLMN defined by the PLMN identity of the CN operator that has accepted the LR.
rrrrr. Registration: This is the process of camping on a cell of the PLMN or the SNPN and doing any necessary LRs.
sssss. UPLMN: PLMN/access technology combination in the “User Controlled PLMN Selector with Access Technology” data file in the SIM (in priority order).
ttttt. OPLMN: PLMN/access technology combination in the “Operator Controlled PLMN Selector with Access Technology” data file in the SIM (in priority order) or stored in the ME (in priority order).

NAS messages as referred to herein can be (but not limited to) REGISTRATION REQUEST message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; REGISTRATION ACCEPT; DEREGISTRATION ACCEPT; SERVICE REJECT; SERVICE ACCEPT; UE CONFIGURATION UPDATE command, UE PARAMETERS UPDATE command, and so on.

The term 5GMM sublayer states in this embodiment are at least one of the below:
1) 5GMM-NULL
2) 5GMM-DEREGISTERED
a) 5GMM-DEREGISTERED.NORMAL-SERVICE
b) 5GMM-DEREGISTERED.LIMITED-SERVICE
c) 5GMM-DEREGISTERED.ATTEMPTING-REGISTRATION
d) GMM-DEREGISTERED.PLMN-SEARCH
e) 5GMM-DEREGISTERED.NO-SUPI
f) 5GMM-DEREGISTERED.NO-CELL-AVAILABLE
g) 5GMM-DEREGISTERED.eCALL-INACTIVE
h) 5GMM-DEREGISTERED.INITIAL-REGISTRATION-NEEDED
3) 5GMM-REGISTERED-INITIATED
4) 5GMM-REGISTERED
a) 5GMM-REGISTERED.NORMAL-SERVICE
b) 5GMM-REGISTERED.NON-ALLOWED-SERVICE
c) 5GMM-REGISTERED.ATTEMPTING-REGISTRATION-UPDATE
d) 5GMM-REGISTERED.LIMITED-SERVICE
e) 5GMM-REGISTERED.PLMN-SEARCH
f) 5GMM-REGISTERED.NO-CELL-AVAILABLE
g) 5GMM-REGISTERED.UPDATE-NEEDED
5) 5GMM-DEREGISTERED-INITIATED
6) 5GMM-SERVICE-REQUEST-INITIATED

In this embodiment, the term EMM sublayer states are at least one of the below:
1) EMM-NULL
2) EMM-DEREGISTERED
a) EMM-DEREGISTERED.NORMAL-SERVICE
b) EMM-DEREGISTERED.LIMITED-SERVICE
c) EMM-DEREGISTERED.ATTEMPTING-TO-ATTACH
d) EMM-DEREGISTERED.PLMN-SEARCH
e) EMM-DEREGISTERED.NO-IMSI
f) EMM-DEREGISTERED.ATTACH-NEEDED
g) EMM-DEREGISTERED.NO-CELL-AVAILABLE
h) EMM-DEREGISTERED.eCALL-INACTIVE
3) EMM-REGISTERED-INITIATED
4) EMM-REGISTERED
a) EMM-REGISTERED.NORMAL-SERVICE
b) EMM-REGISTERED.ATTEMPTING-TO-UPDATE
c) EMM-REGISTERED.LIMITED-SERVICE
d) EMM-REGISTERED.PLMN-SEARCH
e) EMM-REGISTERED.UPDATE-NEEDED
f) EMM-REGISTERED.NO-CELL-AVAILABLE
g) EMM-REGISTERED.ATTEMPTING-TO-UPDATE-MM
h) EMM-REGISTERED.IMSI-DETACH-INITIATED
5) EMM-DEREGISTERED-INITIATED
6) EMM-TRACKING-AREA-UPDATING-INITIATED
7) EMM-SERVICE-REQUEST-INITIATED

The term RAT as defined herein can be one of the following: Next Generation Radio Access Network (NG-RAN), 5G, Fourth Generation (4G), Third Generation (3G), Second Generation (2G), EPS, 5G System (5GS), NR, NR in unlicensed bands, NR(LEO) satellite access, NR(MEO) satellite access, NR(GEO) satellite access, NR(OTHERSAT) satellite access, NR RedCap, E-UTRA, E-UTRA in unlicensed bands

NB-IoT, WB-IoT, LTE-M, and so on.

5GS registration type can be initial registration, mobility registration, updating periodic registration, updating emergency registration, SNPN onboarding registration, disaster roaming initial registration/disaster roaming mobility registration updating, and so on.

Not set the registration type to disaster roaming initial registration or disaster roaming mobility registration updating means 5GS registration type is set to value other than “disaster roaming initial registration” or ““disaster roaming mobility registration updating” at least one of initial registration, mobility registration updating, periodic registration updating, emergency registration, SNPN onboarding registration, and so on.

PLMN selection as per 23.122 without RPLMN: The MS selects and attempts registration on any PLMN/access technology combinations, if available and allowable, in the following order:
a) either the HPLMN (if the EHPLMN list is not present or is empty) or the highest priority EHPLMN that is available (if the EHPLMN list is present);
b) each PLMN/access technology combination in the “User Controlled PLMN Selector with Access Technology” data file in the SIM (in priority order);
c) each PLMN/access technology combination in the “Operator Controlled PLMN Selector with Access Technology” data file in the SIM (in priority order) or stored in the ME (in priority order);
d) other PLMN/access technology combinations with received high quality signal in random order; and
e) other PLMN/access technology combinations in order of decreasing signal quality.

PLMN selection as per 23.122 with RPLMN: The MS selects and attempts registration on any PLMN/access technology combinations, if available and allowable, in the following order:
a) either the RPLMN or the Last registered PLMN;
b) either the HPLMN (if the EHPLMN list is not present or is empty) or the highest priority EHPLMN that is available (if the EHPLMN list is present);
c) each PLMN/access technology combination in the “User Controlled PLMN Selector with Access Technology” data file in the SIM (in priority order);
d) each PLMN/access technology combination in the “Operator Controlled PLMN Selector with Access Technology” data file in the SIM (in priority order) or stored in the ME (in priority order);
e) other PLMN/access technology combinations with received high quality signal in random order; and
f) other PLMN/access technology combinations in order of decreasing signal quality.

The terms UE and MS are used interchangeably in this embodiment and have the same meaning.

The term area/location/geographical area are used in this embodiment may refer to any of cell/cell ID, Tracking Area Code (TAC)/TAI, PLMN, Mobile Country Code (MCC)/Mobile Network Code (MNC), Latitude/longitude, Closed access group (CAG) cell or any geographical location/coordinate.

The solutions explained in this embodiment are applicable to any (but not limited to) of the RAT(s) as defined in this embodiment.

The Network used in this embodiment could be any 5G/EUTRAN Core Network Entities like AMF/Session Management Function (SMF)/Mobility Management Entity (MME)/User Plane Function (UPF) or the Network could be any (but not limited to) 5G/EUTRAN RAN Entity like eNodeB (eNB) or gNodeB (gNB) or NG-RAN etc.

The terms unavailability period duration, unavailability period, discontinuous coverage, discontinuous coverage period and unavailability duration are interchangeably used and have the same meaning.

The terms start time, start of unavailability period, start of unavailability duration, start of discontinuous coverage, start of discontinuous coverage period and start of unavailability period duration are interchangeably used and have the same meaning.

The terms support of/for “Unavailability Period” and “Unavailability Period Support” are used interchangeably and have the same meaning. The NTN and TN could either operate in two different frequency bands (e.g. FR1 vs FR2), or in same frequency band (e.g. FR1 or FR2). The terms Satellite 3GPP access, Satellite access, Satellite Access Network, NR Satellite Access Network, Satellite NG-RAN Access Technology and NR Satellite access have been interchangeably used and have the same meaning. The methods, issues or solutions disclosed in this embodiment are explained using NR satellite access or Satellite NG-RAN Access Technology as an example and is not restricted or limited to NR Satellite access only. However, the solutions proposed in this embodiment are also applicable for Satellite E-UTRAN access Technology, Narrow Band (NB)-S1 mode or Wide Band (WB)-S1 mode via satellite E-UTRAN access and/or NarrowBand Internet of Things (NB-IOT) or WideBand Internet of Things (WB-IOT) Satellite Access/Architecture. The solutions which are defined for NR (5G Core (5GC)) are also applicable to legacy RATs like E-UTRA/LTE, the corresponding CN entities needs to be replaced by LTE entities for e.g. AMF with MME, g-nodeB with e-nodeB, Unified Data Management Function (UDM) with Home Subscriber Server (HSS) etc. But principles of the solution remain same. An example list of NAS messages can be, but not limited to, REGISTRATION REQUEST message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; DEREGISTRATION ACCEPT; SERVICE REJECT; SERVICE ACCEPT, and so on.

The Network used in this embodiment is explained using any 5G Core Network Function for e.g. AMF. However, the network could be any 5G/EUTRAN Core Network Entities like AMF/SMF/MME/UPF or the Network could be any 5G/EUTRAN RAN Entity like eNodeB (eNB) or gNodeB (gNB) or NG-RAN etc.

The messages used or indicated in this embodiment are shown as an example. The messages could be any signalling messages between UE and the Network Functions/Entities or between different Network functions/entities. The term area/location/geographical area are used in this embodiment may refer to any of cell/cell ID, TAC/TAI, PLMN, MCC/MNC, Latitude/longitude, CAG cell or any geographical location/coordinate. The 3GPP Technical document and references and the version number given in this embodiment are for reference/example and may be present in or refer to any of the 3GPP Technical documents or references. In this embodiment, SIB19, SIB32 are given for examples and the parameters/indication from Network can be configured in any of the broadcast or signalling messages. The methods, issues or solutions disclosed in this embodiment are explained using NR access or NG-RAN Access Technology as an example and is not restricted or limited to NR access only. However, the solutions proposed in this embodiment are also applicable for E-UTRAN access Technology, NB-S1 mode or WB-S1 mode via E-UTRAN access and/or NB-IOT or WB-IOT Access/Architecture.

The solutions which are defined for NR(5GC) are also applicable to legacy RATs like E-UTRA/LTE, the corresponding CN entities needs to be replaced by LTE entities for e.g. AMF with MME, g-nodeB with e-nodeB, UDM with HSS etc. But principles of the solution remain same.

The Network used in this embodiment is explained using any 5G Core Network Function for e.g. AMF. However, the network could be any 5G/EUTRAN Core Network Entities like AMF/SMF/MME/UPF or the Network could be any 5G/EUTRAN RAN Entity like eNodeB (eNB) or gNodeB (gNB) or NG-RAN etc.

The messages used or indicated in this embodiment are shown as an example. The messages could be any signalling messages between UE and the Network Functions/Entities or between different Network functions/entities.

The terms camp and register are used interchangeably and have the same meaning.

The terms wait timer, DisCo wait timer, Discontinuous Coverage wait timer, Random timer, Random wait timer, DCW Timer are all used interchangeably and have the same meaning.

The terms wait range, Disco Wait Range, Discontinuous Coverage Wait Range, DCW Range are all used interchangeably and have the same meaning.

The term area as used in this embodiment may refer to any of cell/cell ID, TAC/TAI, PLMN, MCC/MNC, Latitude/longitude, any CAG/CAG identifier or any geographical location/coordinate. In this embodiment, RPLMN and LRPLMN may refer to the same thing and have same meaning. In this embodiment, Registered PLMN and Last Registered PLMN may refer to the same thing and have same meaning.

The terms searching, scanning, selecting, registering, attaching, initiating Tracking Area Update (TAU) and camping have been used interchangeable and have same meaning.

For the list of possible NAS messages please refer to 3GPP TS 24.501 or 3GPP TS 24.301, for list of AS messages please refer to 3GPP TS 38.331 or 3GPP TS 36.331

The cause names in this embodiment are for illustration purpose and it can have any name. The non access stratum (NAS) messages and access stratum (AS) messages described in this embodiment is only for illustration purpose it can be any NAS or AS messages as per defined protocol between UE and AMF/MME or UE and gNB (NG-RAN/any RAN node)/eNB.

The term Network as used in this embodiment may refer to any PLMN, RAT, Access, Access Technology or any combination of these.

The term NTN or NR/E-UTRAN Satellite Access Network as used in this embodiment may refer to any of the NR Satellite Access Network or E-UTRAN Satellite Access Network or NR Satellite Access Technology or E-UTRAN Satellite Access Technology.

The terms unavailability period duration, unavailability period, discontinuous coverage, discontinuous coverage period and unavailability duration are interchangeably used and have the same meaning.

The terms start time, start of unavailability period, start of unavailability duration, start of discontinuous coverage, start of discontinuous coverage period and start of unavailability period duration are interchangeably used and have the same meaning.

In Non Terrestrial Networks (NTN), Continuous satellite coverage can be characterized by the fact that Uu interface is available for the UE, at a given position for 100% of the time.

In Non Terrestrial Networks (NTN), Discontinuous satellite coverage can be characterized by the fact that Uu interface is available for the UE, at a given position, less than 100% of the time, due to predictable lack of satellite coverage.

Due to Discontinuous coverage, the UE may have access to satellite service coverage only at specific time and places.

At switch on, or following recovery from lack of coverage or when the UE is periodically searching for PLMN or higher priority PLMN after the expiry of the timer T, if the UE was registered(on RPLMN) with 5GC is via satellite access), or if UE determines that UE is in Discontinuous Coverage (DC) or if UE determines a PLMN/Network is not available over Satellite Access/NTN RAT based on unavailability period/duration or based on start of unavailability period or based on Start Time/End Time whenever Discontinuous Coverage (DC) is ongoing for those NTN PLMN/Network, then UE shall disable/ignore/postpone/de-prioritize/not select/select or search with lowest priority the last registered PLMN (RPLMN) or any selected PLMN/Network on Satellite Access/NTN RATs or HPLMN/EHPLMN list (if there is no RPLMN) or any higher priority PLMN over satellite access.

In yet another embodiment, the UE can search for RPLMN or any selected PLMN/Network on another RATs/access/access technology other than NR/E-UTRAN Satellite access/access technology during the unavailability period duration and select the RPLMN/selected PLMN over other RATs/access technologies if available.

In yet another embodiment, when the UE determines that UE is in discontinuous coverage, UE shall disable the satellite access or lower the priority of Satellite Access RAT.

When the UE determines that UE is in discontinuous coverage, UE shall ignore Satellite Access RAT Frequencies while performing the PLMN search.

In yet another embodiment, if UE the knows (though machine learning/AI/ML/historic data/database or though pre-configuration or operator deployment that a PLMN/Network is only deployed over NTN RATs/satellite access and is not deployed over TN and currently is not available due to discontinuous coverage (for ex-based on unavailability period/duration or Start Time/End Time whenever Discontinuous Coverage (DC) is ongoing for those NTN PLMN/Network), then UE shall not search for those PLMN/network during any PLMN Search procedure (i.e., During Switch Off/Switch ON or during OOS recovery or during Higher Priority PLMN Search or during cell selection/reselection etc.).

In embodiments herein, the terms RAT and access are used interchangeably.

In embodiments herein, the terms power-on and switch-on are used interchangeably.

In embodiments herein, the terms out of service (OOS) recovery or following recovery from lack of coverage are used interchangeably. In embodiments herein, the solutions are explained using the switch On and recovery from lack of coverage as an example. However the solutions are applicable to any trigger conditions, for e.g. at-least one of but not limited to (in any order or combinations): a switch OFF the UE, a switch ON the UE, a recovery of the UE from lack of a coverage area, a recovery of the UE from an OOS area, a SIM insertion in the UE, a SIM re-insertion post removal in the UE, a SIM removal in the UE, a disabling of the SIM in the UE, an enabling of the SIM in the UE, a modem reset, a power cycle, a modem power up, a modem power cycle, an airplane mode ON in the UE, an airplane mode OFF in the UE, a UE exiting airplane mode, a UE entering airplane mode, a modem exiting airplane mode, an activation of the UE, a reject cause from the network, a detach triggered by the network, a deregistration triggered by the network, on entering store and forward mode in the UE, on exiting store and forward mode in the UE, on entering store and forward mode from the network, on exiting store and forward mode from the network, a detach triggered by the UE, a deregistration triggered by the UE, a network mode change in the UE, a network selection mode change in the UE, an operating mode change in the UE, on entering satellite mode in the UE, on exiting satellite mode in the UE, a turning on of a modem, and a SIM refresh procedure. These events may also be referred to as “trigger conditions” in this embodiment. The events may also include scenarios where the UE need to trigger or perform a Network Search or selection or scanning procedure, a PLMN Search or selection or scanning procedure, a Cell search or selection or scanning procedure or a RAT/Access Search or selection or scanning procedure. In embodiments herein, the solutions are explained using higher priority PLMN search timer expiry as an example. However, the solutions are applicable to any trigger conditions, for e.g. at least one of: an expiry of a timer for higher priority PLMN search procedure, a handover procedure, a redirection procedure, a reselection procedure, an expiry of a timer for Better System Reselection (BSR), an expiry of an operator defined timer, a background network search procedure, an idle mode procedure, a connected mode procedure and a network release procedure. The events may also include scenarios where the UE need to trigger or perform a network search or selection or scanning procedure, a PLMN search or selection or scanning procedure, a cell search or selection or scanning procedure or a RAT/Access Search or selection or scanning procedure. In embodiments herein, the solutions are explained by applying during the network search procedure. However, the solutions are also applicable before or during or after the network search procedure and the core principle remains the same.

In embodiments herein, after the network search procedure, the UE may camp or attach or register on any of the selected available network. The UE may prefer to camp or attach or register or trigger a TAU on TN before triggering a search or scanning for the NTN and optionally, camping or attaching or registering or triggering a TAU on TN. The terms search, select and scan are used interchangeably and have the same meaning.

The terms EF_LOCI, EF-LOCI and EFLOCI are used interchangeably and have the same meaning. The terms EF_EPSLOCI, EF-EPSLOCI and EFEPSLOCI are used interchangeably and have the same meaning. The terms EF_PSLOCI, EFPSLOCI and EFPSLOCI are used interchangeably and have the same meaning. The terms EF_5GS3GPPLOCI, EF-5GS3GPPLOCI and EF5GS3GPPLOCI are used interchangeably and have the same meaning. The terms EF_LRPLMNSI, EFLRPLMNSI and EFLRPLMNSI are used interchangeably and have the same meaning. In embodiments herein, the solutions are explained by using the network search or PLMN search as an example. However, the solutions are also applicable to any of the network search or selection or scanning procedure, a PLMN Search or selection or scanning procedure, a cell search or selection or scanning procedure or a RAT/Access Search or selection or scanning procedure and the core principle remains the same. In embodiments herein, an “allowable network” for the UE may be those Network(s) which are not a part of any of the back-off network list or a forbidden network list or a temporary back-off/forbidden Network list of the UE. It may refer to a network on which UE is allowed to camp or register to get normal or full services.

In embodiments herein, Acceptable Cell/Network: Acceptable cell/Network is the cell/Network that is not enough to be a suitable cell/Network, but meets the minimum condition at least to make an emergency call. The minimum conditions are:
a) The cell/Network is not barred
b) The cell/Network selection criteria is met

In embodiments herein, Suitable Cell/Network: The cell/Network that the UE may camp on for a normal service. The E-UTRA and UTRA Suitable Cell/Network criteria is defined in 3GPP TS 36.304 and NR Suitable Cell/Network criteria is defined in 3GPP TS 38.304.

In embodiments herein, a “non-availability of a Terrestrial Network (TN) coverage at the location of the UE” may refer to a situation where there may be no terrestrial network available at the location of the UE or there may be terrestrial network(s) available in the location of the UE but those Terrestrial Network may not be suitable or allowable for the UE for getting normal services (for e.g. UE may not be able to get normal services (for e.g. full set of services such as Voice, Data, SMS etc.) from those terrestrial network. Those terrestrial network may be a part of a forbidden list present in the UE). The UE may assume that the UE is in a location where Terrestrial Network coverage is not available. There may be terrestrial network(s) available in those area, but those Terrestrial Network may not be suitable or allowable for the UE for getting normal services (for e.g. UE may not be able to get normal services (for e.g. full set of services such as Voice, Data, SMS etc.) from those terrestrial network (for e.g. those terrestrial network may not have any partnership with the Network Operator or Home PLMN (HPLMN) of the UE and may not provide normal services to the UE). Those terrestrial network may be a part of a forbidden list present in the UE). The UE may assume that the UE is in a location where Terrestrial Network coverage is not available and only NTN coverage may be available in the location which may provide normal service to the UE (for e.g. normal service with only SMS or Data etc.). The NTN may be deployed by the HPLMN or any of the partner network of the Network Operator/HPLMN of the UE.

In embodiments herein, a “presence of the UE in an NTN only coverage area” may refer to a situation where there may be only non-terrestrial network available at the location of the UE or there may be NTN available at the location of the UE and there may be terrestrial network(s) available in the location of the UE but those Terrestrial Network may not be suitable or allowable for the UE for getting normal services (for e.g. UE may not be able to get normal services (for e.g. full set of services such as Voice, Data, SMS etc.) from those terrestrial network.

In embodiments herein, the device may add the selected or the registered Network (for e.g. PLMN or RAT or Cell or any combination of these to any temporary back-off Network List or forbidden Network List or any back-off list) which may lead to delay in the acquisition of available NTN services

In embodiments herein, a “temporary forbidden PLMN list” refers to a list of Public Land Mobile Networks (PLMNs) stored at the UE. The list indicates the PLMNs the UE is temporarily configured to avoid camping or registering. The list indicates the list of PLMN(s) which are not a part of allowable PLMN(s) of the UE. The UE may not be allowed to register or attach to the list of the PLMN(s) which are a part of “temporary forbidden PLMN list” for normal services.

In embodiments herein, the back-off timer in the 3GPP standard is a mechanism used to control the frequency of retransmissions in a wireless communication system. The back-off timer is mainly utilized to alleviate the overload of the Mobility Management Entity (MME) or AMF or a RAN entity (for e.g. g-NodeB or NG-RAN or eNodeB etc.) and to resolve congestion at the Serving Gateway (S-GW), or the SMF or the UPF or and the Packet Data Gateway (P-GW).

The solutions and procedures which are defined for NR(5GC) are also applicable to legacy RATs like E-UTRA/LTE, the corresponding 5G CN entities needs to be replaced by LTE entities for e.g. AMF with MME, g-nodeB with e-nodeB, UDM with HSS etc. Similarly, the corresponding 5G procedures needs to be replaced by LTE procedures for e.g. Registration procedure with Attach Procedure, Registration procedure for mobility registration updating with TAU procedure, Deregistration Procedure with Detach procedure and so on. But principles of the solution remain same.

The Network used in this embodiment is explained using any 5G Core Network Function for e.g. AMF. However, the network could be any 5G/EUTRAN Core Network Entities like AMF/SMF/MME/UPF or the Network could be any 5G/EUTRAN RAN Entity like eNodeB (eNB) or gNodeB (gNB) or NG-RAN etc.

The messages used or indicated in this embodiment are shown as an example. The messages could be any signalling messages between UE and the Network Functions/Entities or between different Network functions/entities.

The 3GPP Technical document and references and the version number given in this embodiment are for reference/example and may be present in or refer to any of the 3GPP Technical documents or references.

The methods, issues or solutions disclosed in this embodiment are explained using NR access or NG-RAN Access Technology as an example and is not restricted or limited to NR access only. However, the solutions proposed in this embodiment are also applicable for E-UTRAN access Technology, NB-S1 mode or WB-S1 mode via E-UTRAN access and/or NB-IOT or WB-IOT Access/Architecture.

The solutions which are defined for NR(5GC) are also applicable to legacy RATs like E-UTRA/LTE, the corresponding CN entities needs to be replaced by LTE entities for e.g. AMF with MME, g-nodeB with e-nodeB, UDM with HSS etc. But principles of the solution remain same.

The Network used in this embodiment is explained using any 5G Core Network Function for e.g. AMF. However, the network could be any 5G/EUTRAN Core Network Entities like AMF/SMF/MME/UPF or the Network could be any 5G/EUTRAN RAN Entity like eNodeB (eNB) or gNodeB (gNB) or NG-RAN etc.

The solutions and procedures defined in this embodiment are illustrated using 5G or LTE as an example. It could be any applicable for any RAT(s)/Access but the core principles remain the same.

The solutions and procedures defined in this embodiment are illustrated using one of cell(s), RAT(s), PLMN(s) and Access(es) as an example. It could be applicable for any Network or Network Entity and the core principle remains the same.

The term Network as used in this embodiment may refer to any PLMN, RAT, Access, Access Technology or any combination of these. As used herein, the term “network” may refer to one or more of a Public Land Mobile Network (PLMN) or a Radio Access Technology (RAT) or an access or a system or a Radio Access Network (RAN) or a band or a frequency or a cell or a Network entity or a Core Network (CN) entity or a Network function or any Terrestrial Network or any Non-Terrestrial Network or any component of the network. The solutions defined in this embodiment are defined using PLMN selection or Network search as an example but it can refer to any of the Network Selection or Search procedures (for e.g. Cell Selection/Search, RAT selection/search, PLMN Selection/Search etc.). As used herein, the term “registration procedure” is associated with registration or camping of a UE in a 5G network. As used herein, the term “attach procedure” is associated with registration or camping of a UE in a 4G network or Long-Term Evolution (LTE) network. As used herein, the term “detach” is associated with de-registration or detaching of a UE in a 4G Network or an LTE network. As used herein, the term “deregistration” is associated with de-registration or detaching of a UE in a 5G Network or a NR network. As used herein, “camping” or “registering” to a network or network cell refers to the process by which a UE (such as for e.g. a mobile phone or tablet or the like) connects to a specific cellular network and becomes associated with that network. It may also refer to a procedure where the UE has completed the cell/Network selection/reselection process and has chosen a cell/Network from which it plans to receive all available services. It may also refer to a process of selecting a cell of the PLMN/Network and doing any necessary procedures (for e.g. Location Registration) to avail services from the Network. The terms NTN, 3GPP based Satellite Network, Satellite 3GPP access, Satellite access, Satellite Access Network, NR Satellite Access Network, Satellite NG-RAN Access Technology and NR Satellite access have been interchangeably used and have the same meaning. The solutions stated in this embodiment are illustrated using ignoring or de-prioritizing RPLMN or the last registered Network. However, the same solutions are also applicable to RPLMN and/or its equivalent PLMN, Last registered Network or its equivalent Network, RPLMN and/or its equivalent PLMN over NTN or over Satellite access technology, RPLMN and/or its equivalent PLMN over any access technologies, RPLMN over NTN or over Satellite access technology, RPLMN over any access technologies, Last Registered Network over any access technologies, Last Registered Network over NTN or over Satellite access technology and the core principle remains the same. The solutions described in this embodiment are illustrated using NR/E-UTRAN satellite access network as an example. However, the same or similar solutions are also applicable to any 3GPP network or any NTN Network or any Satellite network and the core principle remains the same.

In embodiments herein, the solutions are explained using the example of unavailability type due to NR/E-UTRAN Satellite access discontinuous coverage. However, the solutions are also applicable for any unavailability type or any unavailability period duration or whenever the UE is unavailable due to any type of unavailability period duration or whenever the network is unavailable due to any reason; (i.e., not due to NR/E-UTRAN Satellite access discontinuous coverage).

The proposed method ensures that UE does not perform RPLMN or Last Registered Network search first upon Switch On or Recovery from Lack of coverage or due to any trigger conditions if the RPLMN is an NTN PLMN or if the last registered network is a NTN, and directly scan TN PLMN or TN or TN cellular networks resulting in quick and better services for the User.

The proposed method ensures that UE does not perform RPLMN or last registered network search upon Switch On or Recovery from Lack of coverage or due to any trigger conditions if the RPLMN is an NTN PLMN or if the last registered network is a NTN and if the RPLMN or the last registered network is in discontinuous coverage or not in coverage, and directly scan TN PLMN or TN or TN cellular networks resulting in quick and better services for the User and prevent battery drain in scanning NTN PLMN during discontinuous coverage. The proposed method ensures that the UE does not perform the RPLMN or the TN or the TN cellular networks search first on the satellite access or satellite RATs or over any access/band/frequency used to provide NTN upon Switch On or Recovery from the lack of coverage or due to any trigger conditions if the TN and NTN services are deployed over same PLMN ID for RPLMN or over same network identifier, and directly scan TN PLMN or TN or TN cellular networks resulting in quick and better services for the user. The proposed method ensures that the UE camped on a VPLMN TN network or registered/attached to any network, during higher priority PLMN search or during expiry of any timer or procedure for selection of a higher priority Network or for a better system or any trigger conditions does not select or move to NTN PLMN or cell or NTN. The UE remains on VPLMN TN cell or move only to other higher priority PLMN TN cell or TN if found. Thus, UE's service quality and availability is not affected and user gets better experience. In an embodiment, during the network search procedure due to any trigger conditions, the UE may de-prioritize or ignore or postpone or disable or select with lowest priority the NTN. If any TN Network is not found during Network Search procedure, the UE may choose to remain in No Service or the UE may select/scan/register/attach to any available NTN. The UE may prioritize the NTN which is available, optionally without any unavailability period or the NTN with minimal discontinuous coverage period or minimal unavailability period or minimal remaining unavailability period (for e.g. if multiple NTNs are available, the UE may prioritize the NTN which is having a smaller unavailability period in comparison to a NTN which is having a greater unavailability period earlier) or the UE may prioritize the NTN with a unavailability period start time later than the current time (for e.g. if multiple NTNs are available, the UE may prioritize the NTN which is having a later start time of unavailability period in comparison to a NTN which is having a start time of unavailability period earlier) or any combination of these.

In an embodiment, the UE may add the last selected or the registered network (for e.g. PLMN or RAT or Cell or Band or Network any combination of these) to any temporary back-off network list or forbidden network list or any back-off list. The UE may not select or search or scan or deprioritize or ignore or scan with lowest priority the Network (for e.g. cell/PLMN/RAT/Access/Band/Network) present in this list.

In an embodiment, the scanning or search with lowest priority may mean that UE may scan or search for this network after the network search procedure has ended and no other suitable/allowable/available/preferred network is found.

In an embodiment, the UE may start a timer after triggering the network search procedure. The UE may not select or may not search or may not scan or may deprioritize or ignore or scan with lowest priority the last registered network/PLMN if the last registered network or PLMN was an NTN. The UE may perform the network search procedure of the TN. If the TN network is not found or any network is not available or found or if the timer has expired, the UE may scan or search for the last registered network or PLMN or the NTN. In an embodiment, the UE may wait for the timer to expire before searching or scanning for last registered network or NTN. In an embodiment, if the TN network is not found or any network is not available or found, the UE may stop the timer and the UE may scan or search for the last registered network or PLMN or the NTN. In an embodiment, the UE may derive the value of the last registered network or last registered PLMN from the value stored in the UE (ME/Universal SIM (USIM)) or from a value using any of the files present in the SIM (for e.g. EF_LOCI, EF_PSLOCI, EF_EPSLOCI, EF5GS3GPPLOCI file) (for e.g. the files may contain value for some other parameters for e.g. GUTI and the UE may use the value of that parameter to determine the value of the last registered Network or the RPLMN). In an embodiment, the UE may ignore or not consider the value of the EF_LRPLMNSI file present in the UE (ME or USIM) and may determine to perform or trigger a Network Search procedure on any of the PLMN(s) or Network as described in this embodiment. (for e.g. if the value of the EF_LRPLMNSI is 0, still the UE may not select or may not search or may not scan or may deprioritize or ignore or scan with lowest priority the RPLMN or last registered network). In an embodiment, the UE may use the solutions proposed in this embodiment before, during or after the network search procedure. In an embodiment, after the network search procedure is complete, the UE may register or attach or camp or trigger a TAU procedure on the selected/available network.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

FIG. 10 shows various hardware components of the UE (100), according to an embodiment of the disclosure.

The UE (100) can be, for example, but not limited to a laptop, a desktop computer, a notebook, a Device-to-Device (D2D) device, a vehicle to everything (V2X) device, a smartphone, a foldable phone, a smart Television (TV), a tablet, a server, an IoT device, an Augmented Reality (AR) device, a Mixed Reality (MR) device, a Virtual Reality (VR) device, an immersive device, an Extended Reality (XR) device, a metaverse device or the like.

In an embodiment, the UE (100) includes a processor (1110), a communicator (1120), memory (1130) and a network search controller (1140). The processor (1110) is coupled with the communicator (1120), the memory (1130) and the network search controller (1140). The network can be, for example, but not limited to a PLMN, a RAT, an access, a RAN, the network operated in a band, the network operated in a frequency, and the network operated in a cell, a CN entity, a Network Function, a Network entity, a component of the Network, a TN, and an NTN or a combination of these. The UE (100) can be, for example, but not limited to an NTN-capable UE, a UE (100) capable of availing an NTN service, a UE (100) supporting NTN technology, a UE (100) capable of getting NTN services using technologies other than NTN technology, a UE (100) capable of availing the NTN service which is deployed using a 3GPP Satellite or NTN system, a UE (100) capable of availing the NTN service which is deployed using an NTN network deployed using any 3GPP technology, a UE (100) capable of availing a service which is deployed using a 3^{rd} Generation Partnership Project (3GPP) system and a UE (100) capable of availing the NTN service which is deployed using any proprietary NTN implementation outside the scope of 3GPP NTN system.

The UE (100) is triggered to select the network, when the UE (100) detects an event. The event can be, for example, but not limited to a switch off the UE, a switch on the UE, a recovery of the UE (100) from lack of a coverage area, a recovery of the UE (100) from an OOS area, a SIM insertion in the UE, a SIM re-insertion post removal in the UE, a SIM removal in the UE, a disabling of the SIM in the UE, an enabling of the SIM in the UE, a modem reset, a power cycle, a modem power up, a modem power cycle, an airplane mode on in the UE, an airplane mode off in the UE, a UE (100) exiting airplane mode, a modem exiting airplane mode, a modem entering airplane mode an activation of the UE, a reject cause from the network, a detach triggered by the network, a deregistration triggered by the network, on entering store and forward mode in the UE, on exiting store and forward mode in the UE, on entering store and forward mode from the network, on exiting store and forward mode from the network, a detach triggered by the UE, a deregistration triggered by the UE, a network mode change in the UE, a network selection mode change in the UE, an operating mode change in the UE, on entering satellite mode in the UE, on exiting satellite mode in the UE, a turning on of a modem, and a SIM refresh procedure.

The network search controller (1140) determines if the last registered network is present in the UE. The last registered network can be determined from, for example, but not limited to a value configured in the UE, a value configured in the SIM, a value stored in the non-volatile memory of the device, and a file stored in the SIM. The network search controller (1140) determines the Last Registered Network by using at least one of: one or more of a value or a file or a configuration or an information configured or stored in the UE (for e.g. a Last registered Network value derived or stored in the UE or a last registered PLMN value (for e.g. RPLMN) stored or derived in the UE), one or more of a value or a file or a configuration or an information configured or stored in the SIM, one or more of a value or a file or a configuration or an information configured by the network, one or more of a value or a file or a configuration or an information configured by the server, one or more of a value or a file or a configuration or an information configured by an application function, a value configured in the SIM, a value stored in or derived from one or more of a EF_EPSLOCI file or a EF_LOCI file or a EF_PSLOCI file or a EF5GS3GPPLOCI file (or any other file or value stored or derived from) in the SIM (for e.g. the value stored in the above file may refer to some other value from which UE can derive the value of the RPLMN or the last registered network), a value stored in the non-volatile memory of the device and a file stored in the SIM.

The network search controller (1140) determines if the last registered network is the NTN. The last registered network is a network on which the UE (100) was successfully registered or attached before selecting a network or before triggering a network selection or before triggering a network search procedure. The last registered network can be, for example, but not limited to a last registered PLMN (RPLMN), a last registered RAT (LRRAT), a last registered access, a last registered system, a last registered RAN, a last registered network operated in band, a last registered network operated in frequency, a last registered network operated in cell, a last registered CN entity, a last registered Network entity, a last registered network function (NF) and a last registered component of network.

The NTN can be, for example, but not limited to a LEO, a MEO, a GEO, a HAPS, an UAV, a network supported by an airborne vehicle, a network deployed using the 3GPP satellite or NTN system, an NTN Network deployed using any 3GPP technology, a NTN Network deployed using at least one 3GPP technology (for e.g. a 3GPP based Satellite system or a NTN Network deployed using a LTE network etc.) and an NTN Network deployed using any proprietary NTN implementation outside the scope of a 3GPP NTN system (for e.g. a NTN deployed using an operator server or application etc.).

The UE (100) determines that the last registered network is the NTN by using at least one of a broadcast parameter, a SIB parameter, a NAS signalling parameter, an AS signalling parameter, a band used by an operator for deploying a satellite service or an NTN service, a PLMN used by an operator for deploying the satellite service or the NTN service, a frequency used by the operator for deploying the satellite service or the NTN service, a RAT used by the operator for deploying the satellite service or the NTN service, a network deployed using any of an NTN Technology, a network used by a satellite vendor for deploying a satellite service or an NTN service, an information regarding configuration for an NTN deployment as configured in the UE, an information regarding configuration for the NTN deployment as indicated by the network, an information regarding configuration for the NTN deployment as configured in a SIM, an information regarding configuration for the NTN deployment as indicated by a server, and an information regarding configuration for the NTN deployment as indicated by an application function, a database indicating details of a satellite or NTN cell, its location, its availability/unavailability time and its deployment details, a machine learning or an artificial intelligence based technique to predict or determine a network type, and a data driven technique to predict or determine a network type. In an example, the satellite cell may broadcast call, emergency call as unsupported and indicate SMS only support or the Satellite Cell may broadcast NTN related SIB parameters (such as SIB-19, SIB-32 etc.).

Further, the network search controller (1140) ignores the last registered network, if the last registered network is the NTN. In an embodiment, the network search controller (1140) ignores the last registered network if the last registered network is the NTN. In an embodiment, the network search controller (1140) selects a TN if the last registered network is the NTN. In an embodiment, the network search controller (1140) selects any Network other than NTN if the last registered network is the NTN. In an embodiment, the network search controller (1140) selects any PLMN other than RPLMN if the last registered PLMN is the NTN. In an embodiment, the network search controller (1140) selects any Network other than Last Registered Network if the last registered network is the NTN. In an embodiment, the network search controller (1140) ignores the last registered network if the last registered network is the NTN and the UE (100) is in discontinuous coverage of the last registered network. In another embodiment, the network search controller (1140) de-prioritizes the last registered network if the last registered network is the NTN. In another embodiment, the network search controller (1140) selects the last registered network with a lowest priority if the last registered network is the NTN. In another embodiment, the network search controller (1140) de-prioritizes the last registered network, if the last registered network is the NTN and the UE (100) is in the discontinuous coverage of the last registered network. In another embodiment, the network search controller (1140) selects the last registered network with the lowest priority if the last registered network is the NTN and the UE (100) is in the discontinuous coverage of the last registered network. In another embodiment, the network search controller (1140) disables the last registered network if the last registered network is the NTN. In another embodiment, the network search controller (1140) disables the last registered network if the last registered network is the NTN and the UE (100) is in discontinuous coverage of the last registered network. In another embodiment, the network search controller (1140) disables the last registered network over the NTN if the last registered network is the NTN. In another embodiment, the network search controller (1140) disables the last registered network over the NTN if the last registered network is the NTN and the UE (100) is in the discontinuous coverage of the last registered network. In another embodiment, the network search controller (1140) ignores the last registered network over the NTN if the last registered network is the NTN. In another embodiment, the network search controller (1140) ignores the last registered network over the NTN if the last registered network is the NTN and the UE (100) is in the discontinuous coverage of the last registered network. In another embodiment, the network search controller (1140) de-prioritizes the last registered network over the NTN if the last registered network is the NTN. In another embodiment, the network search controller (1140) selects the last registered network over the NTN the with lowest priority if the last registered network is the NTN. In another embodiment, the network search controller (1140) de-prioritizes the last registered network over the NTN, if the last registered network is the NTN and the UE (100) is in the discontinuous coverage of the last registered network. In another embodiment, the network search controller (1140) selects the last registered network over the NTN with lowest priority if the last registered network is the NTN and the UE (100) is in the discontinuous coverage of the last registered network. In another embodiment, the network search controller (1140) disables the last registered network over a satellite access or the NTN access or over the NTN deployed band or frequency or RAT if the last registered network is the NTN. In another embodiment, the network search controller (1140) disables the last registered network when the last registered RAT is a satellite access or a satellite RAT or an NTN access or an NTN RAT. In another embodiment, the network search controller (1140) ignores the last Registered PLMN (RPLMN) if the last registered network is the NTN. In another embodiment, the network search controller (1140) disables the PLMN search on the last RPLMN and searching for a TN PLMN as per priority order. In another embodiment, the network search controller (1140) disables the PLMN search on the last RPLMN and searches for the TN PLMN as per a priority order when the UE (100) is in the discontinuous coverage of the RPLMN. In another embodiment, the network search controller (1140) de-prioritizes the RPLMN and searches for the TN PLMN as per priority order, and searches for the NTN PLMN when the TN PLMN is not found, and the UE (100) is not in the discontinuous coverage of RPLMN. In an embodiment, the network search controller (1140) ignores the last registered network, if the last registered network is the selected network during the network search procedure and the last registered network is the NTN. In an embodiment, the network search controller (1140) ignores the last registered network during the network search procedure. In an embodiment, the network search controller (1140) ignores the last registered network or ignores the NTN or ignores the last registered PLMN during the network search procedure. In an embodiment, the network search controller (1140) ignores the last registered network or ignores the NTN or ignores the last registered PLMN if the selected network is same as the last registered network/PLMN and the last registered network/PLMN is an NTN. In an embodiment, the network search controller (1140) ignores the NTN if the selected network is an NTN during network search procedure. In an embodiment, ignoring the last registered network may occur during the network search procedure. In an embodiment, the UE (100) may ignore the last registered network during the network search procedure. In an embodiment, the UE (100) may ignore the last registered network before or during or after a network search procedure. In an embodiment, the UE (100) ignores the last registered network or the UE (100) ignores the NTN or the UE (100) ignores the last registered PLMN during a network search procedure. In an embodiment, the UE (100) ignores the last registered network or the UE (100) ignores the NTN or the UE (100) ignores the last registered PLMN if the selected network is same as the last registered network/PLMN and the last registered network/PLMN is an NTN. In an embodiment, the UE (100) ignores the NTN if the selected network is an NTN during network search procedure.

The UE (100) determines that the UE (100) is in the discontinuous coverage of the network by using at least one of: the broadcast parameter, the SIB parameter, the NAS signalling parameter, the AS signalling parameter, an information regarding configuration for NTN deployment as configured in the UE, an information regarding configuration for the NTN deployment as indicated by the network, an unavailability period duration and a start of unavailability period, an unavailability type, an indication for store and forward mode, a satellite coverage availability information, a satellite ephemeris information, an information regarding configuration for the NTN deployment as configured in a SIM, an information regarding configuration for the NTN deployment as indicated by a server, an information regarding configuration for the NTN deployment as indicated by an application function, a database indicating details (e.g., ex-Band, frequency, Global Cell Identifier etc.) of a satellite or NTN cell, its location, its availability/unavailability time and its deployment details, a machine learning or an artificial intelligence based technique to predict or determine a network availability and unavailability status, and a data driven technique to predict or determine a Network availability and unavailability status.

Further, the network search controller (1140) performs the network search procedure. In an embodiment, the network search controller (1140) selects a network and searches the selected network. In another embodiment, the network search controller (1140) performs the network search procedure for the TN. In another embodiment, the UE (100) performs the network search procedure for the TN on at least one of: a terrestrial PLMN, a terrestrial RAT, a terrestrial access, a terrestrial system, a terrestrial RAN, a terrestrial band, a terrestrial frequency, a terrestrial cell, a network other than NTN, a terrestrial CN entity, a terrestrial network entity, a component of terrestrial network, a terrestrial network function and a network other than satellite access network.

Further, the network search controller (1140) obtains the at least one service from the TN.

In another embodiment, the UE (100) is registered to the TN. In another embodiment, the UE (100) is registered to the NTN. In another embodiment, the UE (100) is registered to the 3GPP network. In another embodiment, the UE (100) s registered to the N3GPP network. The UE (100) performs the network search procedure, when the UE (100) detects an event. The event can be, for example, but not limited to an expiry of a timer for higher priority PLMN search procedure, a handover procedure, a redirection procedure, a reselection procedure, an expiry of a timer for BSR, an expiry of an operator defined timer, a background network search procedure, an idle mode procedure, a connected mode procedure and a network release procedure. The events may also include scenarios where the UE (100) need to trigger or perform the network search or selection or scanning procedure, the PLMN search or selection or scanning procedure, a cell search or selection or scanning procedure or a RAT/Access Search or selection or scanning procedure.

In another embodiment, the network search controller (1140) performs the network search procedure for the TN. In another embodiment, the UE (100) performs the network search procedure for the TN on at least one of: a terrestrial PLMN, a terrestrial RAT, a terrestrial access, a terrestrial system, a terrestrial RAN, a terrestrial band, a terrestrial frequency, a terrestrial cell, a terrestrial CN entity, a terrestrial network entity, a component of a terrestrial network, a terrestrial network function, a network other than NTN, and a network other than satellite access network.

Further, the network search controller (1140) ignores an NTN. In another embodiment, the network search controller (1140) selects a TN. In an embodiment, the network search controller (1140) selects any network other than NTN. In an embodiment, the network search controller (1140) selects any PLMN other than NTN PLMN. In an embodiment, the network search controller (1140) selects any network other than NTN. In another embodiment, the network search controller (1140) ignores the NTN. In another embodiment, the network search controller (1140) ignores the NTN if the UE (100) is in the discontinuous coverage of the NTN. In another embodiment, the network search controller (1140) de-prioritizes the NTN. In another embodiment, the network search controller (1140) selects the NTN with the lowest priority. In another embodiment, the network search controller (1140) de-prioritizes the NTN if the UE (100) is in the discontinuous coverage of the NTN. In another embodiment, the network search controller (1140) selects the NTN with the lowest priority if the UE (100) is in the discontinuous coverage of the NTN. In another embodiment, the network search controller (1140) disables the NTN. In another embodiment, the network search controller (1140) disables the NTN if the UE (100) is in the discontinuous coverage of the NTN. In another embodiment, the network search controller (1140) ignores the found network over the NTN. In another embodiment, the network search controller (1140) de-prioritizes the found network over the NTN. In another embodiment, the network search controller (1140) selects the found network over the NTN with the lowest priority. In another embodiment, the network search controller (1140) de-prioritizes the found network over the NTN, if the UE (100) is in the discontinuous coverage of the found network. In another embodiment, the network search controller (1140) selects the found network over the NTN with the lowest priority if the UE (100) is in the discontinuous coverage of the found network. In another embodiment, the network search controller (1140) disables the found network over the satellite access or the NTN access or over the NTN deployed band or frequency or RAT. In another embodiment, the network search controller (1140) disables the found network when the found RAT is a satellite access or a satellite RAT or an NTN access or an NTN RAT. In another embodiment, the network search controller (1140) ignores the found network if the found network is the NTN. In another embodiment, the network search controller (1140) disables the PLMN search on the found network and searches for the TN PLMN as per a priority order. In another embodiment, the network search controller (1140) searches for higher priority TN PLMNs on all RATs except NTN RAT or NTN band and disabling searching on NTN bands or RATs and operator deployed NTN Bands. In another embodiment, the network search controller (1140) disables the PLMN search on the found network and searches for the TN PLMN as per the priority order when the UE (100) is in the discontinuous coverage of the found network. In another embodiment, the network search controller (1140) de-prioritizes the found network and searches for the TN PLMN as per a priority order, and searches for a NTN PLMN when TN PLMN is not found, and the UE (100) is not in the discontinuous coverage of found Network.

In another embodiment, the UE (100) ignores the NTN on at least one of a non-terrestrial PLMN, a non-terrestrial RAT, a non-terrestrial access, a non-terrestrial system, a non-terrestrial RAN, a non-terrestrial band, a non-terrestrial frequency, the non-terrestrial cell, a non-terrestrial network entity, a non-terrestrial network function, a non-terrestrial CN entity, a component of a non-terrestrial network, a network other than TN, and a network on satellite access network.

Further, the network search controller (1140) selects the TN.

The network search controller (1140) may determine that the UE (100) is in the NR/E-UTRAN Satellite Access Discontinuous Coverage or determine that the Satellite Coverage is currently not available, through one of the below technique:
a) Based on the Start of the Unavailability Period and/or Unavailability period duration determined by the UE, indicated by the Network (i.e., by any Network Function such as AMF, MME etc.) or negotiated between the UE (100) and the Network. For ex—If the current time is after the Start Time and the Unavailability Period Duration is not over, the UE (100) may determine that the UE (100) is in discontinuous coverage.
b) Based on the Unavailability Type, which indicates that the Unavailability Period is due to NR/E-UTRAN Satellite Access Network discontinuous coverage
c) Based on any of the Network Broadcast parameters or messages or any Network indication (such as SIB-19, SIB-32, Satellite ephemeris information etc.)
d) Based on UE (100) determination, using AI/ML models deployed at the UE (100) side.
e) Based on Satellite coverage availability information (SCAI) provided to the UE (100) by any application function or the 5GC Network Function (like AMF/PCF/UDM or any other NF etc.) or any other entity such as Satellite Coverage Availability Function (SCAF).
f) If the UE (100) is in an area/TAI/Registration Area where Satellite Coverage or Satellite Access is not available.
g) Based on historical coverage data stored and maintained at UE side, and algorithms implemented at UE side to predict Satellite Coverage availability.
h) Based on indication/message/broadcast provided by the Terrestrial Network cell about availability of NTN coverage in an area.
i) Based on OEM/Network/Satellite operator server deployed to provide this information to the UE.
j) Pre-configuration by the operator in the UE (100) or SIM/USIM of the device.

In another embodiment, whenever an emergency call is triggered from the UE (100) or when the UE (100) is in-between an Emergency SMS communication (for ex-using SMS over NAS or using SMS through any proprietary/native applications etc.), the UE (100) can determine the capability of the current camped RAT/Network/PLMN (for e.g. NTN RAT/PLMN) and check if the device needs a faster and quicker camping to TN for full set of services in such a scenario or whether device needs a quick camping for limited set of service. Based on the triggered use case from the UE (100) side and the UE (100) determination of the current RAT capability (NTN RAT), the UE (100) can determine to use the proposed method or delay the usage of the proposed method till the triggered/ongoing services are over.

In an embodiment, the terms device and UE are used interchangeably and have the same meaning.

The network search controller (1140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (1110) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (110) may include multiple cores and is configured to execute the instructions stored in the memory (1130).

Further, the processor (1110) is configured to execute instructions stored in the memory (1130) and to perform various processes. The communicator (1120) is configured for communicating internally between internal hardware components and with external devices via one or more networks. For example, the communicator (1120) may comprise communication circuitry. The memory (1130) also stores instructions to be executed by the processor (1110). The memory (1130) may include non-volatile storage elements. Examples of such non-volatile storage elements may include magnetic hard discs, optical discs, floppy discs, flash memories, or forms of electrically programmable read only memories (EPROMs) or electrically erasable and programmable ROMs (EEPROMs). In addition, the memory (1130) may, in some examples, be considered a non-transitory storage medium. The term “non-transitory” may indicate that the storage medium is not embodied in a carrier wave or a propagated signal. However, the term “non-transitory” should not be interpreted that the memory (1130) is non-movable. In certain examples, a non-transitory storage medium may store data that can, over time, change (e.g., in Random Access Memory (RAM) or cache).

Although FIG. 10 shows various hardware components of the UE (100) but it is to be understood that other embodiments are not limited thereon. In other embodiments, the UE (100) may include less or more number of components. Further, the labels or names of the components are used only for illustrative purposes and does not limit the scope of the disclosure. One or more components can be combined together to perform the same or substantially similar function in the UE (100).

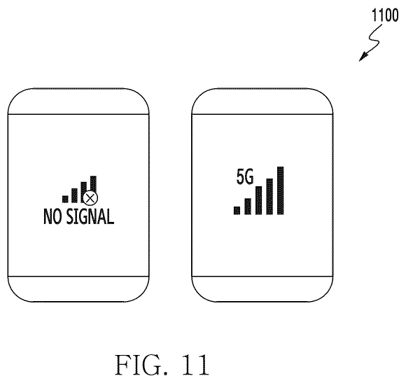

FIG. 11 depicts an example scenario (1100), wherein the UE (100) shall disable/ignore/postpone/de-prioritize the NR/E-UTRAN satellite access/RAT or by lowering the priority of satellite access/NTN RATs during Discontinuous Coverage, according to an embodiment of the disclosure.

If the UE (100) was last registered to NTN PLMN (i.e., RPLMN is NTN PLMN), at Switch-ON or recovery from lack of coverage or any trigger conditions, the UE (100) will ignore/de-prioritize/disable RPLMN (Satellite/NTN PLMN) and search for other TN PLMN(s) (as per priority order) on all RATs and Access Network (except Satellite Access Network) as per below proposed method. When the UE (100) is in discontinuous coverage of RPLMN, the UE (100) must disable the PLMN search on RPLMN and search for other PLMNs (HPLMN/EHPLMN or any PLMN as per priority defined in 23.122) for TN service if the UE (100) is in discontinuous coverage of RPLMN. When the UE (100) exits the discontinuous coverage of RPLMN, then the UE (100) must de-prioritize the RPLMN and search for other PLMNs (HPLMN/EHPLMN or any PLMN as per priority defined in 23.122) for TN service, and search for NTN PLMN when other PLMNs are not found. The UE (100) gets full service from a TN PLMN earlier and does not waste time and power while scanning for RPLMN (NTN PLMN) during discontinuous coverage. UE (100) gets good service quickly and user gets good experience.

When the UE (100) is not in discontinuous coverage of RPLMN or does not have discontinuous coverage information, the UE (100) must ignore/de-prioritize the PLMN search on RPLMN and search for other PLMNs (HPLMN/EHPLMN or any PLMN as per priority defined in 23.122) for TN service. The UE (100) searches for NTN PLMN only when other PLMNs (TN PLMNs) are not found. The UE (100) finds full set of services directly from TN PLMNs (HPLMN/EHPLMN or any other TN PLMN) quickly and does not get stuck in NTN PLMN with Limited set of services.

If the UE (100) has the RPLMN information, at Switch-ON or recovery from lack of coverage or any trigger conditions, the UE (100) will search for RPLMN on all RATs and Access Network (except Satellite Access Network or Operator deployed NTN Bands and search for other TN PLMN(s) (as per priority order) on all RATs and Access Network (except Satellite Access Network or Operator deployed NTN Bands) as per below proposed method.

When the UE (100) is in discontinuous coverage of RPLMN, the UE (100) must disable the NR/E-UTRAN satellite access and Operator deployed NTN Bands for the RPLMN if the UE (100) is in discontinuous coverage of the RPLMN and search for RPLMN on all other RATs/Access Technologies. Upon exiting the discontinuous coverage, the UE (100) must de-prioritize NR/E-UTRAN Satellite access/RAT and Operator deployed NTN Bands. The UE (100) should search RPLMN on Satellite Access/RAT/Operator deployed NTN Bands if no other TN PLMNs are found. The UE (100) gets full set of service from RPLMN or any other TN PLMN earlier and does not waste time and power while scanning for RPLMN on NR/E-UTRAN Satellite access/Operator deployed NTN Bands during discontinuous coverage. UE (100) gets good service quickly and user gets good experience.

When the UE (100) is not in discontinuous coverage of RPLMN or does not have discontinuous coverage information, the UE (100) must de-prioritize NR/E-UTRAN Satellite access/RAT and Operator deployed NTN Bands for the RPLMN and put it in lower priority than the terrestrial network bands/RAT. The UE (100) should search RPLMN on Satellite Access/RAT and Operator deployed NTN Bands if no other TN PLMNs are found. The UE (100) finds full set of service directly from RPLMN or any other TN PLMN quickly and does not get stuck in RPLMN on Satellite Access/RAT with Limited set of services.

Based on the proposed methods, the UE (100) ignores/deprioritizes RPLMN (NTN PLMN) searches for HPLMN/EHPLMN directly and finds TN service directly. The UE (100) is not stuck in satellite limited service state and gets full services quickly.

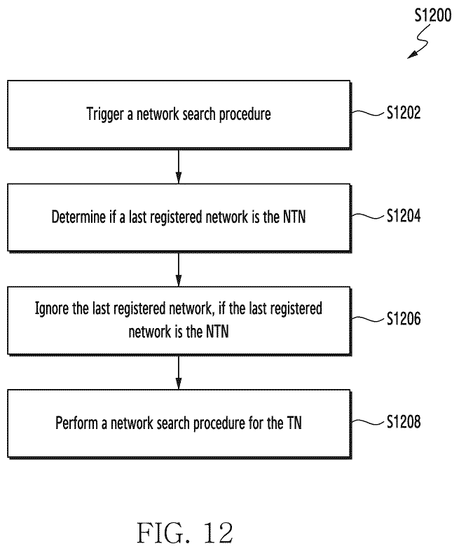

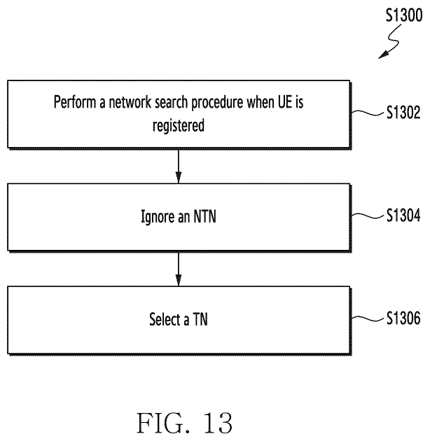

FIGS. 12 and 13 are the flowcharts (S1200 and S1300) illustrating a method for selecting a network by the UE, according to various embodiments of the disclosure.

Referring to FIG. 12, the operations (S1202-S1208) are handled by the network search controller (1140). At operation S1202, the method includes triggering a network search procedure (for e.g. due to any trigger conditions). At operation S1204, the method includes determining if the last registered network is the NTN. At operation S1206, the method includes ignoring the last registered network, if the last registered Network is the NTN. At operation S1208, the method includes performing the network search procedure for the TN.

Referring to FIG. 13, the operations (S1302-S1306) are handled by the network search controller (1140). At operation S1302, the method includes performing the network search procedure when the UE (100) is registered or attached to the network. At operation S1304, the method includes ignoring the NTN. At operation S1306, the method includes selecting the TN.

The proposed method ensures that UE (100) does not perform RPLMN search or last registered network search first upon Switch On or Recovery from Lack of coverage or due to any trigger condition if the RPLMN is an NTN PLMN or the last registered network is a NTN, and directly scan TN PLMN or TN resulting in quick and better services for the User.

The proposed method ensures that UE (100) does not perform RPLMN search upon Switch On or Recovery from Lack of coverage if the RPLMN is an NTN PLMN if the RPLMN is in discontinuous coverage, and directly scan TN PLMN resulting in quick and better services for the User and prevent battery drain in scanning NTN PLMN during discontinuous coverage.

The proposed method ensures that UE (100) does not perform RPLMN search first on Satellite access and Satellite RATs upon Switch On or Recovery from Lack of coverage if TN and NTN services are deployed over same PLMN ID for RPLMN, and directly scan TN PLMN resulting in quick and better services for the User.

The proposed method ensures that the UE (100) camped on a VPLMN TN network during higher priority PLMN search does not select or move to NTN PLMN or cell. The UE (100) remains on VPLMN TN cell or move only to other higher priority PLMN TN cell if found. Thus, UE's service quality and availability is not affected and user gets better experience.

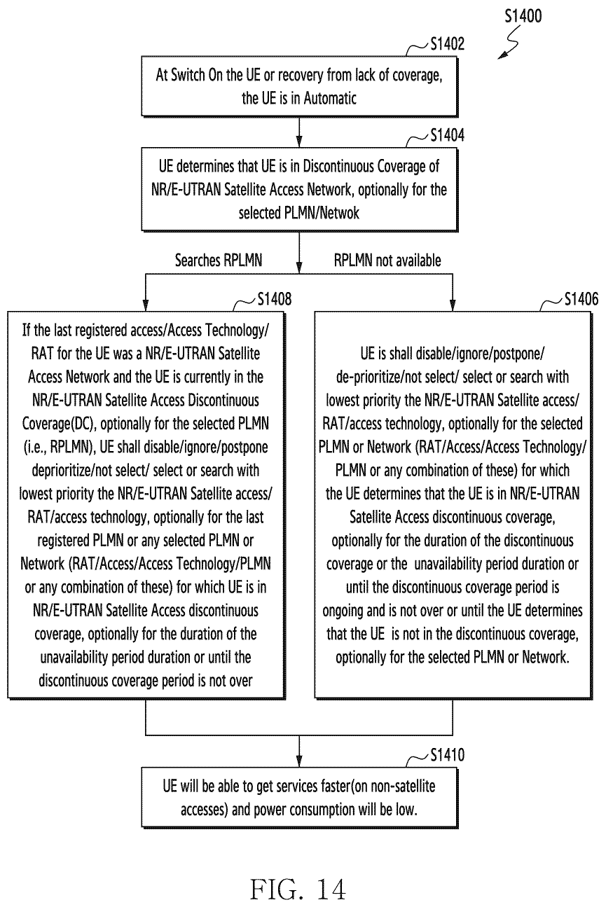

FIG. 14 depicts a scenario (S1400), wherein the UE (100) shall disable/ignore/postpone/de-prioritize the NR/E-UTRAN Satellite access/RAT or lower the priority of satellite access/NTN RATs during Discontinuous Coverage according to an embodiment of the disclosure.

At Switch On or recovery from lack of coverage, optionally if the UE (100) is in automatic mode (automatic network selection mode), if the UE (100) determines that the UE (100) is in NR/E-UTRAN Satellite Access Discontinuous Coverage or the UE (100) is in an area/TAI/Registration Area where Satellite Coverage or Satellite Access is not available, optionally based on unavailability period duration or Start of Unavailability Period or Start Time/End Time of Unavailability period or Unavailability type, or optionally based on UE (100) determination or Network indication or based on any information available/stored in the UE (100) (for e.g., in ME/USIM/UE) indicating that the UE (100) is in satellite access discontinuous coverage optionally without any indication by the UE (100) or by the Network regarding the start/duration of the unavailability period/discontinuous coverage before/during the start of the satellite access discontinuous coverage, or when the UE (100) is in NR/E-UTRAN Satellite Access Discontinuous Coverage, optionally for a selected PLMN or registered PLMN or Network or whenever Discontinuous Coverage (DC) is ongoing for the selected PLMN or Network, the UE (100) shall disable/ignore/postpone/de-prioritize/de-activate satellite access/NTN RAT/NR or E-UTRAN Satellite Access RAT/NR or E-UTRAN Satellite Access Technology or lower the priority order of satellite access/access technology/RAT or NR/E-UTRAN Satellite Access Network/RAT/Access/Access Technology or de-activate its access stratum or access stratum functions due to discontinuous coverage/unavailability period or de-activate its access stratum/access stratum functions for NR/E-UTRAN Satellite Access, optionally for a selected/registered PLMN or Network or RAT/Access/Access Technology, optionally until coverage returns, optionally for the selected/registered PLMN/network/RAT/Access/Access Technology.

In an embodiment herein, at switch on, if the UE (100) determines that it is in discontinuous coverage, the UE (100) may deactivate its Access Stratum functions for NR satellite access. In yet another embodiment herein, at switch on or recovery from lack of coverage, if the UE (100) determines that it is in discontinuous coverage, the UE (100) may deactivate its Access Stratum functions for NR satellite access. In an embodiment herein, in general, the UE (100) may disable or de-activate its access stratum/access stratum functions for either NR Satellite Access or the UE (100) may disable or de-activate its access stratum/access stratum functions for E-UTRAN Satellite Access or the UE (100) may disable or de-activate its access stratum/access stratum functions for both NR Satellite Access and E-UTRAN Satellite Access or the UE (100) may disable or de-activate its access stratum for any associated or supported RAT(s) or RAT type(s) or PLMN(s) or Access or any combination of these. In an embodiment, the UE (100) may disable or de-activate its access stratum for any associated or supported RAT(s) or RAT type(s) or PLMN(s) or Access or any combination of these, for which discontinuous coverage is determined.

In yet another embodiment, at Switch On or recovery from lack of coverage, optionally if the UE (100) is in automatic mode (automatic network selection mode), if the UE (100) determines that the UE (100) doesn't have the information for discontinuous coverage or unavailability period/unavailability type or start of unavailability period or start time/end time of discontinuous coverage/unavailability period and/or the Satellite Coverage or Satellite Access is not available, optionally for the UE (100) in the given/current area/location/TAI/Registration Area, the UE (100) shall disable/ignore/postpone/de-prioritize/de-activate satellite access/NTN RAT/NR or E-UTRAN Satellite Access RAT/NR or E-UTRAN Satellite Access Technology or lower the priority order of satellite access/access technology/RAT or NR/E-UTRAN Satellite Access Network/RAT/Access/Access Technology or de-activate its access stratum due to discontinuous coverage/unavailability period or de-activate its access stratum/access stratum functions for NR/E-UTRAN Satellite Access, optionally for a selected/registered PLMN or Network or RAT/Access/Access Technology, optionally until coverage returns, optionally for the selected/registered PLMN/network/RAT/Access/Access Technology.

In yet another embodiment, at Switch On or recovery from lack of coverage, optionally if the UE (100) is in automatic mode (automatic network selection mode), if the UE (100) determines that the UE (100) doesn't have the information for discontinuous coverage or unavailability period/unavailability type or start of unavailability period or start time/end time of discontinuous coverage/unavailability period, optionally for the UE (100) in the given/current area/location/TAI/Registration Area, the UE (100) shall not disable/ignore/postpone/de-prioritize/de-activate satellite access/NTN RAT/NR or E-UTRAN Satellite Access RAT/NR or E-UTRAN Satellite Access Technology or the UE (100) shall not lower the priority order of satellite access/access technology/RAT or NR/E-UTRAN Satellite Access Network/RAT/Access/Access Technology or the UE (100) shall not de-activate its access stratum due to discontinuous coverage/unavailability period or de-activate its access stratum/access stratum functions for NR/E-UTRAN Satellite Access, optionally for a selected/registered PLMN or Network or RAT/Access/Access Technology, optionally until UE (100) enters discontinuous coverage/unavailability period/start time of unavailability period or discontinuous coverage starts, optionally for the selected/registered PLMN/network/RAT/Access/Access Technology.

In yet another embodiment, at Switch On or recovery from lack of coverage, optionally if the UE (100) is in automatic mode (automatic network selection mode), if the UE (100) determines that the UE (100) is not in NR/E-UTRAN Satellite Access Discontinuous Coverage (i.e., when NR/E-UTRAN Satellite Access Discontinuous Coverage is over) or the UE (100) is in an area/TAI/Registration Area where Satellite Coverage or Satellite Access is available, optionally based on unavailability period duration or Start of Unavailability Period or Start Time/End Time of Unavailability period or Unavailability type or when UE (100) is not in NR/E-UTRAN Satellite Access Discontinuous Coverage, optionally for a selected PLMN or Network or whenever Discontinuous Coverage (DC) is not ongoing for the selected PLMN or Network, UE (100) shall not disable/ignore/postpone/de-prioritize/de-activate satellite access/NTN RAT/NR or E-UTRAN Satellite Access RAT/NR or E-UTRAN Satellite Access Technology or the UE (100) shall not lower the priority order of satellite access/access technology/RAT or NR/E-UTRAN Satellite Access Network/RAT/Access/Access Technology or the UE (100) shall not de-activate its access stratum due to discontinuous coverage/unavailability period or the UE (100) shall not de-activate its access stratum/access stratum functions for NR/E-UTRAN Satellite Access, optionally for a selected PLMN or Network or RAT/Access/Access Technology, optionally until UE (100) enters discontinuous coverage/unavailability period/start time of unavailability period or discontinuous coverage starts, optionally for the selected/registered PLMN/network/RAT/Access/Access Technology.

The UE (100) shall disable/ignore/postpone/de-prioritize the NR/E-UTRAN Satellite access/RAT or de-activate its access stratum due to discontinuous coverage/unavailability period or de-activate its access stratum/access stratum functions for NR/E-UTRAN Satellite Access, optionally for the selected/registered PLMN/Network, until coverage returns or lower the priority of satellite access/NTN RATs during Discontinuous Coverage based on unavailability period duration and/or start of unavailability period and/or start time/end time of discontinuous coverage (i.e. when discontinuous coverage starts or at the start/start time of unavailability period, optionally due to satellite access discontinuous coverage).

At Switch-ON or recovery from lack of coverage, if the UE (100) is in automatic mode (automatic network selection mode) and if the UE (100) was last registered on a PLMN (i.e., registered PLMN or RPLMN) over NR/E-UTRAN Satellite Access Network and if the UE (100) determines that the UE (100) is currently in the NR/E-UTRAN Satellite Access Discontinuous Coverage (DC), optionally based on unavailability period duration or Start of Unavailability Period or Start Time/End Time of Unavailability period or Unavailability type or when UE (100) is in NR/E-UTRAN Satellite Access Discontinuous Coverage, optionally for the last registered PLMN or any selected PLMN or Network (RAT/Access/Access Technology/PLMN or any combination of these), the UE (100) shall disable/ignore/postpone/de-prioritize/not select/select or search with lowest priority the NR/E-UTRAN Satellite access/RAT/access technology, optionally for the last registered PLMN or any selected PLMN or Network (RAT/Access/Access Technology/PLMN or any combination of these) for which the UE (100) is in NR/E-UTRAN Satellite Access discontinuous coverage, optionally for the duration of the unavailability period duration or until the discontinuous coverage period is not over. In yet another embodiment, the UE (100) shall not select the NR/E-UTRAN Satellite access network or the UE (100) shall ignore the NR/E-UTRAN Satellite access network or the UE (100) shall disable the NR/E-UTRAN Satellite access network or the UE (100) shall postpone the search for NR/E-UTRAN Satellite access network or the UE (100) shall de-prioritize the search for NR/E-UTRAN Satellite access network or the UE (100) shall select the NR/E-UTRAN Satellite access network with the lowest priority, optionally among all the supported and/or enabled access technologies by the UE, optionally for the registered PLMN/RPLMN or Selected PLMN/Network or any PLMN/Network, for which UE (100) determines that the UE (100) is in the Satellite Access discontinuous coverage, optionally for the duration of the discontinuous coverage or the unavailability period duration or until the discontinuous coverage period is ongoing and is not over or until the UE (100) determines that the UE (100) is not in the discontinuous coverage, optionally for the selected PLMN or Network.

In yet another embodiment, at Switch-ON or recovery from lack of coverage, if the UE (100) is in automatic mode (automatic network selection mode), if there is no last registered PLMN, then the UE (100) shall disable/ignore/postpone/de-prioritize/not select/select or search with lowest priority the NR/E-UTRAN Satellite access/RAT/access technology, optionally for the selected PLMN or Network (RAT/Access/Access Technology/PLMN or any combination of these) for which the UE (100) determines that the UE (100) is in NR/E-UTRAN Satellite Access discontinuous coverage, optionally for the duration of the discontinuous coverage or the unavailability period duration or until the discontinuous coverage period is ongoing and is not over or until the UE (100) determines that the UE (100) is not in the discontinuous coverage, optionally for the selected PLMN or the network.

In yet another embodiment, after Power-ON, if UE (100) is in automatic mode (network selection mode), UE (100) shall not search for Last registered PLMN(RPLMN) over satellite Access/NTN RATs and thus UE (100) save time in searching for desired PLMN/Network. If there is no last registered PLMN, then UE (100) shall search for HPLMN/EHPLMN list in priority order for non-satellite accesses first (if priority of satellite access is lowered) or UE (100) will search only for HPLMN/EHPLMN list in priority order for non-satellite accesses (if satellite access is disabled) based on the discontinuous coverage or based on unavailability period/duration or Start Time/End Time whenever Discontinuous Coverage (DC) is ongoing for those NTN PLMN/Network.

This will solve the issue of un-necessary access/search to/for satellite RAT/PLMNs during discontinuous coverage (DC) at switch on or during recovery from lack of coverage and UE (100) will be able to get services faster (on non-satellite accesses) and power consumption will be low.

After the discontinuous coverage is over or the UE (100) is back in the coverage of the NR/E-UTRAN Satellite access network or the UE (100) determines that the NR/E-UTRAN Satellite access discontinuous coverage is over or the UE (100) determines that the NR/E-UTRAN Satellite access network is available, at switch on or recovery from lack of coverage or during PLMN search/selection, the UE (100) can select/consider/search/prioritize the NR/E-UTRAN Satellite access/RAT or activate/re-activate its access stratum/access stratum functions for NR/E-UTRAN Satellite Access, optionally for the selected PLMN or network. In yet another embodiment, the UE (100) may add the Satellite access in the priority list again or priority can be set to search/select Satellite access whenever available.

Referring to FIG. 14, at operation S1402, at switch on the UE (100) or recovery from lack of coverage, the UE (100) is in the automatic mode. At operation S1404, the UE (100) determines that the UE (100) is in the discontinuous coverage of the NR/E-UTRAN Satellite Access Network, (optionally for the selected PLMN/Network). At operation S1406, the UE (100) shall disable/ignore/postpone/de-prioritize/not select/select or search with lowest priority the NR/E-UTRAN Satellite access/RAT/access technology, optionally for the selected PLMN or Network (RAT/Access/Access Technology/PLMN or any combination of these) for which the UE (100) determines that the UE (100) is in NR/E-UTRAN Satellite Access discontinuous coverage, optionally for the duration of the discontinuous coverage or the unavailability period duration or until the discontinuous coverage period is ongoing and is not over or until the UE (100) determines that the UE (100) is not in the discontinuous coverage, optionally for the selected PLMN or Network.

At operation S1408, if the last registered access/Access Technology/RAT for the UE (100) was a NR/E-UTRAN Satellite Access Network and the UE (100) is currently in the NR/E-UTRAN Satellite Access Discontinuous Coverage (DC), optionally for the selected PLMN (i.e., RPLMN), UE (100) shall disable/ignore/postpone/de-prioritize/not select/select or search with lowest priority the NR/E-UTRAN Satellite access/RAT/access technology, optionally for the last registered PLMN or any selected PLMN or Network (RAT/Access/Access Technology/PLMN or any combination of these) for which UE (100) is in NR/E-UTRAN Satellite Access discontinuous coverage, optionally for the duration of the unavailability period duration or until the discontinuous coverage period is not over

At operation S1410, the UE (100) will be able to get services faster (on non-satellite accesses) and power consumption will be low.

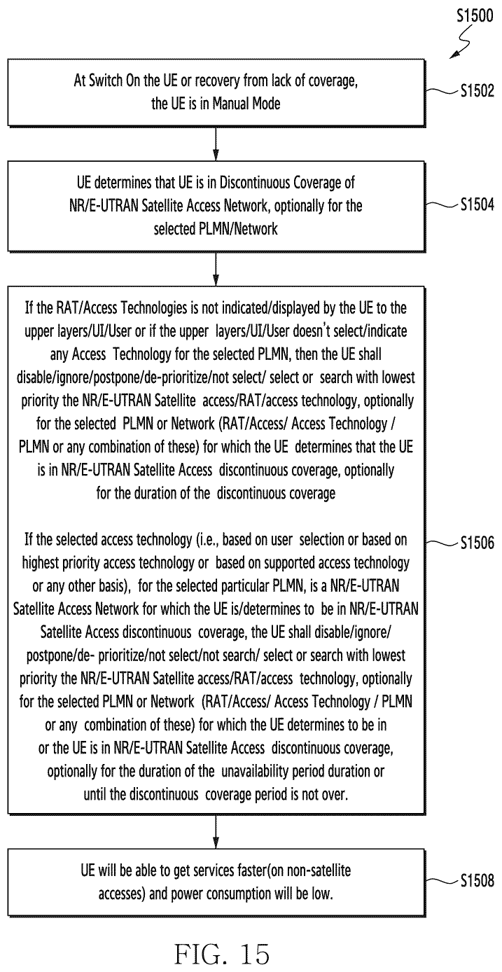

FIG. 15 depicts an example scenario (S1500), wherein the UE (100) shall disable/ignore/postpone/de-prioritize the NR/E-UTRAN Satellite access/RAT or by lowering the priority of satellite access/NTN RATs during Discontinuous Coverage according to an embodiment of the disclosure.

When the UE (100) determines that UE (100) is in NR/E-UTRAN Satellite Access Discontinuous Coverage (DC) of selected/any PLMN or NTN Network/PLMN/RAT/Access/Access Technology combination and the UE (100) is in manual mode (manual network selection mode). At Switch-ON or during recovery from lack of coverage or during any PLMN/Network Search/Selection/Scanning, optionally if the UE (100) is in Manual mode (i.e. Manual network selection mode), if the UE (100) determines that the UE (100) is in NR/E-UTRAN Satellite Access Discontinuous Coverage or the UE (100) is in an area/TAI/Registration Area where Satellite Coverage or Satellite Access is not available or, optionally based on unavailability period duration or Start of Unavailability Period or Start Time/End Time of Unavailability period or Unavailability type, or optionally based on UE (100) determination or Network indication or based on any information available/stored in the UE (100) (for e.g., in ME/USIM/UE) indicating that the UE (100) is in satellite access discontinuous coverage optionally without any indication by the UE (100) or by the Network regarding the start/duration of the unavailability period/discontinuous coverage before/during the start of the satellite access discontinuous coverage, or when the UE (100) is in NR/E-UTRAN Satellite Access Discontinuous Coverage or if the UE (100) determines that the UE (100) does not have the information for discontinuous coverage or unavailability period/unavailability type or start of unavailability period or start time/end time of discontinuous coverage/unavailability period and/or the Satellite Coverage or Satellite Access is not available, optionally for a selected PLMN or Network or whenever Discontinuous Coverage (DC) is ongoing for the selected PLMN or Network, UE (100) shall search for all the available PLMN(s) or Network (i.e., PLMN/RAT/Access or combination of these) using all the supported access technologies except NR/E-UTRAN Satellite Access/RAT, optionally for the selected Network/PLMN for which discontinuous coverage/unavailability period is ongoing, and the UE (100) shall disable/de-activate/ignore/postpone/de-prioritize/not select/not search/select or search with lowest priority the NR/E-UTRAN Satellite access/RAT/access technology or de-activate its access stratum due to discontinuous coverage/unavailability period or de-activate its access stratum/access stratum functions for NR/E-UTRAN Satellite Access until coverage returns, optionally for the selected PLMN or Network (RAT/Access/Access Technology/PLMN or any combination of these) for which the UE (100) determines to be in or the UE (100) is in NR/E-UTRAN Satellite Access discontinuous coverage, optionally for the duration of the unavailability period duration or until the discontinuous coverage period is not over or based on unavailability period duration and/or start of unavailability period and/or Start Time/End Time of discontinuous coverage. In an embodiment herein, at switch on, if the UE (100) is in Manual mode (i.e., Manual network selection mode), if the UE (100) determines that it is in discontinuous coverage, the UE (100) may deactivate its Access Stratum functions for NR satellite access. In yet another embodiment herein, at switch on or recovery from lack of coverage. If the UE (100) is in Manual mode (i.e. Manual network selection mode), if the UE (100) determines that it is in discontinuous coverage, the UE (100) may deactivate its Access Stratum functions for NR satellite access. In an embodiment herein, in general, the UE (100) may disable or de-activate its access stratum/access stratum functions for either NR Satellite Access or the UE (100) may disable or de-activate its access stratum/access stratum functions for E-UTRAN Satellite Access or the UE (100) may disable or de-activate its access stratum/access stratum functions for both NR Satellite Access and E-UTRAN Satellite Access or the UE (100) may disable or de-activate its access stratum for any associated or supported RAT(s) or RAT type(s) or PLMN(s) or Access or any combination of these.

In yet another embodiment, at Switch-ON or during recovery from lack of coverage or during any PLMN/Network Search/Selection/Scanning, optionally if the UE (100) is in Manual mode (i.e. Manual network selection mode), if the UE (100) determines that the UE (100) is not in NR/E-UTRAN Satellite Access Discontinuous Coverage or the UE (100) is in an area/TAI/Registration Area where Satellite Coverage or Satellite Access is available or, optionally based on unavailability period duration or Start of Unavailability Period or Start Time/End Time of Unavailability period or Unavailability type or when UE (100) is in NR/E-UTRAN Satellite Access Discontinuous Coverage or if the UE (100) determines that the UE (100) doesn't have the information for discontinuous coverage or unavailability period/unavailability type or start of unavailability period or start time/end time of discontinuous coverage/unavailability period and/or the Satellite Coverage or Satellite Access is available, optionally for a selected PLMN or Network or whenever Discontinuous Coverage (DC) is ongoing for the selected PLMN or Network, UE (100) shall search for all the available PLMN(s) or Network (i.e., PLMN/RAT/Access or combination of these) using all the supported access technologies optionally including NR/E-UTRAN Satellite Access/RAT, if supported by the UE, optionally for the selected Network/PLMN for which discontinuous coverage/unavailability period is not ongoing, and the UE (100) shall not disable/de-activate/ignore/postpone/de-prioritize and/or shall select/search/select or search with any priority order the NR/E-UTRAN Satellite access/RAT/access technology or shall not de-activate its access stratum due to discontinuous coverage/unavailability period or shall not de-activate its access stratum/access stratum functions for NR/E-UTRAN Satellite Access until coverage returns, optionally for the selected PLMN or Network (RAT/Access/Access Technology/PLMN or any combination of these) for which the UE (100) determines to be not in or the UE (100) is not in NR/E-UTRAN Satellite Access discontinuous coverage, optionally until UE (100) enters discontinuous coverage/unavailability period/start time of unavailability period or discontinuous coverage starts.

In yet another embodiment, the UE (100) shall indicate/populate the list of the available PLMN(s), optionally including/indicating/displaying the list of RAT/Access Technologies associated/available along with the available PLMN(s) to the upper layers/UI/User and/or the UE (100) shall not indicate/include/display the NR/E-UTRAN satellite access technology/RAT to the upper layers/UI/User, for the PLMN(s), for which the UE (100) is/determines to be in the NR/E-UTRAN Satellite access discontinuous coverage.

If the RAT/Access Technologies is not indicated/displayed by the UE (100) to the upper layers/UI/User or if the upper layers/UI/User doesn't select/indicate any Access Technology for the selected PLMN, then the UE (100) shall select the highest priority available access technology for the selected PLMN, if available or stored in the UE, or the UE (100) may select any supported access technology for the selected PLMN for registration and the UE (100) shall disable/ignore/postpone/de-prioritize/not select/select or search with lowest priority the NR/E-UTRAN Satellite access/RAT/access technology or de-activate its access stratum due to discontinuous coverage/unavailability period or de-activate its access stratum/access stratum functions for NR/E-UTRAN Satellite Access, optionally for the selected PLMN/Network, until coverage returns, optionally for the selected PLMN or Network (RAT/Access/Access Technology/PLMN or any combination of these) for which the UE (100) determines that the UE (100) is in NR/E-UTRAN Satellite Access discontinuous coverage, optionally for the duration of the discontinuous coverage or the unavailability period duration or until the discontinuous coverage period is ongoing and is not over or until the UE (100) determines that the UE (100) is not in the discontinuous coverage, optionally for the selected PLMN or Network.

If the selected access technology (i.e., based on user selection or based on highest priority access technology or based on supported access technology or any other basis), for the selected particular PLMN, is a NR/E-UTRAN Satellite Access Network for which the UE (100) is/determines to be in NR/E-UTRAN Satellite Access discontinuous coverage, the UE (100) shall disable/ignore/postpone/de-prioritize/not select/not search/select or search with lowest priority the NR/E-UTRAN Satellite access/RAT/access technology or de-activate its access stratum due to discontinuous coverage/unavailability period or de-activate its access stratum/access stratum functions for NR/E-UTRAN Satellite Access until coverage returns, optionally for the selected PLMN or Network (RAT/Access/Access Technology/PLMN or any combination of these) for which the UE (100) determines to be in or the UE (100) is in NR/E-UTRAN Satellite Access discontinuous coverage, optionally for the duration of the unavailability period duration or until the discontinuous coverage period is not over.

In yet another embodiment, if the Upper Layers/UI/User selects a PLMN/Network and doesn't specify/indicate/select the access technology for the selected PLMN/Network and if the UE (100) determines that the UE (100) is in the NR/E-UTRAN Satellite Access discontinuous coverage of the selected PLMN/Network, the UE (100) shall disable/ignore/postpone/de-prioritize/not select/not search/select or search with lowest priority the NR/E-UTRAN Satellite access/RAT/access technology or de-activate its access stratum due to discontinuous coverage/unavailability period or de-activate its access stratum/access stratum functions for NR/E-UTRAN Satellite Access until coverage returns, optionally for the selected PLMN or Network (RAT/Access/Access Technology/PLMN or any combination of these) for which the UE (100) determines to be in or the UE (100) is in NR/E-UTRAN Satellite Access discontinuous coverage, optionally for the duration of the unavailability period duration or until the discontinuous coverage period is not over. In yet another embodiment, the UE (100) shall select any other supported access technology, other than/except NR/E-UTRAN Satellite access Network, optionally in priority order if available in the UE, to select/search for the selected PLMN/Network.

After the discontinuous coverage is over or the UE (100) is back in the coverage of the NR/E-UTRAN Satellite access network or the UE (100) determines that the NR/E-UTRAN Satellite access discontinuous coverage is over or the UE (100) determines that the NR/E-UTRAN Satellite access network is available, at switch on or recovery from lack of coverage or during PLMN search/selection when the UE (100) is in manual mode, the UE (100) can select/consider/search/prioritize the NR/E-UTRAN Satellite access/RAT or activate/re-activate its access stratum/access stratum functions for NR/E-UTRAN Satellite Access, optionally for the selected PLMN or network and optionally include/indicate/display the list of RAT/Access Technologies associated/available along with the available PLMN(s) to the upper layers/UI/User, and also includes/indicates NR/E-UTRAN Satellite access network, if available or found. In yet another embodiment, the UE (100) shall select/consider/search/prioritize the NR/E-UTRAN Satellite access/RAT or activate/re-activate its access stratum/access stratum functions for NR/E-UTRAN Satellite Access, optionally for the selected PLMN, optionally if selected/indicated by the User/Upper Layers/UI or optionally, if supported by the UE (100) or optionally if NR/E-UTRAN Satellite access is the highest priority access technology for the selected network/PLMN, optionally if the UE (100) is not in the NR/E-UUTRAN Satellite access discontinuous coverage, optionally for the selected PLMN/Network.

Referring to FIG. 15, at operation S1502, at switch On the UE (100) or recovery from lack of coverage, the UE (100) is in manual mode. At operation S1504, the UE (100) determines that the UE (100) is in the discontinuous coverage of NR/E-UTRAN Satellite Access Network, optionally for the selected PLMN/Network.

At operation S1506, if the RAT/Access Technologies is not indicated/displayed by the UE (100) to the upper layers/UI/user or if the upper layers/UI/User doesn't select/indicate any access technology for the selected PLMN, then the UE (100) shall disable/ignore/postpone/de-prioritize/not select/select or search with lowest priority the NR/E-UTRAN Satellite access/RAT/access technology, optionally for the selected PLMN or Network (RAT/Access/Access Technology/PLMN or any combination of these) for which the UE (100) determines that the UE (100) is in NR/E-UTRAN Satellite Access discontinuous coverage, optionally for the duration of the discontinuous coverage.

If the selected access technology (i.e. based on user selection or based on highest priority access technology or based on supported access technology or any other basis), for the selected particular PLMN, is a NR/E-UTRAN Satellite Access Network for which the UE (100) is/determines to be in NR/E-UTRAN Satellite Access discontinuous coverage, the UE (100) shall disable/ignore/postpone/de-prioritize/not select/not search/select or search with lowest priority the NR/E-UTRAN Satellite access/RAT/access technology, optionally for the selected PLMN or Network (RAT/Access/Access Technology/PLMN or any combination of these) for which the UE (100) determines to be in or the UE (100) is in NR/E-UTRAN Satellite Access discontinuous coverage, optionally for the duration of the unavailability period duration or until the discontinuous coverage period is not over.

At operation S1508, the UE (100) will be able to get services faster (on non-satellite accesses) and power consumption will be low.

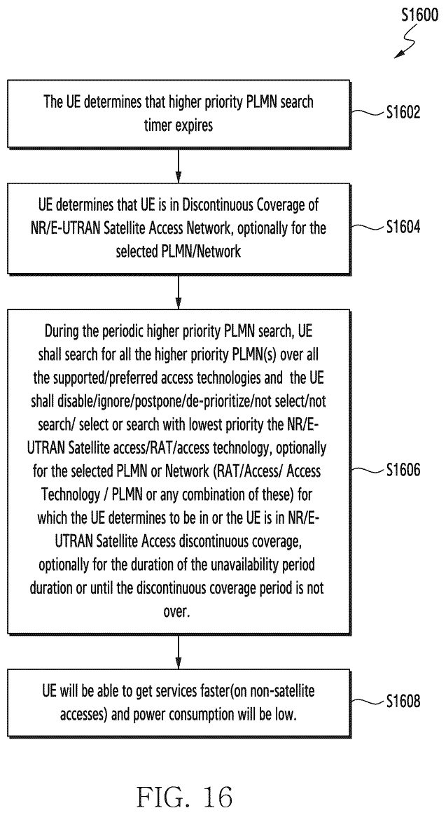

FIG. 16 depicts an example scenario (S1600), wherein the UE (100) shall disable/ignore/postpone/de-prioritize the NR/E-UTRAN Satellite access/RAT or by lowering the priority of satellite access/NTN RATs during Discontinuous Coverage according to an embodiment of the disclosure.

When the UE (100) determines that UE (100) is in NR/E-UTRAN Satellite Access Discontinuous Coverage (DC) of selected/any PLMN or Network/PLMN/RAT/Access/Access Technology or any combination of these and periodic higher priority PLMN search timer or any timer or procedure for selection of a higher priority Network or for a better system expires. If the UE (100) is in a Visited PLMN (VPLMN), the UE (100) shall periodically attempt to obtain service on its HPLMN (if the EHPLMN list is not present or is empty) or one of its EHPLMNs (if the EHPLMN list is present) or a higher priority PLMN/access technology combinations listed in “user controlled PLMN selector” or “operator controlled PLMN selector” by scanning in accordance with the requirements that are applicable to i), ii) and iii) as defined in the Automatic Network Selection Mode in clause 4.4.3.1.1 of 3GPP TS 23.122. During the periodic higher priority PLMN search, if the UE (100) determines that the UE (100) is in NR/E-UTRAN Satellite Access Discontinuous Coverage or the UE (100) is in an area/TAI/Registration Area where Satellite Coverage or Satellite Access is not available, optionally based on unavailability period duration or Start of Unavailability Period or Start Time/End Time of Unavailability period or Unavailability type, or optionally based on the UE (100) determination or the Network indication or based on any information available/stored in the UE (100) (for e.g., in ME/USIM/UE) indicating that the UE (100) is in satellite access discontinuous coverage optionally without any indication by the UE (100) or by the Network regarding the start/duration of the unavailability period/discontinuous coverage before/during the start of the satellite access discontinuous coverage, or when UE (100) is in NR/E-UTRAN Satellite Access Discontinuous Coverage, optionally for a selected PLMN or Network or whenever Discontinuous Coverage (DC) is ongoing for the selected PLMN or Network, UE (100) shall search for all the higher priority PLMN(s) over all the supported/preferred access technologies except NR/E-UTRAN Satellite Access/RAT, optionally for the selected Network/PLMN for which discontinuous coverage/unavailability period is ongoing and the UE (100) shall disable/ignore/postpone/de-prioritize/not select/not search/select or search with lowest priority the NR/E-UTRAN Satellite access/RAT/access technology or the UE (100) shall de-activate its access stratum due to discontinuous coverage/unavailability period or de-activate its access stratum/access stratum functions for NR/E-UTRAN Satellite Access, until coverage returns, optionally for the selected PLMN or Network (RAT/Access/Access Technology/PLMN or any combination of these) for which the UE (100) determines to be in or the UE (100) is in NR/E-UTRAN Satellite Access discontinuous coverage, optionally for the duration of the unavailability period duration or until the discontinuous coverage period is not over.

In an embodiment herein, when the UE (100) is periodically attempting/searching to obtain service on Higher Priority PLMN(s) (i.e., during Higher Priority PLMN Search), if the UE (100) determines that it is in discontinuous coverage, the UE (100) may deactivate its Access Stratum functions for NR satellite access. In an embodiment herein, in general, the UE (100) may disable or de-activate its access stratum/access stratum functions for either NR Satellite Access or the UE (100) may disable or de-activate its access stratum/access stratum functions for E-UTRAN Satellite Access or the UE (100) may disable or de-activate its access stratum/access stratum functions for both NR Satellite Access and E-UTRAN Satellite Access or the UE (100) may disable or de-activate its access stratum for any associated or supported RAT(s) or RAT type(s) or PLMN(s) or Access or any combination of these.

In yet another embodiment, if the UE (100) is in a Visited PLMN (VPLMN), UE (100) shall periodically attempt to obtain service on its HPLMN (if the EHPLMN list is not present or is empty) or one of its EHPLMNs (if the EHPLMN list is present) or a higher priority PLMN/access technology combinations listed in “user controlled PLMN selector” or “operator controlled PLMN selector” by scanning in accordance with the requirements that are applicable to i), ii) and iii) as defined in the Automatic Network Selection Mode in clause 4.4.3.1.1 of 3GPP TS 23.122. During the periodic higher priority PLMN search, if the UE (100) determines that the UE (100) is not in NR/E-UTRAN Satellite Access Discontinuous Coverage or the UE (100) is in an area/TAI/Registration Area where Satellite Coverage or Satellite Access is available, optionally based on unavailability period duration or Start of Unavailability Period or Start Time/End Time of Unavailability period or Unavailability type or when UE (100) is not in NR/E-UTRAN Satellite Access Discontinuous Coverage, optionally for a selected PLMN or Network or whenever Discontinuous Coverage (DC) is not ongoing for the selected PLMN or Network, UE (100) shall search for all the higher priority PLMN(s) over all the supported/preferred access technologies optionally including NR/E-UTRAN Satellite Access/RAT, if supported or preferred by the UE, optionally for the selected Network/PLMN for which discontinuous coverage/unavailability period is not ongoing and the UE (100) shall not disable/ignore/postpone/de-prioritize and/or the UE (100) may select/search/select or search with any priority the NR/E-UTRAN Satellite access/RAT/access technology or the UE (100) shall not de-activate its access stratum due to discontinuous coverage/unavailability period or shall not de-activate its access stratum/access stratum functions for NR/E-UTRAN Satellite Access, optionally until UE (100) enters discontinuous coverage/unavailability period/start time of unavailability period or discontinuous coverage starts, optionally for the selected PLMN or Network (RAT/Access/Access Technology/PLMN or any combination of these) for which the UE (100) determines not to be in or the UE (100) is not in NR/E-UTRAN Satellite Access discontinuous coverage, optionally until UE (100) enters discontinuous coverage/unavailability period/start time of unavailability period or discontinuous coverage starts.

For the selected/registered/any PLMN/Network, if the UE (100) determines that the UE (100) is in the NR/E-UTRAN Satellite Access discontinuous coverage of the selected/registered PLMN/Network, the UE (100) shall disable/ignore/postpone/de-prioritize/not select/not search/select or search with lowest priority the NR/E-UTRAN Satellite access/RAT/access technology or de-activate its access stratum due to discontinuous coverage/unavailability period or de-activate its access stratum/access stratum functions for NR/E-UTRAN Satellite Access, until coverage returns, optionally for the selected PLMN or Network (RAT/Access/Access Technology/PLMN or any combination of these) for which the UE (100) determines to be in or the UE (100) is in NR/E-UTRAN Satellite Access discontinuous coverage, optionally for the duration of the unavailability period duration or until the discontinuous coverage period is not over or based on unavailability period duration and/or start of unavailability period and/or Start Time/End Time of discontinuous coverage. In yet another embodiment, the UE (100) shall select any other supported access technology, other than/except NR/E-UTRAN Satellite access Network, optionally in priority order if available in the UE, to select/search for the selected PLMN/Network.

After the discontinuous coverage is over or the UE (100) is back in the coverage of the NR/E-UTRAN Satellite access network or the UE (100) determines that the NR/E-UTRAN Satellite access discontinuous coverage is over or UE (100) moves to any area/TAI for which it does not have the Discontinuous coverage or start time information or the UE (100) determines that the NR/E-UTRAN Satellite access network is available, during higher priority PLMN search or when the periodic timer T expires for higher priority PLMN search, the UE (100) can select/consider/search/prioritize the NR/E-UTRAN Satellite access/RAT or activate/re-activate its access stratum/access stratum functions for NR/E-UTRAN Satellite Access, optionally for the selected PLMN or network. In yet another embodiment, the UE (100) shall select/consider/search/prioritize the NR/E-UTRAN Satellite access/RAT or activate/re-activate its access stratum/access stratum functions for NR/E-UTRAN Satellite Access, optionally for the selected PLMN, if supported by the UE (100) or optionally if NR/E-UTRAN Satellite access is the highest priority access technology for the selected network/PLMN, optionally if the UE (100) is not in the NR/E-UUTRAN Satellite access discontinuous coverage, optionally for the selected PLMN/Network.

The UE (100) may determine that the UE (100) is in NR/E-UTRAN Satellite Access Discontinuous Coverage, optionally for a selected/registered PLMN or Network, through at-least one of the below methods:
a. Based on the Start of the Unavailability Period and/or Unavailability period duration determined by the UE, indicated by the Network (i.e., by any Network Function such as AMF, MME etc.) or negotiated between the UE (100) and the Network. For ex-If the current time is after the Start Time and the Unavailability Period Duration is not over, UE (100) may determine that the UE (100) is in discontinuous coverage, optionally for the selected PLMN or Network;
b. Based on the Unavailability Type, which indicates that the Unavailability Period is due to NR/E-UTRAN Satellite Access Network discontinuous coverage;
c. Based on any of the Network Broadcast parameters or messages or any Network indication (such as SIB-19, SIB-32);
d. Based on UE (100) determination;
e. Based on Satellite coverage availability information (SCAI) provided to the UE (100) by AF or the 5GC NF (like AMF/PCF/UDM or any other NF etc.) or any other entity such as Satellite Coverage Availability Function (SCAF);
f. If the UE (100) is in an area/TAI/Registration Area where Satellite Coverage or Satellite Access is not available;
g. If the UE (100) doesn't have the information for discontinuous coverage or unavailability period/unavailability type or start of unavailability period or start time/end time of discontinuous coverage/unavailability period and/or the Satellite Coverage or Satellite Access is not available, optionally for the UE (100) in the given area/TAI/Registration Area; and
h. Based on UE determination, using AI/ML models deployed at the UE side.
i. Based on the historical coverage data stored and maintained at the UE side, and techniques implemented at the UE side to predict Satellite Coverage availability.
j. Based on indication/message/broadcast provided by the Terrestrial Network cell about availability of NTN coverage in an area.
k. Based on OEM/Network/Satellite operator server (for e.g., Server or Operator Server) deployed to provide this information to the UE.
l. Pre-configuration by the operator in the UE or SIM/USIM of the device.
m. Based on any other methods or indication.

In this embodiment, if the UE (100) doesn't determine or fails to determine or the UE (100) is not able to determine that the UE (100) is in NR/E-UTRAN Satellite Access Discontinuous Coverage, optionally for a selected PLMN or Network, then the UE (100) may determine that the UE (100) is not in the NR/E-UTRAN Satellite Access Discontinuous Coverage, optionally for a selected PLMN or Network.

In yet another embodiment, if the UE (100) is not able to determine any of the above conditions or methods or procedures, then the UE (100) determines that the UE (100) is not in the NR/E-UTRAN Satellite Access Discontinuous Coverage, optionally for a selected PLMN or Network.

In an embodiment, if the UE (100) is not in NR/E-UTRAN Satellite Access Discontinuous Coverage may mean that the UE (100) is in NR/E-UTRAN Satellite Access coverage.

In an embodiment, if the UE (100) is in NR/E-UTRAN Satellite Access Discontinuous Coverage may mean that the UE (100) is not in NR/E-UTRAN Satellite Access coverage.

In an embodiment, the UE (100) may disable or de-activate its access stratum/access stratum functions may mean any of the following, in any order or combinations:
a. the UE (100) may disable or de-activate its access stratum/access stratum functions for NR Satellite Access;
b. the UE (100) may disable or de-activate its access stratum/access stratum functions for NR Satellite Access, optionally for the selected/registered PLMN only or optionally over any/all the PLMN(s), optionally over any access (i.e., only 3GPP access or only Non-3GPP access or both 3GPP access and Non-3GPP access);
c. the UE (100) may disable or de-activate its access stratum/access stratum functions for E-UTRAN Satellite Access;
d. the UE (100) may disable or de-activate its access stratum/access stratum functions for E-UTRAN Satellite Access, optionally for the selected/registered PLMN only or optionally over any/all the PLMN(s), optionally over any access (i.e., only 3GPP access or only Non-3GPP access or both 3GPP access and Non-3GPP access);
e. the UE (100) may disable or de-activate its access stratum/access stratum functions for both NR Satellite Access and E-UTRAN Satellite Access;
f. the UE (100) may disable or de-activate its access stratum/access stratum functions for both NR Satellite Access and E-UTRAN Satellite Access, optionally for the selected/registered PLMN only or optionally over any/all the PLMN(s), optionally over any access (i.e., only 3GPP access or only Non-3GPP access or both 3GPP access and Non-3GPP access);
g. the UE (100) may disable or de-activate its access stratum for any/all associated or supported RAT(s) or RAT type(s) or PLMN(s) or Access or any combination of these; and
h. the UE (100) may disable or de-activate its access stratum for any/all associated or supported RAT(s) or RAT type(s) or PLMN(s) or Access or any combination of these, for which discontinuous coverage is determined.

Referring to FIG. 16, at operation S1602, the UE (100) determines that higher priority PLMN search timer is expired. At operation S1604, the UE (100) determines that the UE (100) is in the discontinuous coverage of NR/E-UTRAN Satellite Access Network, optionally for the selected PLMN/Network.

At operation S1606, during the periodic higher priority PLMN search, the UE (100) shall search for all the higher priority PLMN(s) over all the supported/preferred access technologies and the UE (100) shall disable/ignore/postpone/de-prioritize/not select/not search/select or search with lowest priority the NR/E-UTRAN Satellite access/RAT/access technology, optionally for the selected PLMN or Network (RAT/Access/Access Technology/PLMN or any combination of these) for which the UE (100) determines to be in or the UE (100) is in NR/E-UTRAN Satellite Access discontinuous coverage, optionally for the duration of the unavailability period duration or until the discontinuous coverage period is not over. At operation S1608, the UE (100) will be able to get services faster (on non-satellite accesses) and power consumption will be low.

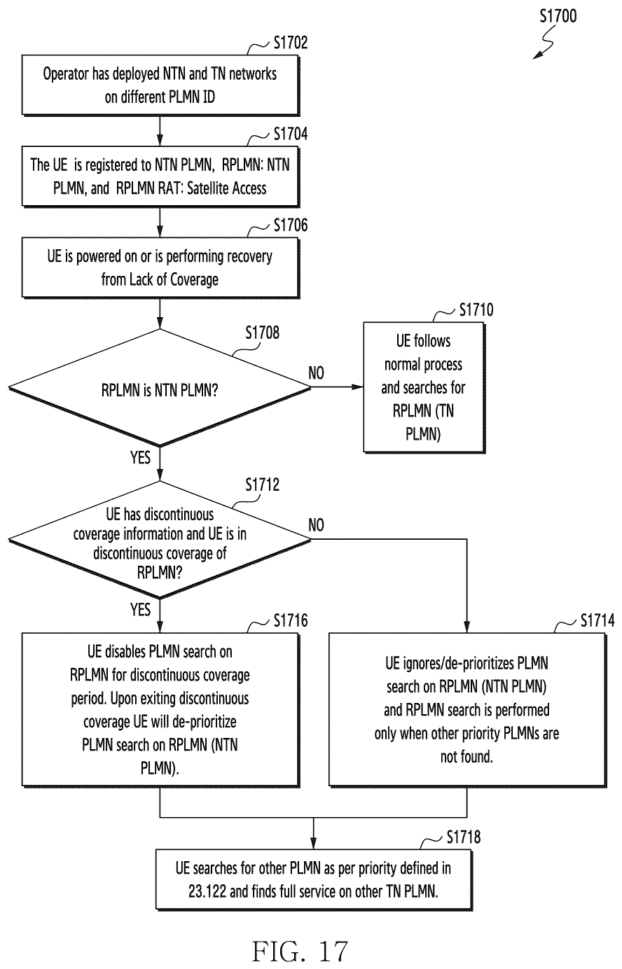

FIG. 17 depicts an example scenario (S1700), wherein the UE (100) shall disable/ignore/postpone/de-prioritize the NR/E-UTRAN Satellite access/RAT or by lowering the priority of satellite access/NTN RATs during Discontinuous Coverage, according to an embodiment of the disclosure.

Referring to FIG. 17, at operation S1702, the operator has deployed NTN and TN networks on different PLMN ID. At operation S1704, the UE (100) is registered to NTN PLMN, RPLMN: NTN PLMN, and RPLMN RAT: Satellite Access. At operation S1706, the UE (100) is powered on or is performing recovery from lack of coverage. At operation S1708, the UE (100) determines that RPLMN is NTN PLMN?

If that RPLMN is not the NTN PLMN, at operation S1710, the UE (100) follows normal process and searches for RPLMN (TN PLMN). If that RPLMN is the NTN PLMN, at operation S1712, the UE (100) determines whether the UE (100) has discontinuous coverage information and the UE (100) is in discontinuous coverage of RPLMN?

If the UE (100) does not have the discontinuous coverage information and the UE (100) is not in discontinuous coverage of RPLMN then, at operation S1714, the UE (100) ignores/de-prioritizes PLMN search on RPLMN (NTN PLMN) and RPLMN search is performed only when other priority PLMNs are not found.

If the UE (100) has discontinuous coverage information and the UE (100) is in discontinuous coverage of RPLMN then, at operation S1716, the UE (100) disables the PLMN search on the RPLMN for discontinuous coverage period. Upon exiting discontinuous coverage, the UE (100) will de-prioritize PLMN search on the RPLMN (i.e., NTN PLMN).

At operation S1718, the UE (100) searches for other PLMN as per priority defined in 23.122 and finds full service on other TN PLMN.

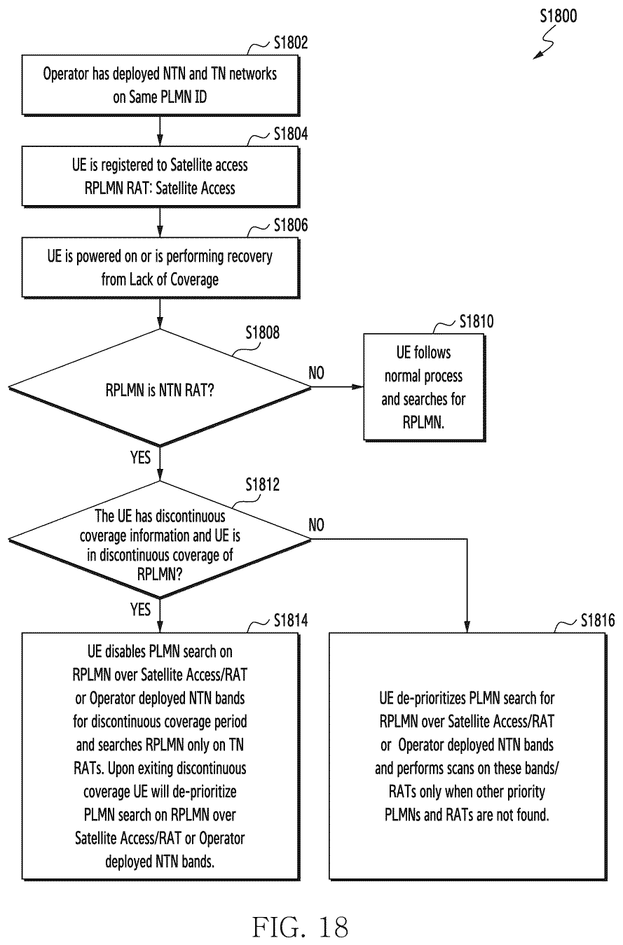

FIG. 18 depicts an example scenario (S1800), where the UE (100) shall disable/ignore/postpone/de-prioritize the NR/E-UTRAN Satellite access/RAT or by lowering the priority of satellite access/NTN RATs during Discontinuous Coverage, according to an embodiment of the disclosure.

At operation S1802, the operator has deployed NTN and TN networks on the same PLMN ID. At operation S1804, the UE (100) is registered to the satellite access RPLMN RAT: Satellite Access. At operation S1806, the UE (100) is powered on or is performing recovery from lack of coverage. At operation S1808, the UE (100) determines whether the RPLMN is NTN RAT?

If the RPLMN is NTN RAT then, at operation S1810, the UE (100) follows the normal process and searches for RPLMN. If the RPLMN is not NTN RAT then, at operation S1812, the UE (100) determines whether the UE (100) has discontinuous coverage information and the UE (100) is in discontinuous coverage of RPLMN?

If the UE (100) has discontinuous coverage information and the UE (100) is in discontinuous coverage of RPLMN then, at operation S1814, UE (100) disables PLMN search on RPLMN over Satellite Access/RAT or Operator deployed NTN bands for discontinuous coverage period and searches RPLMN only on TN RATs. Upon exiting discontinuous coverage UE (100) will de-prioritize PLMN search on RPLMN over Satellite Access/RAT or Operator deployed NTN bands.

If the UE (100) does not have the discontinuous coverage information and the UE (100) is not in discontinuous coverage of RPLMN then, at operation S1816, UE (100) de-prioritizes PLMN search for RPLMN over Satellite Access/RAT or Operator deployed NTN bands and performs scans on these bands/RATs only when other priority PLMNs and RATs are not found.

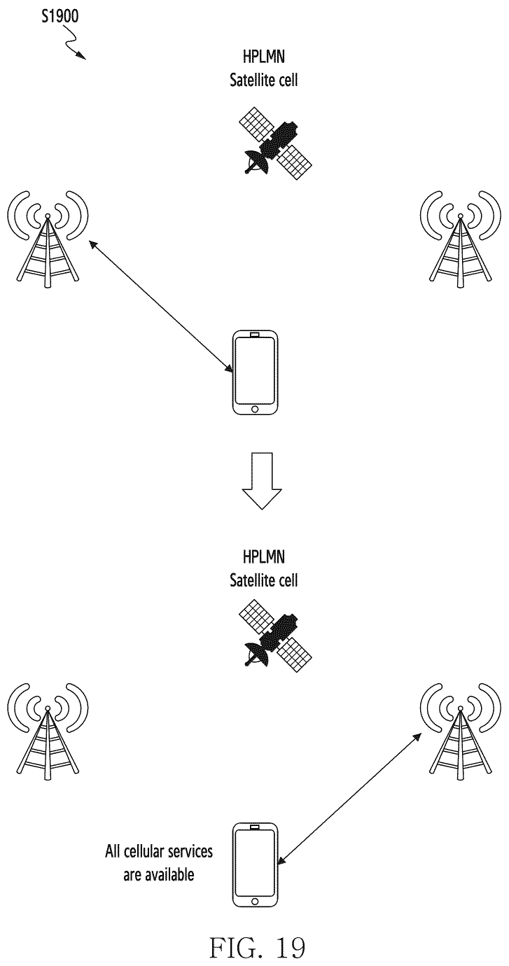

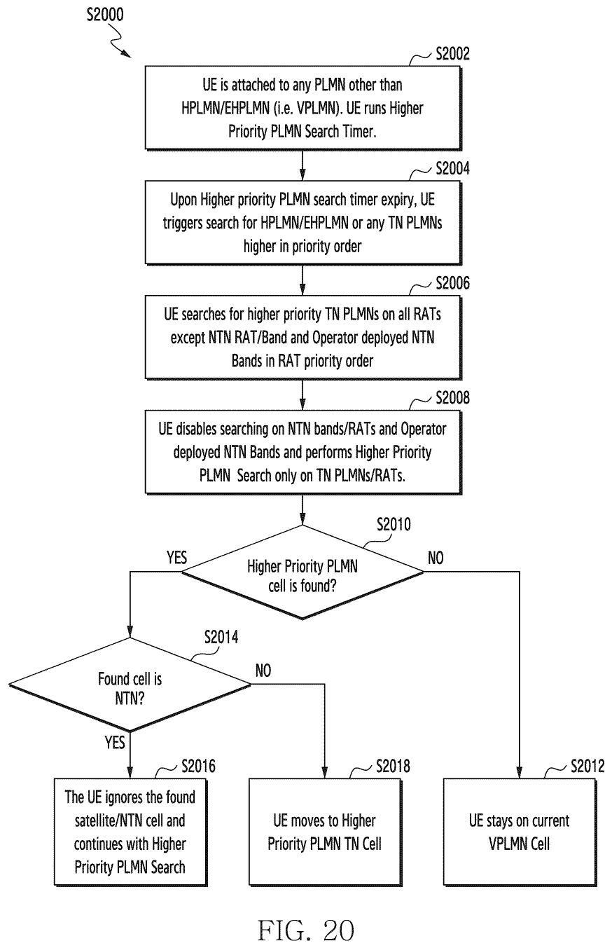

FIGS. 19 and 20 depict example scenarios (S1900-S2000), wherein the UE (100) shall disable/ignore/postpone/de-prioritize the NR/E-UTRAN Satellite access/RAT or by lowering the priority of satellite access/NTN RATs during Discontinuous Coverage, according to various embodiments of the disclosure.

When the UE (100) is attached/registered to any PLMN other than the HPLMN/EHPLMN of the SIM (i.e. UE (100) is attached to a Visited PLMN or VPLMN), the UE (100) runs a higher priority PLMN search timer. The VPLMN may be a TN PLMN and is able to provide full set of services to the UE (100) such as SMS, MMS, HD Voice and Video Call, High speed Data etc. Since the UE (100) is not in highest priority PLMN, upon expiry of Higher priority PLMN search timer, the UE (100) searches for PLMNs higher in priority order (e.g., HPLMN/EHPLMN or OPLMN or UPLMN) (only TN PLMNs) for the UE (100) as defined in 23.122 on all RATs and Access Network (except Satellite Access Network or Operator deployed NTN Bands

The UE (100) belonging to the operator (For example, XYZ limited) is currently attached to a VPLMN TN network. The UE (100) runs a higher priority PLMN search timer and triggers search for only TN PLMNs (HPLMN/EHPLMN or other PLMNs higher in priority order as per 23.122) upon expiry of the Higher Priority PLMN Search timer.

During Higher Priority PLMN Search, the UE (100) with the proposed solution disables searching on NTN bands/RATs/PLMNs or Operator deployed NTN Bands on common PLMNs and performs Higher Priority PLMN Search only on TN RATs. If the network has deployed NTN services on same RATs/Bands as TN network and the UE (100) detects any NTN cell during Higher Priority PLMN search, the UE (100) ignores the found satellite/NTN cell and continues with Higher Priority PLMN Search. If UE (100) finds service on any TN PLMN, the UE (100) then selects the TN PLMN and performs attach/tracking area update on that PLMN. If no other higher priority PLMN TN cell is found, UE (100) remains on current TN VPLMN cell. UE (100) remains in full service throughout and does not move to a cell which can provide only limited set of services. User experience is good and user does not face service unavailability.

Referring to FIG. 19, the UE (100) ignores the NTN band/RAT during Higher Priority PLMN search procedure and performs Attach/registration/Tracking Area Update Procedure to attach to HPLMN TN cell only. The UE (100) moves to HPLMN/EHPLMN TN Cell if found or remains with the VPLMN. The UE (100) is able to get full set of services and User Experience is Good.

Referring to FIG. 20, at operation S2002, the UE (100) is attached/registered to any PLMN other than HPLMN/EHPLMN (i.e. VPLMN). The UE (100) runs higher priority PLMN search timer. At operation S2004, upon higher priority PLMN search timer expiry, the UE (100) triggers search for HPLMN/EHPLMN or any TN PLMNs higher in priority order. At operation S2006, the UE (100) searches for higher priority TN PLMNs on all RATs except NTN RAT/Band and Operator deployed NTN Bands in RAT priority order. At operation S2008, the UE (100) disables searching on NTN bands/RATs and Operator deployed NTN Bands and performs Higher Priority PLMN Search only on TN PLMNs/RATs.

At operation S2010, the UE (100) determines whether the higher priority PLMN cell is found? If the Higher Priority PLMN cell is not found then, at operation S2012, the UE (100) stays on current VPLMN Cell. If the Higher Priority PLMN cell is found then, at operation S2014, the UE (100) determines whether the found cell is NTN?

If found cell is NTN, at operation S2016, the UE (100) ignores the found satellite/NTN cell and continues with Higher Priority PLMN Search. If found cell is not NTN, at operation S2018, the UE (100) moves to Higher Priority PLMN TN Cell.

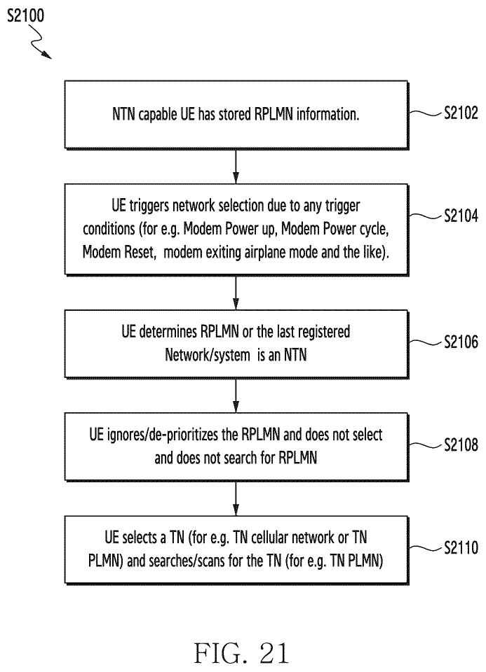

FIG. 21 depicts an example scenario (S2100), wherein the UE (100) capable to avail the NTN services shall ignore or de-prioritize the RPLMN if the last registered network or the system or the PLMN is the NTN (for e.g. NTN PLMN or NTN system) and the UE (100) shall search for any other TN (for e.g. any TN PLMN or TN cellular networks), according to an embodiment of the disclosure.

Referring to FIG. 21, at operation S2102, the UE (100) has the RPLMN value stored in the UE (100). The UE (100) may store or use the value of the last registered network (for e.g. the last registered PLMN or the RPLMN) in any of the file or registry or any of the memory present in the UE (100) (for e.g. in the UE (100) or the SIM Card.) (for e.g. the UE (100) may use any of: non-volatile memory or a registry file of the UE (100), a database maintained in the UE (100), a value of the RPLMN or Last registered stored or maintained in the UE (100), the value of the file present or derived in or from the SIM card (for e.g. files like but not limited to EF_LOCI, EF_PSLOCI, EF_EPSLOCI, EF5GS3GPPLOCI etc.)). The UE (100) may read a value of any parameter (for e.g. GUTI or TMSI or any Network identifier) from any of the files or memory or value stored in the UE (100) or the SIM Card and may derive the value of the last registered network or the last registered PLMN (RPLMN) from that value. In an embodiment, the UE (100) may derive the value of the last registered network or last registered PLMN from the value stored in the UE (100) (e.g., ME/USIM) or from a value using any of the files present in the SIM (for e.g. EF_LOCI, EF_PSLOCI, EF_EPSLOCI, EF5GS3GPPLOCI file) (for e.g. the files may contain value for some other parameters for e.g. GUTI and the UE (100) may use the value of that parameter to determine the value of the last registered Network or the RPLMN). In an embodiment, the UE (100) determines the last registered network by using at least one of: one or more of a value or a file or a configuration or an information configured or stored in the UE (100) (for e.g. a last registered network value derived or stored in the UE (100) or a last registered PLMN value (for e.g. RPLMN) stored or derived in the UE (100)), one or more of a value or a file or a configuration or an information configured or stored in the SIM, one or more of a value or a file or a configuration or an information configured by the network, one or more of a value or a file or a configuration or an information configured by the server, one or more of a value or a file or a configuration or an information configured by an application function, a value configured in the SIM, a value stored in or derived from one or more of the EF_EPSLOCI file or a EF_LOCI file or a EF_PSLOCI file or a EF5GS3GPPLOCI file (or any other file or value stored or derived from) in the SIM (for e.g. the value stored in the above file may refer to some other value from which UE can derive the value of the RPLMN or the last registered network), a value stored in the non-volatile memory of the device and a file stored in the SIM In an embodiment, the UE (100) may be an UE (100) which is capable of availing NTN service from any NTN or NTN deployment (for e.g. using NTN technology, using 3GPP-based NTN network, using existing 3GPP technologies (for e.g. using 3GPP RAT(s) such as LTE or NB-IOT NTN, i.e. deploying LTE-based Satellite system or NB-IOT based Satellite or NTN system).

At operation S2104, the UE (100) triggers the network selection or the network search procedure due to any of the trigger conditions (for e.g. modem power up, modem power cycle, modem reset, modem entering airplane mode, modem exiting airplane mode, SIM Refresh procedure, a Switch ON of the UE, a recovery of the UE (100) from lack of coverage, any PLMN/Network Search/Selection/Scanning procedure, handover procedure, idle mode procedure, reselection procedure, UE initiated detach, network initiated detach, reject from the network, SIM insertion in the UE (100), SIM removal and insertion in the UE (100), a network mode change in the UE (100), an expiry of higher priority PLMN search timer or expiry of any timer/trigger of any procedure for selection of a higher priority network/better system or any other trigger conditions as described in this embodiment). In an embodiment, the event includes at least one of: a switch off the UE (100), a switch on the UE (100), a recovery of the UE (100) from lack of the coverage area, the recovery of the UE (100) from the OOS area, the SIM insertion in the UE (100), the SIM re-insertion post removal in the UE (100), the SIM removal in the UE (100), the disabling of the SIM in the UE (100), an enabling of the SIM in the UE (100), the modem reset, the power cycle, the modem power up, the modem power cycle, the airplane mode on in the UE (100), the airplane mode off in the UE (100), the UE exiting airplane mode, the UE (100) entering airplane mode, the modem exiting airplane mode, the activation of the UE (100), the reject cause from the network, the detach triggered by the network, the deregistration triggered by the network, on entering store and forward mode in the UE (100), on exiting store and forward mode in the UE (100), on entering store and forward mode from the network, on exiting store and forward mode from the network, a detach triggered by the UE (100), a deregistration triggered by the UE (100), a network mode change in the UE (100), a network selection mode change in the UE (100), an operating mode change in the UE (100), on entering satellite mode in the UE (100), on exiting satellite mode in the UE (100), a turning on of a modem, and a SIM refresh procedure. These events may also be referred to as “trigger conditions” in this embodiment. In an embodiment, the event includes at least one of: an expiry of a timer for higher priority PLMN search procedure, a handover procedure, a redirection procedure, a reselection procedure, an expiry of a timer for Better System Reselection (BSR), the expiry of an operator defined timer, the background network search procedure, the idle mode procedure, the connected mode procedure and the network release procedure. The events may also include scenarios where the UE (100) need to trigger or perform the network search or selection or scanning procedure, a PLMN search or selection or scanning procedure, the cell search or selection or scanning procedure or a RAT/access search or selection or scanning procedure. In an embodiment, the trigger conditions explained in this embodiment are illustrated for example and it could be any trigger conditions.

At operation S2106, the UE (100) may determine the RPLMN or the last registered Network/system is the NTN. The UE (100) may determine the RPLMN or the last registered network/system is the NTN using any of the methods or procedures (for e.g. by using any of the: stored parameters, broadcast parameters, NAS signaling parameters, AS signaling parameters, AI/ML approach, data driven approach, a band/PLMN/Frequency/RAT used by the network operator/the satellite vendor for deploying the satellite service/the NTN service, a configuration by/from the server, and a configuration by an application function or any other mechanism/procedure/values/files. In an embodiment, the UE (100) may determine that the RPLMN or the last registered Network/system is the NTN before or during or after the network search/selection procedure is triggered or before or during or after the trigger conditions has occurred.

At operation S2108, the UE (100) upon determining the RPLMN is the NTN PLMN, the UE (100) ignores/de-prioritizes/postpones/disables the RPLMN and does not select the RPLMN and does not search for RPLMN. In an embodiment, the UE (100) shall ignore the RPLMN if the last registered network/system/PLMN was the NTN. In an embodiment, the UE (100) shall ignore the last registered network (for e.g. the last registered PLMN) if the UE (100) determines that the last registered network/system/PLMN was the NTN. In an embodiment, if the UE (100) determines that Network (for e.g. PLMN) selected for network selection/search procedure is the last registered network (for e.g. last registered PLMN or the RPLMN) and if the UE (100) determines that the last registered network/system/PLMN (for e.g. RPLMN) was a NTN, the UE (100) shall ignore or de-prioritize or does not select or disable or select with lowest priority or postpone the search on the last registered network/system/PLMN (for e.g. RPLMN) (for e.g. the UE (100) doesn't select the RPLMN or the last registered network or ignores the last registered network/system/PLMN (for e.g. RPLMN) if the selected network/PLMN is RPLMN or last registered network). In an embodiment, the UE shall ignore or de-prioritize or does not select or disable or select with lowest priority or postpone the search on the last registered network/system/PLMN over all access technologies. In an embodiment, the UE shall ignore or de-prioritize or does not select or disable or select with lowest priority or postpone the search on the last registered network/system/PLMN over satellite access technologies. In an embodiment, the UE (100) shall ignore or de-prioritize or does not select or disable or select with lowest priority or postpone the search on the last registered network/system/PLMN and its equivalent Network/system/PLMN (for e.g. equivalent PLMN). In an embodiment, ignoring the last registered network may occur during a network search procedure. In an embodiment, the UE (100) may ignore the last registered network during a network search procedure. In an embodiment, the UE (100) may ignore the last registered network before or during or after a network search procedure. In an embodiment, the UE (100) ignores the last registered network or the UE (100) ignores the NTN or the UE (100) ignores the last registered PLMN during a network search procedure. In an embodiment, the UE (100) ignores the last registered network or the UE (100) ignores the NTN or the UE (100) ignores the last registered PLMN if the selected network is same as the last registered network/PLMN and the last registered network/PLMN is the NTN. In an embodiment, the UE (100) ignores the NTN if the selected network is the NTN during network search procedure. In an embodiment, the UE (100) may add the last selected or the last registered network (for e.g. RPLMN or the PLMN or RAT or Cell or Band or Network any combination of these) to any temporary back-off network list or forbidden network list or any back-off list (for e.g. temporary forbidden PLMN list). The UE (100) may not select or search or scan or deprioritize or ignore or scan with lowest priority the Network (for e.g. cell/PLMN/RAT/Access/Band/Network) (for e.g. the RPLMN or the last registered network) present in this list. In an embodiment, the UE (100) may add the selected or the last registered network (for e.g. the RPLMN) (for e.g. PLMN or RAT or Cell or any combination of these to any temporary back-off network list or forbidden network list or any back-off list) which may lead to delay in the acquisition of available NTN services and UE can prioritize or select or scan the TN cellular Network or services first. In an embodiment, the scanning or search with lowest priority may mean that the UE (100) may scan or search for this network after the network search procedure has ended and no other suitable/allowable/available/preferred network is found. The solutions stated in this embodiment are illustrated using ignoring or de-prioritizing RPLMN or the last registered Network. However, the same solutions are also applicable to RPLMN and/or its equivalent PLMN, last registered network or its equivalent network, RPLMN and/or its equivalent PLMN over NTN or over satellite access technology, RPLMN and/or its equivalent PLMN over any access technologies, RPLMN over NTN or over the satellite access technology, RPLMN over any access technologies, last registered network over any access technologies, last registered network over NTN or over satellite access technology and the core principle remains the same. In an embodiment, the UE (100) may start the back-off timer associated with the last registered network or the last registered PLMN (for e.g. RPLMN) if the last registered network or the RPLMN is the NTN. The UE (100) shall ignore or shall not select or shall not scan or de-prioritize or does not select or disable or select with lowest priority or postpone the search/scanning on the last registered network/system/PLMN (for e.g. RPLMN) till the back-off timer is running. In an embodiment, the UE (100) may ignore or not consider the value of the EF_LRPLMNSI file present in the UE (100) (e.g., ME or USIM) and may determine to perform or trigger the network search procedure on any of the PLMN(s) or network as described in this embodiment. In an example, if the value of the EF_LRPLMNSI is 0, still the UE (100) may not select or may not search or may not scan or may deprioritize or ignore or scan with lowest priority the RPLMN or last registered network.

At operation S2110, the UE (100) selects the TN (for e.g. a terrestrial cellular network or the Terrestrial Network or the Terrestrial PLMN) and searches/scans or performs a network search procedure for the TN (for e.g. a terrestrial cellular network or the Terrestrial Network or the TN PLMN). In an embodiment, the UE (100) may select or search or scan or camp/register/attach for the network/PLMN other than the last registered network or last registered PLMN (for e.g. RPLMN) if the last registered Network/system/PLMN is the NTN. In embodiments herein, after the network search procedure, the UE (100) may camp or attach or register on any of the selected available network. The UE (100) may prefer to camp or attach or register or trigger the TAU on the TN before triggering the search or scanning on the NTN. The UE (100) may camp or attach or register or trigger the TAU on TN if the last registered network/system/PLMN is the NTN. In an embodiment, the UE (100) may start the timer after triggering the network search procedure. The UE (100) may not select or may not search or may not scan or may deprioritize or ignore or scan with lowest priority the last registered network/PLMN if the last registered network or PLMN was the NTN. The UE (100) may perform a network search/selection procedure of the TN. If the TN network is not found or any other network is not available or found or if the timer has expired, the UE may scan or search for the last registered network or PLMN or the NTN. In an embodiment, the UE (100) may wait for the timer to expire before searching or scanning for the last registered network or NTN. In an embodiment, if the TN network is not found or any network is not available or found, the UE (100) may stop the timer and the UE (100) may scan or search for the last registered network or PLMN or an NTN. In an embodiment, if any TN network is not found during the network search procedure, the UE (100) may choose to remain in No service and optionally, not select/scan/search for NTN. In an embodiment, during the network search procedure due to any trigger conditions, the UE (100) may de-prioritize or ignore or postpone or disable or select with lowest priority the NTN. If any TN Network is not found during the network search procedure, the UE (100) may choose to remain in the No Service and optionally, not select/scan/search for NTN. In an embodiment, if any TN Network is not found during the network search procedure, the UE (100) may select/scan/register/attach to any available NTN other than the last registered Network/PLMN. In an embodiment, if any TN network is not found during the network search procedure, the UE (100) may select/scan/register/attach to any available NTN (for e.g. including the last registered Network/PLMN). The UE (100) may prioritize the NTN which is available, optionally without any unavailability period or the NTN with minimal discontinuous coverage period or minimal unavailability period or minimal remaining unavailability period (for e.g. if multiple NTNs are available, the UE (100) may prioritize the NTN which is having a smaller unavailability period in comparison to a NTN which is having a greater unavailability period earlier) or the UE (100) may prioritize the NTN with a unavailability period start time later than the current time (for e.g. if multiple NTNs are available, the UE (100) may prioritize the NTN which is having a later start time of unavailability period in comparison to a NTN which is having a start time of unavailability period earlier) or any combination of these.

According to embodiments, a method may be performed by a user equipment (UE) for selecting a network search procedure. The method may comprise triggering a network search procedure. The method may comprise determining if a last registered network is a Non-Terrestrial Network (NTN). The method may comprise ignoring the last registered network, if the last registered Network is the NTN. The method may comprise performing the network search procedure for a terrestrial network (TN).

In an embodiment, the network may be at least one of: a Public Land Mobile Network (PLMN), a Radio Access Technology (RAT), an access, a Radio Access Network (RAN), the network operated in a band, the network operated in a frequency, the network operated in a cell, a Core Network (CN) Entity, a network entity, a network function, a TN, and an NTN.

In an embodiment, the last registered network may be a network on which the UE (100) was successfully registered or attached before selecting a network or before triggering a network selection or before triggering a network search procedure.

In an embodiment, the UE (100) may determine the Last Registered Network by using at least one of: one or more of: a value or a file or a configuration or an information configured or stored in the UE (100), one or more of: a value or a file or a configuration or an information configured or stored in the SIM, one or more of: a value or a file or a configuration or an information configured by the network, one or more of: a value or a file or a configuration or an information configured by a server, one or more of: a value or a file or a configuration or an information configured by an application function, a value configured in the SIM, a value stored in or derived from one or more of: an EF_EPSLOCI file or an EF_LOCI file or an EF_PSLOCI file or a EF5GS3GPPLOCI file in the SIM, a value stored in memory of the UE, or a file stored in the SIM.

In an embodiment, the UE (100) may determine that the last registered network is an NTN by using at least one of a broadcast parameter, a System Information Block (SIB) parameter, a Non-access stratum (NAS) signalling parameter, an access stratum (AS) signalling parameter, a band used by an operator for deploying a satellite service or an NTN service, a PLMN used by an operator for deploying the satellite service or the NTN service, a frequency used by the operator for deploying the satellite service or the NTN service, a RAT used by the operator for deploying the satellite service or the NTN service, a network deployed using any of an NTN Technology, a network used by a satellite vendor for deploying a satellite service or an NTN service, an information regarding configuration for an NTN deployment as configured in the UE (100), an information regarding configuration for the NTN deployment as indicated by the network, an information regarding configuration for the NTN deployment as configured in a Subscriber Identity Module (SIM), an information regarding configuration for the NTN deployment as indicated by a server, an information regarding configuration for the NTN deployment as indicated by an application function, a database indicating details of a satellite or NTN cell, its location, its availability/unavailability time and its deployment details, a machine learning or an artificial intelligence based technique to predict or determine a network type, or a data driven technique to predict or determine a network type.

In an embodiment, ignoring the last registered network comprises at least one of ignoring the last registered network if the last registered network is the NTN, ignoring the last registered network if the last registered network is the NTN and the UE (100) is in discontinuous coverage of the last registered network, de-prioritizing the last registered network if the last registered network is the NTN, selecting the last registered network with a lowest priority if the last registered network is the NTN, de-prioritizing the last registered network, if the last registered network is the NTN and the UE (100) is in the discontinuous coverage of the last registered network, selecting the last registered network with the lowest priority if the last registered network is the NTN and the UE (100) is in the discontinuous coverage of the last registered network, disabling the last registered network if the last registered network is the NTN, disabling the last registered network if the last registered network is the NTN and the UE (100) is in discontinuous coverage of the last registered network, disabling the last registered network over the NTN if the last registered network is the NTN, disabling the last registered network over the NTN if the last registered network is the NTN and the UE (100) is in the discontinuous coverage of the last registered network, ignoring the last registered network over the NTN if the last registered network is the NTN, ignoring the last registered network over the NTN if the last registered network is the NTN and the UE (100) is in the discontinuous coverage of the last registered network, de-prioritizing the last registered network over the NTN if the last registered network is the NTN, selecting the last registered network over the NTN the with lowest priority if the last registered network is the NTN, de-prioritizing the last registered network over the NTN, if the last registered network is the NTN and the UE (100) is in the discontinuous coverage of the last registered network, selecting the last registered network over the NTN with lowest priority if the last registered network is the NTN and the UE (100) is in the discontinuous coverage of the last registered network, disabling the last registered network over a satellite access or the NTN access or over the NTN deployed band or frequency or RAT if the last registered network is the NTN, disabling the last registered network when the last registered RAT is a satellite access or a satellite RAT or an NTN access or an NTN RAT, ignoring the last Registered PLMN (RPLMN) if the last registered network is the NTN, disabling the PLMN search on the last Registered PLMN (RPLMN) and searching for a TN PLMN as per priority order, disabling the PLMN search on the last Registered PLMN (RPLMN) and searching for a TN PLMN as per a priority order when the UE (100) is in the discontinuous coverage of the RPLMN, de-prioritizing the RPLMN and searching for the TN PLMN as per priority order, and searching for the NTN PLMN when the TN PLMN is not found, and the UE (100) is not in the discontinuous coverage of RPLMN, selecting any network other than NTN, selecting any PLMN other than RPLMN, selecting any network other than Last Registered Network, selecting a TN, or not selecting an NTN.

In an embodiment, the UE (100) may ignore the last registered network during the network search procedure.

In an embodiment, the last registered network may be at least one of a last registered PLMN (RPLMN), a last registered RAT (LRRAT), a last registered access, a last registered system, a last registered RAN, a last registered network operated in band, a last registered CN entity, a last registered Network entity, a last registered network function (NF), a last registered component of network, a last registered Terrestrial Network, a last registered Non-Terrestrial Network, a last registered network operated in frequency, or a last registered network operated in cell.

In an embodiment, the UE (100) may determine that the UE (100) is in the discontinuous coverage of the network by using at least one of a broadcast parameter, a System Information Block (SIB) parameter, a Non-access stratum (NAS) signalling parameter, an access stratum (AS) signalling parameter, an information regarding configuration for NTN deployment as configured in the UE (100), an information regarding configuration for the NTN deployment as indicated by the network, an unavailability period duration and a start of unavailability period, an unavailability type, an indication for store and forward mode, a satellite coverage availability information, a satellite ephemeris information, an information regarding configuration for the NTN deployment as configured in a Subscriber Identity Module (SIM), an information regarding configuration for the NTN deployment as indicated by a server, an information regarding configuration for the NTN deployment as indicated by an application function, a database indicating details of a satellite or NTN cell, its location, its availability/unavailability time and its deployment details, a machine learning or an artificial intelligence based technique to predict or determine a network availability and unavailability status, or a data driven technique to predict or determine a Network availability and unavailability status.

In an embodiment, the UE (100) may trigger the network search procedure to select the network, when the UE (100) detects an event.

In an embodiment, the event may comprise at least one of a switch off the UE, a switch on the UE, a recovery of the UE (100) from lack of a coverage area, a recovery of the UE (100) from an out-of-service (OOS) area, a SIM insertion in the UE, a SIM re-insertion post removal in the UE, a SIM removal in the UE (100), a disabling of the SIM in the UE (100), an enabling of the SIM in the UE (100), a modem reset, a power cycle, a modem power up, a modem power cycle, an airplane mode on in the UE (100), an airplane mode off in the UE (100), a UE (100) exiting airplane mode, a modem exiting airplane mode, an activation of the UE (100), a reject cause from the network, a detach triggered by the network, a deregistration triggered by the network, on entering store and forward mode in the UE (100), on exiting store and forward mode in the UE (100), on entering store and forward mode from the network, on exiting store and forward mode from the network, a detach triggered by the UE (100), a deregistration triggered by the UE (100), a network mode change in the UE (100), a network selection mode change in the UE (100), an operating mode change in the UE (100), on entering satellite mode in the UE (100), on exiting satellite mode in the UE (100), a turning on of a modem or a SIM refresh procedure.

In an embodiment, the network search procedure may comprise selecting a network and searching the selected network.

In an embodiment, the UE (100) may perform the network search procedure for the TN on at least one of a terrestrial PLMN, a terrestrial RAT, a terrestrial access, a terrestrial system, a terrestrial RAN, a terrestrial band, a terrestrial frequency, a terrestrial cell, a terrestrial CN entity, a terrestrial network entity, a component of a terrestrial network, a terrestrial network function, a network other than NTN, or a network other than satellite access network.

In an embodiment, wherein the UE (100) may be at least one of an NTN-capable UE (100), a UE (100) capable of availing an NTN service, a UE (100) supporting NTN technology, a UE (100) capable of getting NTN services using technologies other than NTN technology, a UE (100) capable of availing the NTN service which is deployed using a 3^{rd} Generation Partnership Project (3GPP) Satellite or NTN system, a UE (100) capable of availing a service which is deployed using a 3^{rd} Generation Partnership Project (3GPP) system, a UE (100) capable of availing the NTN service which is deployed using an NTN network deployed using any 3GPP technology, or a UE (100) capable of availing the NTN service which is deployed using any proprietary NTN implementation outside the scope of 3GPP NTN system.

In an embodiment, the NTN may include one of: Low Earth Orbits (LEO), Medium Earth Orbits (MEO), Geostationary Orbits (GEO), High Altitude Platform Systems (HAPS), Unmanned Aerial Vehicles (UAV), an Unmanned Aircraft System (UAS), a network supported by an airborne vehicle, a Network deployed using a 3^{rd} Generation Partnership Project (3GPP) Satellite or NTN system, a NTN Network deployed using any 3GPP technology, a Network deployed using any 3GPP technology, or a NTN Network deployed using any proprietary NTN implementation outside the scope of a 3GPP NTN system.

According to embodiments, a method for selecting a network may be performed by a user equipment (UE) registered to the network. The method may comprise performing a network search procedure, ignoring an NTN, and selecting a TN.

In an embodiment, the UE (100) registered to the network may be at least one of the UE (100) is registered to the TN, the UE (100) is registered to the NTN, a UE (100) is registered to a 3GPP network, or a UE (100) is registered to a Non-3GPP (N3GPP) network.

In an embodiment, the UE (100) may perform the network search procedure and selects the TN on at least one of a terrestrial PLMN, a terrestrial RAT, a terrestrial access, a terrestrial system, a terrestrial RAN, a terrestrial band, a terrestrial frequency, a terrestrial cell, a terrestrial CN entity, a terrestrial network entity, a component of a terrestrial network, a terrestrial network function, a network other than NTN, or a network other than satellite access network.

In an embodiment, the UE (100) may perform the network search procedure, when the UE (100) detects an event.

In an embodiment, the event may comprise at least one of an expiry of a timer for higher priority PLMN search procedure, a handover procedure, a redirection procedure, a reselection procedure, an expiry of a timer for Better System Reselection (BSR), an expiry of an operator defined timer, a background network search procedure, an idle mode procedure, a connected mode procedure, or a network release procedure.

In an embodiment, ignoring the NTN may comprise at least one of ignoring the NTN, ignoring the NTN if the UE (100) is in a discontinuous coverage of the NTN, de-prioritizing the NTN, selecting the NTN with a lowest priority, de-prioritizing the NTN if the UE (100) is in the discontinuous coverage of the NTN, selecting the NTN with the lowest priority if the UE (100) is in the discontinuous coverage of the NTN, disabling the NTN, disabling the NTN if the UE (100) is in the discontinuous coverage of the NTN, ignoring the found Network over NTN, de-prioritizing the found Network over NTN, selecting the found Network over NTN with lowest priority, de-prioritizing the found Network over NTN, if the UE (100) is in the discontinuous coverage of the found Network, selecting the found Network over NTN with lowest priority if the UE (100) is in the discontinuous coverage of the found Network, disabling the found Network over a satellite access or an NTN access or over the NTN deployed band or frequency or RAT, disabling the found Network when the found RAT is a satellite access or a Satellite RAT or an NTN access or an NTN RAT, ignoring the found Network if the found Network is an NTN, disabling the PLMN search on the found Network and searching for a TN PLMN as per a priority order, searching for higher priority TN PLMNs on all RATs except NTN RAT or NTN Band and disabling searching on NTN bands or RATs and Operator deployed NTN Bands, disabling the PLMN search on the found Network and searching for a TN PLMN as per a priority order when the UE (100) is in a discontinuous coverage of the found Network, de-prioritizing the found Network and searching for a TN PLMN as per a priority order, and searching for a NTN PLMN when TN PLMN is not found, and the UE (100) is not in the discontinuous coverage of found Network, selecting any network other than NTN, select any PLMN other than NTN PLMN, selecting a TN, or not selecting an NTN.

In an embodiment, the UE (100) may ignore the NTN on at least one of a non-terrestrial PLMN, a non-terrestrial RAT, a non-terrestrial access, a non-terrestrial system, a non-terrestrial RAN, a non-terrestrial band, a non-terrestrial frequency, a non-terrestrial cell, a non-terrestrial network entity, a non-terrestrial network function, a non-terrestrial CN entity, a component of a non-terrestrial network, a network other than TN, or a network on satellite access network.

According to embodiments, a user equipment (UE) (100) may comprise memory, including one or more storage media, storing instructions. The UE (100) may comprise at least one processor including processing circuitry. The UE (100) may comprise a network search controller, coupled with the processor and the memory, configured to trigger a network search procedure. The network search controller is configured to determine if a last registered network is a Non-Terrestrial Network (NTN). The network search controller is configured to ignore the last registered network, if the last registered Network is the NTN. The network search controller is configured to perform a network search procedure for a terrestrial network (TN).

According to embodiments, a user equipment (UE) (100) may comprise memory, including one or more storage media, storing instructions. The UE (100) may comprise at least one processor including processing circuitry. The UE (100) may comprise a network search controller, coupled with the processor and the memory, configured to perform a network search procedure. The network search controller is configured to ignore an NTN. The network search controller is configured to select a TN.

In an embodiment, a method may be performed by a user equipment (UE) (100). The method may comprise registering to a non-terrestrial network (NTN). The method may comprise storing information that a registered public land mobile network (RPLMN) corresponds to the NTN. The method may comprise triggering a network search procedure. The method may comprise, in response to the triggering of the network search procedure, in a case that the stored information indicates that the RPLMN corresponds to the NTN, searching for a terrestrial network (TN) instead of searching for the NTN for the network search procedure.

In an embodiment, the method may comprise triggering the network search procedure in response to detecting an event. The event may include at least one of a power on of a modem, a power cycle of the modem, a reset of the modem, the modem entering an airplane mode, the modem exiting the airplane mode, a switch on of the UE, a recovery of the UE from lack of a coverage, a subscriber identity module (SIM) refresh procedure, a SIM insertion in the UE, a SIM removal from the UE, a PLMN selection procedure, a reselection procedure, a UE initiated detach, a network initiated detach, a reject cause from the network, a network mode change of the UE, or an expiry of a PLMN search timer.

In an embodiment, the method may comprise selecting a TN PLMN based on information stored in a SIM of the UE, wherein the information stored in the SIM indicates a priority order of PLMNs. The method may comprise performing a registration on the TN PLMN.

In an embodiment, the method may comprise disabling the RPLMN for the network search procedure or de-prioritizing the RPLMN for the network search procedure.

In an embodiment, the method may comprise, in the case that the stored information indicates that the RPLMN corresponds to the NTN, adding the RPLMN to a temporary forbidden PLMN list.

In an embodiment, the method may comprise starting a timer after triggering the network search procedure. The method may comprise searching for the TN while the timer is running. The method may comprise, in response to an expiry of the timer, searching for the NTN.

In an embodiment, the method may comprise receiving, from a network associated with the NTN, a registration accept indicating a start of an unavailability period and an unavailability period duration. The method may comprise determining that the UE is in a discontinuous coverage of the network based on the registration accept.

In an embodiment, the method may comprise, in response to registering to the NTN, displaying a radio access technology (RAT) for the NTN. The method may comprise, in response to registering to the TN, displaying a RAT for the TN.

In an embodiment, the method may comprise, in response to the triggering of the network search procedure, in a case that the stored information indicates that the RPLMN corresponds to the TN, performing a registration on the RPLMN.

In an embodiment, the network search procedure may comprise a PLMN selection.

In an embodiment, a user equipment (UE) (100) may comprise communication circuitry. The UE (100) may comprise memory, including one or more storage media, storing instructions. The UE (100) may comprise at least one processor including processing circuitry. The instructions, when executed by the at least one processor individually or collectively, may cause the UE to register to a non-terrestrial network (NTN). The instructions, when executed by the at least one processor individually or collectively, may cause the UE to store information that a registered public land mobile network (RPLMN) corresponds to the NTN. The instructions, when executed by the at least one processor individually or collectively, may cause the UE to trigger a network search procedure. The instructions, when executed by the at least one processor individually or collectively, may cause the UE to, in response to the triggering of the network search procedure, in a case that the stored information indicates that the RPLMN corresponds to the NTN, search for a terrestrial network (TN) instead of searching for the NTN for the network search procedure.

In an embodiment, the instructions, when executed by the at least one processor individually or collectively, may cause the UE to trigger the network search procedure in response to detecting an event. the event may include at least one of a power on of a modem, a power cycle of the modem, a reset of the modem, the modem entering an airplane mode, the modem exiting the airplane mode, a switch on of the UE, a recovery of the UE from lack of a coverage, a subscriber identity module (SIM) refresh procedure, a SIM insertion in the UE, a SIM removal from the UE, a PLMN selection procedure, a reselection procedure, a UE initiated detach, a network initiated detach, a reject cause from the network, a network mode change of the UE, or an expiry of a PLMN search timer.

In an embodiment, the instructions, when executed by the at least one processor individually or collectively, may cause the UE to select a TN PLMN based on information stored in a SIM of the UE, wherein the information stored in the SIM indicates a priority order of PLMNs. The instructions, when executed by the at least one processor individually or collectively, may cause the UE to perform a registration on the TN PLMN.

In an embodiment, the instructions, when executed by the at least one processor individually or collectively, may cause the UE to disable the RPLMN for the network search procedure or de-prioritize the RPLMN for the network search procedure.

In an embodiment, the instructions, when executed by the at least one processor individually or collectively, may cause the UE to, in the case that the stored information indicates that the RPLMN corresponds to the NTN, add the RPLMN to a temporary forbidden PLMN list.

In an embodiment, the instructions, when executed by the at least one processor individually or collectively, may cause the UE to start a timer after triggering the network search procedure. The instructions, when executed by the at least one processor individually or collectively, may cause the UE to search for the TN while the timer is running. The instructions, when executed by the at least one processor individually or collectively, may cause the UE to, in response to an expiry of the timer, search for the NTN.

In an embodiment, the instructions, when executed by the at least one processor individually or collectively, may cause the UE to receive, from a network associated with the NTN, a registration accept indicating a start of an unavailability period and an unavailability period duration. The instructions, when executed by the at least one processor individually or collectively, may cause the UE to determine that the UE is in a discontinuous coverage of the network based on the registration accept.

In an embodiment, the instructions, when executed by the at least one processor individually or collectively, may cause the UE to in response to registering to the NTN, display a radio access technology (RAT) for the NTN. The instructions, when executed by the at least one processor individually or collectively, may cause the UE to, in response to registering to the TN, display a RAT for the TN.

In an embodiment, the instructions, when executed by the at least one processor individually or collectively, may cause the UE to, in response to the triggering of the network search procedure, in a case that the stored information indicates that the RPLMN corresponds to the TN, perform a registration on the RPLMN.

In an embodiment, the network search procedure may comprise a PLMN selection.

The term ‘ignore’ can be replaced with ‘disable’, ‘de-prioritize’, ‘postpone’, and/or equivalent terms.

In embodiments herein, the solutions are explained by applying during Network Search/Selection procedure. However, the solutions are also applicable before or during or after the Network search/selection procedure and the core principle remains the same.

The various actions, acts, blocks, operations, or the like in the flowcharts (S1200-S1800, and S2100) may be performed in the order presented, in a different order or simultaneously. Further, in some embodiments, some of the actions, acts, blocks, operations, or the like may be omitted, added, modified, skipped, or the like without departing from the scope of the disclosure.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE), comprising:
registering to a non-terrestrial network (NTN);
storing information that a registered public land mobile network (RPLMN) corresponds to the NTN;
triggering a network search procedure; and
in response to the triggering of the network search procedure, in a case that the stored information indicates that the RPLMN corresponds to the NTN, searching for a terrestrial network (TN) instead of searching for the NTN for the network search procedure.

2. The method of claim 1, wherein the triggering of the network search procedure comprises:
triggering the network search procedure in response to detecting an event,
wherein the event includes at least one of a power on of a modem, a power cycle of the modem, a reset of the modem, the modem entering an airplane mode, the modem exiting the airplane mode, a switch on of the UE, a recovery of the UE from lack of a coverage, a subscriber identity module (SIM) refresh procedure, a SIM insertion in the UE, a SIM removal from the UE, a PLMN selection procedure, a reselection procedure, a UE initiated detach, a network initiated detach, a reject cause from the network, a network mode change of the UE, or an expiry of a PLMN search timer.

3. The method of claim 1, wherein the searching for the TN comprises:
selecting a TN PLMN based on information stored in a SIM of the UE, wherein the information stored in the SIM indicates a priority order of PLMNs; and
performing a registration on the TN PLMN.

4. The method of claim 3, wherein the searching for the TN comprises:
disabling the RPLMN for the network search procedure; or
de-prioritizing the RPLMN for the network search procedure.

5. The method of claim 1, wherein the searching for the TN comprises:
in the case that the stored information indicates that the RPLMN corresponds to the NTN, adding the RPLMN to a temporary forbidden PLMN list.

6. The method of claim 1, wherein the searching for the TN comprises:
starting a timer after triggering the network search procedure;
searching for the TN while the timer is running; and
in response to an expiry of the timer, searching for the NTN.

7. The method of claim 1, wherein the registering to the NTN comprises:
receiving, from a network associated with the NTN, a registration accept indicating a start of an unavailability period and an unavailability period duration; and
determining that the UE is in a discontinuous coverage of the network based on the registration accept.

8. The method of claim 1, comprising:
in response to registering to the NTN, displaying a radio access technology (RAT) for the NTN; and
in response to registering to the TN, displaying a RAT for the TN.

9. The method of claim 1, further comprising:
in response to the triggering of the network search procedure, in a case that the stored information indicates that the RPLMN corresponds to the TN, performing a registration on the RPLMN.

10. The method of claim 1,
wherein the network search procedure comprises a PLMN selection.

11. A user equipment (UE) comprising:
communication circuitry;
memory, including one or more storage media, storing instructions; and
at least one processor including processing circuitry, wherein the instructions, when executed by the at least one processor individually or collectively, cause the UE to:
register to a non-terrestrial network (NTN);
store information that a registered public land mobile network (RPLMN) corresponds to the NTN;
trigger a network search procedure; and
in response to the triggering of the network search procedure, in a case that the stored information indicates that the RPLMN corresponds to the NTN, search for a terrestrial network (TN) instead of searching for the NTN for the network search procedure.

12. The UE of claim 11, wherein the instructions, when executed by the at least one processor individually or collectively, cause the UE to:
trigger the network search procedure in response to detecting an event,
wherein the event includes at least one of a power on of a modem, a power cycle of the modem, a reset of the modem, the modem entering an airplane mode, the modem exiting the airplane mode, a switch on of the UE, a recovery of the UE from lack of a coverage, a subscriber identity module (SIM) refresh procedure, a SIM insertion in the UE, a SIM removal from the UE, a PLMN selection procedure, a reselection procedure, a UE initiated detach, a network initiated detach, a reject cause from the network, a network mode change of the UE, or an expiry of a PLMN search timer.

13. The UE of claim 11, wherein the instructions, when executed by the at least one processor individually or collectively, cause the UE to:
select a TN PLMN based on information stored in a SIM of the UE, wherein the information stored in the SIM indicates a priority order of PLMNs; and
perform a registration on the TN PLMN.

14. The UE of claim 11, wherein the instructions, when executed by the at least one processor individually or collectively, cause the UE to:
disable the RPLMN for the network search procedure; or
de-prioritize the RPLMN for the network search procedure.

15. The UE of claim 11, wherein the instructions, when executed by the at least one processor individually or collectively, cause the UE to:
in the case that the stored information indicates that the RPLMN corresponds to the NTN, add the RPLMN to a temporary forbidden PLMN list.

16. The UE of claim 11, wherein the instructions, when executed by the at least one processor individually or collectively, cause the UE to:
start a timer after triggering the network search procedure;
search for the TN while the timer is running; and
in response to an expiry of the timer, search for the NTN.

17. The UE of claim 11, wherein the instructions, when executed by the at least one processor individually or collectively, cause the UE to:
receive, from a network associated with the NTN, a registration accept indicating a start of an unavailability period and an unavailability period duration; and
determine that the UE is in a discontinuous coverage of the network based on the registration accept.

18. The UE of claim 11, wherein the instructions, when executed by the at least one processor individually or collectively, cause the UE to:
in response to registering to the NTN, display a radio access technology (RAT) for the NTN; and
in response to registering to the TN, display a RAT for the TN.

19. The UE of claim 11, wherein the instructions, when executed by the at least one processor individually or collectively, cause the UE to:
in response to the triggering of the network search procedure, in a case that the stored information indicates that the RPLMN corresponds to the TN, perform a registration on the RPLMN.

20. The UE of claim 11,
wherein the network search procedure comprises a PLMN selection.
